(19) United States
(12) Patent Application Publication
(10) Pub. No.: US 2012/0000175 A1
(43) Pub. Date: Jan. 5, 2012

(54) MILD GASIFICATION COMBINED-CYCLE POWERPLANT

(75) Inventor: Alex Wormser, Marblehead, MA (US)

(73) Assignee: WORMSER ENERGY SOLUTIONS, INC., Marblehead, MA (US)

(21) Appl. No.: 13/132,839

(22) PCT Filed: Dec. 23, 2009
(86) PCT No.: PCT/US09/69455

§ 371 Date: Sep. 21, 2011

Related U.S. Application Data
(60) Provisional application No. 61/140,597, filed on Dec. 23, 2008.
(60) Provisional application No. 61/140,834, filed on Dec. 24, 2008.

(51) Int. Cl. F02C 6/18; B23P 11/00

(52) U.S. Cl. 60/39.12; 29/401.1

(57) ABSTRACT

The invention provides a hybrid integrated gasification combined cycle (IGCC) plant for carbon dioxide emission reduction and increased efficiency including an internally- circulating fluidized bed carbonizer that forms a syngas and char. The invention also provides methods and equipment for retrofitting existing IGCC plants to reduce carbon dioxide emissions, increase efficiency, reduce equipment size and/or decrease the use of water, coal or other resources.

### CROSS REFERENCE TO RELATED APPLICATIONS

This application claims the benefit of, and priority to, U.S. Patent Application Serial Number 61/140597, filed Dec. 23, 2008, and U.S. Patent Application Serial Number 61/140834, filed Dec. 24, 2008, both entitled “Mild Gasification Combined-Cycle Powerplant.” The entire contents of these applications are incorporated herein by this reference.

### BACKGROUND

There are two current trends related to clean coal powerplants: hybrid integrated gasification combined cycle (IGCC) technology and the retrofitting of existing pulverized coal (PC) plants to reduce their CO2 emissions.

With regard to IGCCs, the first generation IGCCs use oxygen-blown gasifiers, while the second generation IGCCs use air blown gasification. Both of these IGCCs attempted to gasify as much of the coal as possible, and essentially gasify most or all of the coal. Third generation IGCCs, called “hybrids,” gasify only a portion of the coal, leaving a residue of char. The char is then burned in a combustor to provide additional power.

With regard to retrofitting existing coal-fired steamplants (e.g., pulverized-coal steamplants) with IGCCs, policy studies by the U.S. government's National Energy Management Systems (NEMS) reflect the increasing awareness of both the importance, and the unique difficulty, of reducing CO₂ emissions from the existing fleet of PC plants. Coal powerplants produce a quarter of the world's CO₂ emissions, and thus can't be ignored in any program that seeks to significantly reduce the world's emissions. Conventional low-emission technologies, such as wind and nuclear technologies, affect only new capacity, so the problem with the existing PC emissions remains. Tearing the plants down is economically unfeasible; the other option is to retrofit them with IGCCs that also provide for carbon capture and storage (CCS), which is also economically unfeasible.

One conclusion of the NEMS studies is that CO₂ emissions from PC plants in the United States could be reduced by as much as 80% by the year 2030, if the right financial conditions are met. For this to be economically viable however, the cost of IGCCs would have to drop significantly, and sufficiently costly carbon caps would have to be imposed.

### SUMMARY

The present invention is based, at least in part, on a clean-coal technology, which employs both hybrid IGCC technology and the retrofitting of existing PC plants, alone or in combination. (See, e.g., FIG. 1).

In one aspect, the invention provides a hybrid integrated gasification combined cycle (IGCC) plant for carbon dioxide emission reduction and increased efficiency. The hybrid IGCC includes an internally-circulating fluidized bed carbonizer that forms a syngas and char, a syngas cooler, a warm gas cleanup system, and a gas turbine fired by the syngas. In some embodiments, the hybrid IGCC plant operates such that the syngas is maintained as a temperature above a tar condensation temperature of a volatile matter in the syngas. In some embodiments, the syngas is formed from a solid fuel such as coal. Additionally or alternatively, biomass may be employed.

In some embodiments, the carbonizer heats incoming flows with at least one external burner.

In some embodiments, char from the hybrid plant is burned in a steamplant. Additionally, in some embodiments, a flue gas from the gas turbine is ducted to the steamplant in order to recover its heat and convert it to electrical power by a steam turbine generator. In some embodiments, both the char and a portion of the syngas are ducted to the existing steamplant. In some embodiments, additional air is added to the combustion chamber of said steamplant. A heat recovery steam generator supplements the heat recovery of said existing steamplant in some embodiments.

In some embodiments, the carbonizer comprises an internally-circulating fluidized bed (ICFB) reactor within a pressure vessel, consisting of a draft tube surrounded by an annular bed of char which is gasified by the addition of oxidant and steam at the bottom of said char bed, in which the coal to said ICFB is injected into said draft tube.

In some embodiments, the hybrid IGCC plant is modified to provide carbon capture and storage, in which the syngas leaving the warm gas cleanup system passes, in sequence, through an array of pressurized vessels comprising, in sequence, a partial oxidizer, a syngas cooler, a water-gas shift reactor, and an absorption system for separating carbon dioxide from the gaseous fuel, whereby said carbon dioxide is then dried and compressed before being sequestered.

In some embodiments, the carbonizer comprises a spouted fluidized bed within a pressure vessel, said spouted bed incorporating a draft tube. In further embodiments, the carbonizer comprises a distributor plate that feeds steam and air to an annular space surrounding the draft tube and means for feeding coal to and removing excess char from the carbonizer.

In some embodiments, the syngas cooler comprises a fluidized bed containing coolant tubes. In some embodiments, the syngas is cooled by steam or water that is injected downstream of the carbonizer.

In some embodiments, waste heat from the syngas cooler is reinjected into the syngas, a steam stream or both the syngas and a steam stream.

In some embodiments where coal is employed, the coal is dried and heated before being injected into the carbonizer, using a conventional coal drier. In some embodiments where coal is employed, the coal is dried and heated before being injected into the carbonizer, using a precombustion thermal treatment of coal (PCTTC) system. In some embodiments, a coal dryer is included that includes an atmospheric-pressure dual-stage fluidized bed combustor, wherein combustion occurs in a lower fluidized bed, the lower fluidized bed incorporating coolant tubes to maintain its temperature below a fusion temperature of the ash in the fuel, and wherein one or more products of combustion from the lower fluidized bed pass through a distributor plate overhead and into a second fluidized bed, the second fluidized bed containing the coal being dried. In some embodiments, coolant entering the coolant tubes comes from an acid plant in the IGCC plan, wherein some of the coolant emerging from the lower bed cooling tubes is directed at a steam turbine, and the remainder of the coolant is ducted to a coal heater of the PCTTC system, and wherein the coolant emerging from the coal heater is pumped back to the entrance of the coolant tubes in the lower fluidized bed of the combustor.

In some embodiments, the syngas cooler comprises a distributor plate comprising a plurality of slanted tubes mounted on a fin-tube plate assembly, wherein the slanted tubes are mounted on a slant sufficient to eliminate the weepage of a bed material when the IGCC plant is not operating. In some embodiments where a fluidized bed syngas cooler is used, the syngas cooler comprises a distributor plate comprising a plurality of slanted openings wherein the slanted openings are sufficiently close to horizontal to eliminate the weepage of a bed material when the IGCC plant is not operating. In other embodiments, the openings in the fluidized bed distributor are formed in the supported refractory from which the distributor is constructed.

In some embodiments, a fluidized bed of a char in the carbonizer is divided into segments each independently fed by a mixture of steam and air, and the IGCC plant efficiency is maintained during a diminishment of a coal feed by use of additional segments to gasify char during the diminishment of the coal feed.

In some embodiments, particulates containing calcium carbonate are injected onto a distributor plate included in a carbonizer bed in the carbonizer.

In some embodiments, char, e.g., char leaving the carbonizer and/or a char cooler, is pulverized, and the pulverized char is passed over a separator, in order to remove fine particles of ash that also contain mercury. In some embodiments, the separator employs either magnetic forces or electrostatic forces, or both, to separate the ash from the char.

In some embodiments, the gasification level is preferably 100% minus the gasification level that would be obtained by gasifying the char fines.

In some embodiments, the gasification level is at least about 70%, preferably at least about 75%, more preferably at least about 80%, more preferably at least about 85%, more preferably at least about 90%, more preferably at least about 95%. In some embodiments, the level of gasification is the maximum that can be used without having to gasify significant or uneconomic amounts of char fines. In some embodiments, the syngas has a heating value of about 300 BTU/SCF or more. In others the syngas has a heating value of about 350 BTU/SCF or more, about 400 BTU/SCF or more, about 450 BTU/SCF or more, or about 500 BTU/SCF or more. In some embodiments, the syngas is maintained at a temperature of about 900° F. or more, about 950° F. or more, about 1000° F. or more, about 1100° F. or more, or about 1200° F. or more. In some embodiments, the carbon conversion ratio is about 80% or more.

In another aspect, the invention provides a method of retrofitting an existing IGCC or coal-fired plant, the method comprising the step of the existing plant providing an IGCC plant according to any of the embodiments described herein.

In yet another aspect, the invention provides methods of reducing carbon dioxide emissions and/or increasing efficiency and/or reducing equipment size and/or decreasing the use of water, coal or other resources (e.g., in comparison to other coal-fired power plants), employing the steps described herein.

In yet another aspect, the invention provides hybrid integrated gasification combined cycle (IGCC) plants for retrofitting existing steamplants, wherein the steamplants include an internally-circulating fluidized bed carbonizer that forms a syngas and char, a syngas cooler, a warm gas cleanup system, and a gas turbine fired by the syngas. In some such embodiments, the plant further comprises at least one of an existing boiler and optionally one or more scrubbers that are decommissioned, a heat recovery steam generator (HRSG), and/or a fluidized-bed combustor for combusting a char generated by the carbonizer.

In some embodiments, the hybrid IGCC plant operates such that the syngas is maintained at a temperature above a tar condensation temperature of a volatile matter in the syngas until the syngas is burned in the gas turbine.

In some embodiments, the fluidized-bed combustor is pressurized.

In some embodiments, the carbonizer is operated at or near the maximum level of gasification for a once-through system.

In some embodiments, the carbonizer, the warm gas cleanup system, and/or the gas turbine are rated at a lower capacity than required to match the output of the retrofitted steamplant for operating the existing at a reduced output.

In some embodiments, the carbonizer, the warm gas cleanup system, and the gas turbine are rated at a lower capacity than required to match the rated capacity of the retrofitted steamplant operating at full capacity.

In some embodiments, if the carbonizer, the warm gas cleanup system, and the gas turbine are rated at a lower capacity than required to match the rated capacity of the retrofitted steamplant, said steamplant shall also be operated below its rated capacity.

In some embodiments, the IGCC further comprises a second HRSG, a second gas turbine, and a stack-gas CO₂ scrubber for providing carbon capture from char generated by the system's carbonizer.

In some embodiments, the carbonizer further comprises a draft tube configured to inject air into the carbonizer for partially combusting volatiles, providing heat for incoming flows, and gasifying char with steam.

In some embodiments, the carbonizer does not comprise external burners.

In some embodiments, the gas turbine is an aeroderivative gas turbine, and wherein the fluidized-bed combustor is adapted to superheat and reheat steam generated by the HRSG.

In some embodiments, the carbonizer comprises an internally-circulating fluidized bed of fluidized char defined by a conical hopper that extends beyond the top of the draft tube, and comprising a cylindrical extension sufficiently tall to avoid penetration of volatiles emitted from the draft tube, whereby the volume of char in said conical hopper and cylindrical extension is sufficient to thermally crack the tars in the volatiles generated in said draft tube, and a bypass channel defined by an inner wall of said carbonizer and an outer wall of said cylindrical extension of said conical hopper, for escape of syngas formed in said annular bed. In some such embodiments, the carbonizer further includes an annular bed of fluidized char surrounding a draft tube and, optionally, a downcomer in communication with the bottom of the conical hopper for supplying a controlled amount of air for maintaining the surface of the annular bed at a desired height. In some such embodiments, the conical hopper and the cylindrical extension are eliminated.

In some embodiments, a halide scrubber of a warm-gas cleanup system is located downstream of a candle filter.

In some embodiments, gasification of fines is increased by recirculating fines or increasing a freeboard volume to a value above the freeboard volume of the carbonizer. In some embodiments, the gasification of fines is increased so as to optimize the system with regard to plant efficiency or cost of electricity.

In some embodiments, the IGCC further comprises a pressurized carbon dioxide absorber for removing CO₂ from char generated by the system's carbonizer.

In some embodiments, pressurized carbon dioxide adsorber is an amine system.

In some embodiments, the IGCC further comprises a char deflector above the outlet of a draft tube of the carbonizer, wherein the char deflector includes a pocket which buffers a surface of said deflector with material that becomes partially entrained on the surface, thereby minimizing the erosion of the deflector by char.

In some embodiments, a distributor plate of of the syngas cooler defines passages for syngas formed in a refractory casting, wherein the casting comprises coolant pipes that provide structural support, and wherein the coolant pipes are at least partially surrounded a fibrous insulation that minimizes the thermal stresses in the refractory.

In some embodiments, the plant is in communication with a furnace of an existing steamplant for burning char generated by the carbonizer.

In some embodiments, a candle filter and a halide scrubber are placed upstream of a desulfurizer of the warm gas cleanup system.

In some embodiments, the carbonizer comprises spraybars. In some such embodiments, water is injected by the spraybars to cool the syngas to a desired temperature for the syngas cleanup system.

In yet another aspect, the invention provides methods of retrofitting an existing power plant, comprising the step of retrofitting an existing power plant to include a hybrid IGCC plant in accordance with any of the teachings herein, e.g., a de-rated plant retrofitted to lower the emissions.

In yet another aspect, the invention provides methods of realizing a reduction in CO₂ emissions (e.g., a reduction of CO₂ emissions of at least about 20%) by upgrading or retrofitting an existing power plant to include a hybrid IGCC plant in accordance with any one of the claims appended hereto.

In yet another aspect, the invention provides methods for realizing a reduction in CO₂ emissions from coal plants, comprising using coal to produce new generating capacity, wherein the reduction in CO₂ emissions occurs more quickly and extensively than if renewable or other low-emission technologies are utilized, e.g., wherein a reduction of CO₂ emissions of at least about 30% is realized.

Additional features, functions and benefits of the disclosed inventions will be apparent from the detailed description which follows, particularly when read in conjunction with the appended figures.

### BRIEF DESCRIPTION OF THE DRAWINGS

To assist those of skill in the art in making and using the disclosed inventions, reference is made to the accompanying figures, wherein:

FIG. 1 is a series of tables comparing (A) exemplary hybrid IGCCs in accordance with the present invention with oxygen-blown IGCCs and other airblown IGCCs, (B) major types of hybrid IGCCs, and (C) the statuses of the major types of hybrid IGCCs.

FIGS. 2 and 3 are flow diagrams which depict exemplary configurations of IGCCs in accordance with the present invention.

FIG. 4 is a diagram which depicts an exemplary process flow in accordance with the present invention.

FIG. 5 is a diagram which depicts an exemplary carbonizer in accordance with the present invention.

FIGS. 6A, 6B and 6C are diagrams which respectively depict the top view, elevation view and side cross-sectional view of an exemplary distributor plate for cooling or desulfurizing syngas in accordance with the present invention.

FIGS. 7A and 7B are diagrams which respectively depict (A) an exemplary portion of a carbonizer in accordance with the present invention modified for turndown and (B) the cross section of such carbonizer along the “A” line of FIG. 7A, to depict an exemplary annular bed.

FIG. 8 is a diagram of an exemplary coal preparation system in accordance with the present invention.

FIG. 9 is a diagram of an exemplary char preparation system in accordance with the present invention.

FIG. 10 is a flow diagram which depicts an exemplary configuration of an IGCC in accordance with the present invention.

FIG. 11 is a diagram of an exemplary in-bed desulfurizer in accordance with the present invention.

FIG. 12 is a diagram of an exemplary hybrid IGCC in accordance with the present invention which includes a CCS.

FIG. 13 is a table describing estimated operating conditions in an exemplary gas turbine utilized in accordance with the present invention.

FIG. 14 is a table describing estimated conditions in an exemplary carbonizer utilized in accordance with the present invention.

FIG. 15 is a graph depicting the estimated plant efficiency of an exemplary hybrid IGCC in accordance with the present the invention as compared to other IGCCs.

FIG. 16 is a graph depicting the estimated effect of an existing steamplant's efficiency on the efficiency of a combined system.

FIG. 17 is a table describing the estimated size and operating parameters of three designs of gasifiers or carbonizers supplying syngas to similarly-rated IGCCs.

FIG. 18 is a table describing the estimated size and operating parameters of two coolers, including an exemplary syngas cooler of the present invention.

FIG. 19 is a table describing typical contaminants of plants, estimated characteristics thereof, and exemplary methods for contaminant removal in accordance with the present invention.

FIG. 20 is a table describing the estimated efficiency of four plant designs, including one in accordance with the present invention.

FIG. 21 is a graph depicting estimated water consumption of seven plant designs, including two in accordance with the present invention.

FIGS. 22 and 23 are flow diagrams which depict exemplary configurations of IGCCs in accordance with the present invention.

FIGS. 24A and 24B are tables describing the estimated flow, temperature and pressure in various portions of an exemplary IGCC in accordance with the present invention.

FIG. 25 is a table comparing various estimated characteristics of airblown carbonizers, airblown gasifiers and oxygen blown gasifiers.

FIG. 26 is a table describing the estimated airflow to gasifier and syngas flow rates of an exemplary IGCC in accordance with the present invention and a conventional IGCC.

FIG. 27 is a flow diagram which depicts exemplary configurations of an IGCC in accordance with the present invention.

FIG. 28 is a diagram which depicts an exemplary carbonizer in accordance with the present invention.

FIG. 29 is a graph depicting estimated relative size of an exemplary fluidized-bed gasifier of the present invention (MaGIC™) in comparison to two fluidized-bed gasifiers known in the art.

FIG. 30 is a diagram which depicts an exemplary carbonizer in accordance with the present invention.

FIG. 31 is a flow diagram which depicts exemplary configurations of an IGCC in accordance with the present invention.

FIG. 32 is a diagram which depicts an exemplary carbonizer in accordance with the present invention.

FIG. 33 is a schematic representation of an exemplary warm-gas cleanup system of the present invention.

FIG. 34 is a schematic representation of an exemplary fluidized-bed combustor of the present invention.

FIGS. 35A and 35B are graphs depicting the estimated higher heating value (HHV) efficiency of exemplary IGCCs of the present invention (MaGIC™) at varying percentage levels of gasification.

FIG. 36 is a table describing the estimated efficiency of an exemplary IGCC of the present invention which includes an aeroderivative engine.

FIG. 37 is a graph depicting the estimated effect of power output on CO₂ emissions in an exemplary IGCC of the present invention (MaGIC™) and a retrofitted natural gas combined cycle plant.

FIG. 38 is a graph depicting the estimated effect of capacity of the steamplant on CO₂ emissions in two exemplary IGCCs of the present invention (MaGIC™) and a natural gas combined cycle plant

FIG. 39 is a graph depicting the estimated total water requirements of an exemplary IGCC of the present invention (MaGIC™) versus the plant output.

FIG. 40 is a graph depicting the estimated effect of varying the existing steamplant utilization on the power output of the plant.

FIG. 41 is a graph depicting the estimated effect of added plant capacity on the capital cost.

FIG. 42 is a graph depicting the estimated effect of added plant capacity on the levelized cost of electricity.

FIG. 43 is a graph depicting the estimated lower heating value (LHV) efficiency of exemplary IGCCs of the present invention (MaGIC™) versus the average U.S. PC plant.

FIG. 44 is a flow chart depicting an exemplary method for removing carbon dioxide from an exemplary mild-gasification IGCC.

FIG. 45A is a table showing estimated methane emissions from an exemplary embodiment of the invention.

FIG. 45B is a schematic representation of an exemplary low-erosion deflector for char emerging from the draft tube in accordance with the present invention.

FIG. 46 is a schematic representation of an exemplary improved distributor plate for the syngas cooler and limestone desulfurizer in accordance with the present invention.

FIG. 47 is a schematic representation of an exemplary alternative configuration of the warm-gas cleanup system of the present invention.

FIG. 48 is a schematic representation of an exemplary carbonizer in accordance with the present invention.

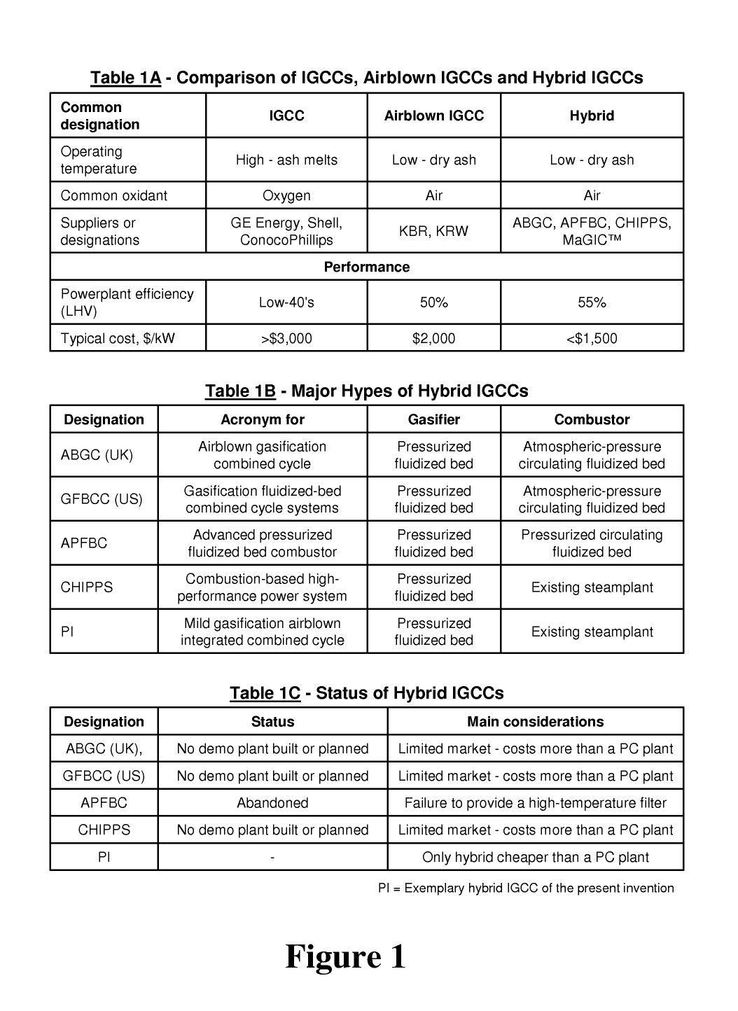

### DETAILED DESCRIPTION OF THE INVENTION

The present invention is based, at least in part, on a clean-coal technology. Without wishing to be bound by any particular theory, it is believed that the present invention will generate new power more cheaply than current technology and/or will reduce the carbon dioxide (CO₂) emissions from both new and existing coal-fired powerplants by 20-35% without carbon capture and storage (CCS), and upwards of 90% with CCS. In some embodiments, the present invention is employed to retrofit existing powerplants of any type or fuel, or be used as a stand-alone new plant. In some embodiments, when used to retrofit, the present invention uses substantially less cooling water than a new freestanding plant would, regardless of the fuel.

In some embodiments, the present invention provides a hybrid IGCC plant. As used herein, the term “hybrid IGCC plant” is used interchangeably with “hybrid plant” and “hybrid IGCC” to refer to a plant which produces both syngas to fire a gas turbine, and char to fire an existing steamplant or other boiler, such as a fluidized bed combustor. In some embodiments, some or all of the char is used for other purposes, for example, to manufacture char briquettes.

Hybrid IGCC plants of the present invention differ from other hybrid IGCCs by retaining volatiles in coal as a fuel (e.g., most or all of the volatiles in coal). As used herein, the terms “volatiles” and “volatile matter” are used interchangeably to refer to mixtures of hydrocarbon gases and vapors, as well as other (non-fuel) gases (e.g., gases that are emitted from coal when it is heated to a sufficiently high temperature. Some of the hydrocarbon vapors are called tars, in reference to their appearance when they condense.

Typically, tars remain vaporized as long as syngas is maintained above a maximum condensation temperature, e.g., above about 900° F. Previous IGCCs used low-temperature gas cleanup systems, which operate below the condensation temperature of tar. Thus their gasifiers needed to destroy the tars to avoid fouling in the syngas cleanup system. In some embodiments, volatiles refer to medium-BTU fuels, e.g., about 500 BTU/SCF, with about four times the heating value of the syngas emerging from conventional air blown gasifiers.

Previous IGCCs required removal of the volatiles because their lower-temperature cleanup systems operate below the volatiles' condensation temperature. Volatiles from coal typically have a density of about 500 BTU/SCF, whereas syngas from conventional airblown gasifiers typically have a density of about 135 BTU/SCF. Warm-gas cleanup systems for syngas have recently been developed, which operate above the volatiles' condensation temperature. Without wishing to be bound by any particular theory, it is believed that the warm-gas cleanup system enables the carbonizer and other elements of the gasifier train to operate above the temperature at which tars condense, thereby enabling the preservation of volatiles.

As used herein, the articles “a” and “an” mean “one or more” or “at least one,” unless otherwise indicated. That is, reference to any element of the present invention by the indefinite article “a” or “an” does not exclude the possibility that more than one of the element is present.

As used herein, the term “plant” and the term “system” are used interchangeably.

As used herein, the term “retrofit” and the term “upgrade” are used interchangeably.

As used herein, the term “water-gas” refers to mixtures of CO and H₂ (e.g., the gas that is produced from gasification of char). As used herein, the term “syngas” refers to mixtures of water-gas and volatiles. In some embodiments, the syngas of the present invention has a heating value of about 300 BTU/SCF or more. In others, the syngas has a heating value of about 350 BTU/SCF or more, about 400 BTU/SCF or more, about 450 BTU/SCF or more, or about 500 BTU/SCF or more. In some embodiments, the syngas is maintained at a temperature of about 900° F. or more, about 950° F. or more, about 1000° F. or more, about 1100° F. or more, or about 1200° F. or more. In some embodiments, the carbon conversion ratio is about 80% or more. The higher heating value of the syngas of some embodiments of the present invention may be due to the heating value of the volatiles in the syngas, which is several-times higher than the water gas found in conventional ariblown carbonizers. The higher heating value of the syngas of some embodiments of the present invention may also be due to the fact that much less air is required by the carbonzier.

In some embodiments, hybrid IGCC plants of the present invention are designed to operate without carbon capture and storage (CCS) at the outset. In some embodiments, the use of CCS in connection with the present invention may lead to the reduction of CO₂ emissions from coal plants by over 90%. In some embodiments, the hybrid IGCC plants of the present invention are carbon-ready, and accordingly can minimize the cost of carbon capture when compared with post-combustion scrubbing. In some embodiments, upgrading to CCS can, for example, be mostly or entirely paid for by the savings of the exemplary hybrid IGCC plants relative to the next-cheapest alternative plants. This can minimize or eliminate the impact of carbon caps or rate hikes to pay for CCS. Such effects would make new technology regarding CCS more acceptable in societies concerned about global warming but unwilling to fund costly endeavors to minimize or prevent it.

Without wishing to be bound by any particular theory, it is believed that, in retrofit applications, a 20-35% reduction in CO2 emissions is realized by the higher plant efficiency relative to that of existing steamplants in developed countries, and by as much as 45% relative to that of existing steamplants in developing countries. In some embodiments, the CO₂ emissions of the hybrid IGCCs of the present invention can be reduced to below the level that a new gas turbine combined cycle plant might achieve, making it an attractive alternative to gas plants in the near-term, even before carbon sequestration systems are available.

Overview

In some embodiments, the invention includes: a gasification system feeding a combined-cycle plant. Exemplary gasification systems include a pressurized gasification train, including a pressurized carbonizer, pressurized syngas cooler, and pressurized syngas cleanup system. Exemplary combined cycle plants include a gas turbine and a heat recovery steam generator (HRSG). The HRSG may be an existing PC plant, a newly built HRSG, or in some cases, a combination of an existing steamplant and a new HRSG. In some embodiments, hybrid IGCC plants produce char that is fed to an existing PC plant or a fluidized-bed combustor.

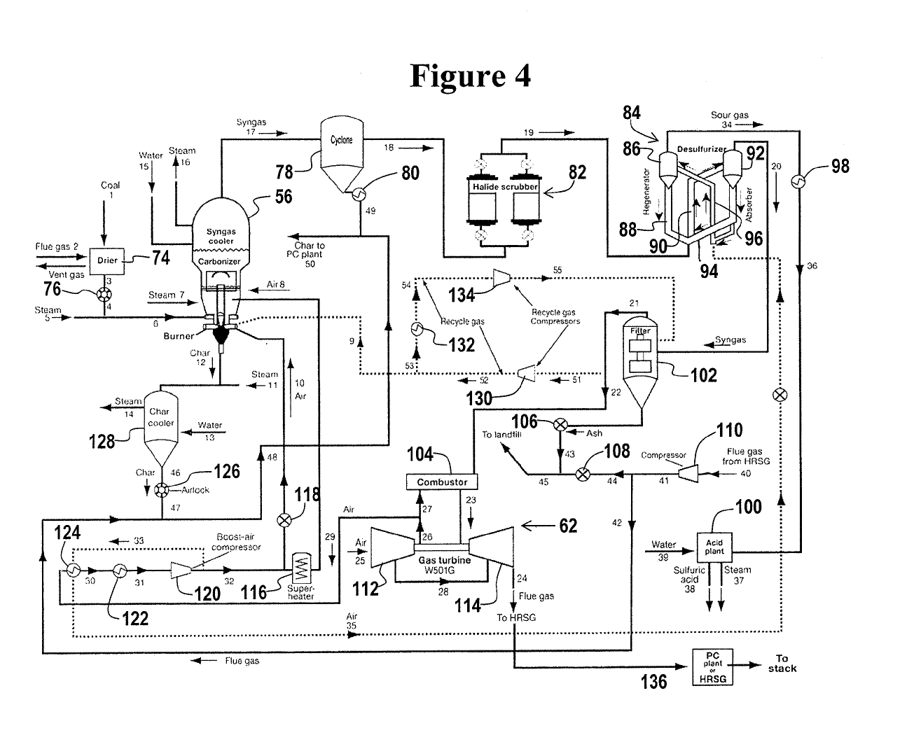

An exemplary process flow sheet for some embodiments of the invention is shown in FIG. 4. The carbonizer 56 is fed coal 1, steam 7, and air 8 to produce syngas 17. The syngas 17 is cooled by coolant tubes in a fluidized-bed cooler located, e.g., in the upper region of the carbonizer's pressure vessel.

The syngas 17 leaving the carbonizer 56 flows through a cyclone 78, which removes char fines 50, cools them, and conveys them to the PC plant or to a fluidized-bed combustor. The syngas 18 then flows through the warm-gas cleanup system, including a halide scrubber 82, desulfurizer 84, and high-temperature filter 102. The desulfurizer 84 includes a regenerator 86, whose exhaust stream fed to an acid plant 100 to produce sulfuric acid 38. The cleaned syngas leaves the filter 102 and is burned in the gas turbine's combustor 104. Steam may be added at the combustor 104 to increase output and reduce NOx emissions. Alternatively, steam (e.g., to increase output) may be injected into the syngas to cool it. Some of the syngas can be used as “recycle gas,” i.e., can be fed to the external burners of the carbonizer 56 and clean the elements in the high temperature filters.

The excess char 12 is removed from the carbonizer 56 through a cooler 128 and airlock 126. From there, it is conveyed 50 to the retrofitted PC plant or fluidized-bed combustor, pulverized, optionally cleaned, and burned. In some embodiments, where the char 12 is burned in a PC plant, the char is cleaned prior to burning. The existing steam plant's burners can be modified to burn char instead of coal. If the existing boiler is to be used as the HRSG, the excess air in the gas turbine's flue gas may be used to burn the char. The flue gas is ducted to the existing boiler through insulated pipes after passing, if necessary or desired, through a cooler.

The air for gasification, operating the external burners and the desulfurizer regenerator, comes from the gas turbine's compressor. Boost-compressors can be used to pressurize the recycle-gas, air to the gasifier, external burners and desulfurizer, and, in some embodiments, flue gases that are used for pneumatic conveying. One or more superheaters may also be used to preheat the air and steam used to gasify char.

In some embodiments, the char generated in the carbonizer of a new installation may be used as a fuel in a separate facility, such as a steam powerplant. Alternatively, it may be integrated with a steamplant, in which the char is burned either in a pulverized coal plants, or in a fluidized bed combustor. Fluidized bed combustors typically have a greater tolerance for difficult fuels, such as the low-reactive char coming from a pressurized carbonizer, as well as high-ash fuels. The ash concentration in the char from the carbonizer in some embodiments is much higher than in the coal from which it came. This is because the ash in the coal is retained in the char, but only a small fraction of the heating value is retained. The higher the level of gasification, the more severe this problem is, and the higher the ash concentration in the coal, the more severe it is.

In some embodiments, a pressurized fluidized bed is preferred over an atmospheric pressure one, because of the smaller size and therefore lower cost of the combustor. In some embodiments of the invention that use carbon capture, the pressurization of the flue gas of the fluidized bed combustor also reduces the size and cost of the carbon dioxide absorber equipment, as well as the power required to pressurize the carbon dioxide to the pressure required for sequestration.

Other benefits of using a fluidized bed combustor to retrofit an existing steamplant, instead of the existing boiler to burn the char, include the life extension of the plant that occurs when its life-limiting system, the boiler, is decommissioned when it is replaced by PFBC (pressurized fluidized bed combustor). Life extension not only preserves the value of existing equipment, but also improves the economics of retrofitting plants that may still have enough life to operate, but not enough to pay for a retrofit. Such plants would likely continue to emit high levels of carbon dioxide for their remaining lifetimes. On the other hand, burning the char in the existing boiler eliminates the cost of the fluidized bed combustor.

The Carbonizer

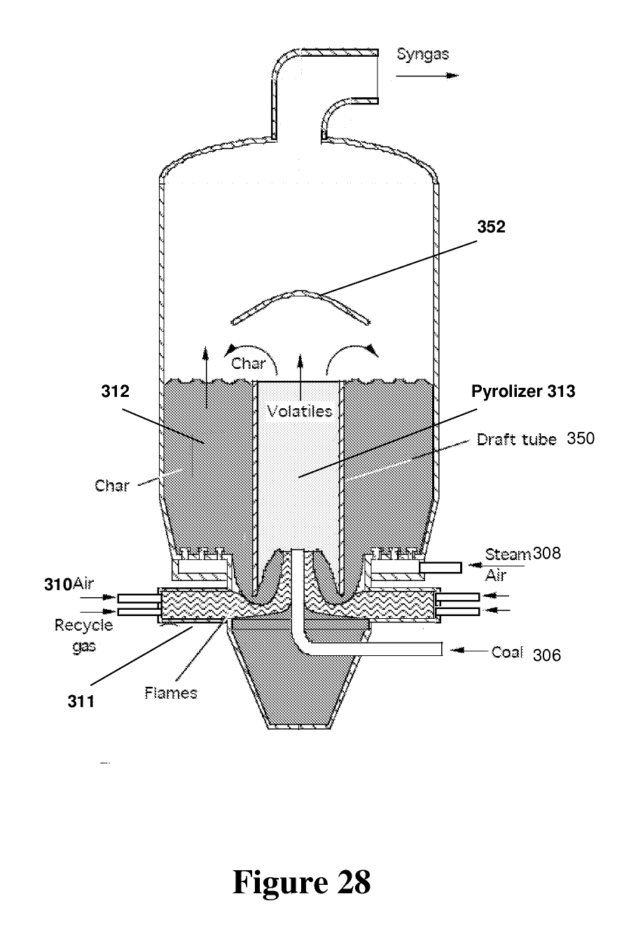

In some aspects, the hybrid IGCCs utilize a carbonizer. In some embodiments, the carbonizer forms a syngas. In some embodiments, the carbonizer utilized in the present invention is designed and operated in a way that preserves the volatile matter in coal, rather than destroying it. In some embodiments, the carbonizer contains three reactors: a burner or an array of burners 311, and two gasifiers 312, 313, e.g., gasifiers operating in parallel (see, e.g., FIG. 28). One gasifier (e.g., the pyrolyzer 313) produces volatiles, while the other gasifier 312 produces a mixture of carbon dioxide and hydogen, e.g., by the water-gas reaction.

In a conventional carbonizer, air is injected into the gasifier to heat the incoming flows by partial combustion. The volatiles are largely combusted by this air and the remaining tars are removed by operating the gasifier at a sufficiently high temperature to thermally crack them. In some embodiments, to avoid the destruction of the volatiles, the carbonizer utilized in the present invention heats incoming flows with external burners, whose products of combustion, in certain embodiments, are oxygen-free. The air injected into the carbonizer utilized in some embodiments of the present invention to help gasify char, is isolated from the volatiles by an internal separator or draft tube 350. Without wishing to be bound by any particular theory, it is believed that the result of using three reactors is that the airflow required for gasification and to heat the incoming flows is reduced by about ⅔, and the volumetric flow rate of the syngas, by about a half. This reduces the size and cost of the equipment in the gasification train accordingly.

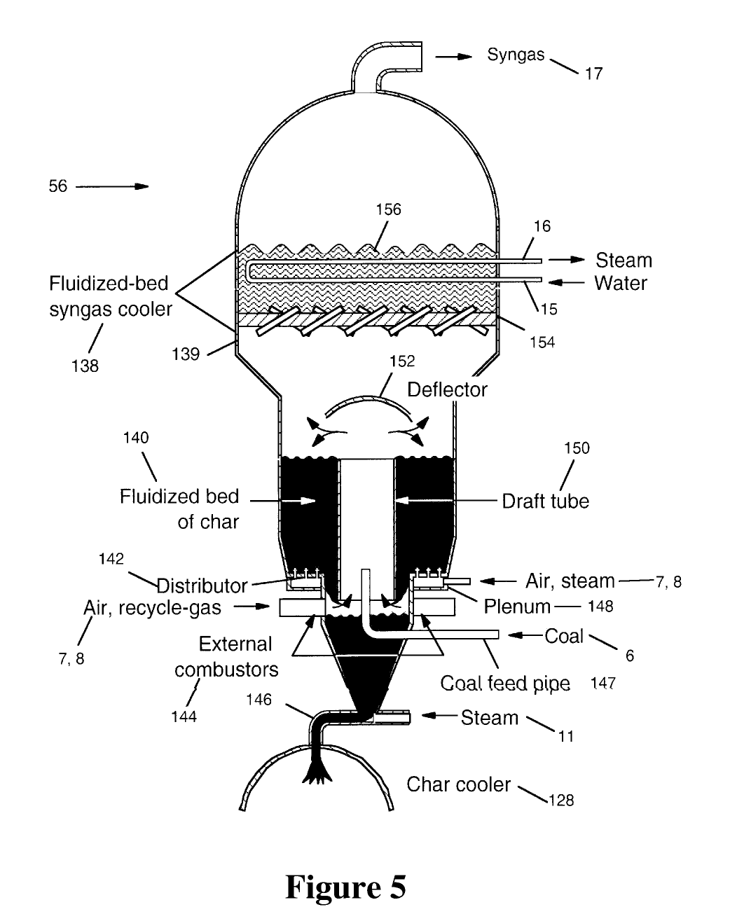

In some embodiments, the present invention includes a fluidized bed carbonizer (i.e., a carbonizer which comprises a fluidized bed). An exemplary fluidized bed carbonizer 56 is shown in FIG. 5. An exemplary carbonizer 56 consists of pressure vessel 139 that has an interior region defined by a draft tube 150 fed by the flow, e.g., jet, of gases emerging from external combustors 144, in which the flow through the draft tube 150 is upwards, and an outer annulus 140 of hot fluidized char, in which the flow of solids is generally downward. Fluidization is caused by steam 8 and air 7 injected through a distributor plate 142 at the bottom of the annulus, which also gasifies char, producing a mixture of carbon monoxide and hydrogen, e.g., by the water-gas reaction. The flow of solids around the bed begins with the entrainment of char by the gases in the draft tube, continues with their deflection by deflector 152 back onto the annulus, and ends with their downward flow through the annulus to complete the loop.

The incoming flows (of coal 6, air 7, and steam 8) may be heated by external combustion 144. In some embodiments, this is provided as an array of external burners 144 mounted radially on the perimeter of the carbonizer 56. The burners 144 are used to keep the carbonizer 56 at its design temperature by heating char particles as they become entrained by flow from the burners 144. A central pipe or draft tube 150 promotes the upward flow. The tops of the burners are just underneath the opening in the draft tube 150. Alternatively, a single vertical combustor could be mounted a controlled distance under the inlet of the draft tube.

In some embodiments, the flows of air and/or recycle gas to the external burners are controlled to burn the recycle-gases to completion, forming CO₂ and water vapor. Burning carbon to completion uses only half the air that is needed in conventional air blown gasifiers, which produce CO. Preserving the volatiles also reduces the energy required for producing the syngas, as pyrolysis is less energy-intensive than gasification. Altogether, the airflow to the carbonizer 56 of some embodiments of the invention is only 30% that of a conventional air blown gasifier. (See, e.g., FIG. 26.)

In some embodiments, the present invention includes a spouted bed fluidized bed carbonizer. A fluidized bed gasifier with central jet to promote circulation is referred to as a “spouted bed” if the central jet penetrates the surface and a “jetting bed” if the central jet does not penetrate the surface. In some embodiments, a spouted reactor is used in connection with the present invention because it excels at keeping the entire volume in the reactor mixed—a quality known as “global mixing”. For example, global mixing may occur in reactors as large as 15 ft in diameter, the size of reactor which can be utilized in connection with the some embodiments of the present invention, e.g., to feed a 400-MW power plant from a single vessel.

In some embodiments, the spouted bed fluidized bed carbonizer includes a draft tube. Although the use of draft tubes in spouted beds is unusual, they have been successfully tested in a full-scale (cold model) carbonizer. The draft tube in these embodiments promotes circulation, and also preserves the volatiles by isolating them from the air in the annulus. The flow through the draft tube is in dilute phase, so its pressure drop is low compared with the pressure at the bottom of the fluidized bed. This promotes char circulation, which in turn further helps keep the char temperatures uniform throughout the carbonizer. The mixing avoids the occurrence of hot spots which could clinker the ash, or cold regions in which the gasification would be too slow.

In some embodiments, the flow rates of the steam and air injected into the bottom of the annulus is metered to provide the desired amount of water-gas. The heat created by the exothermal reaction (of air reacting with char, forming carbon monoxide) may be modified or controlled such that it equals the heat required by the endothermic reaction (steam plus char forming hydrogen). The water-gas may pass through the char, and emerge from the top of the carbonizer (e.g., with the volatiles emerging from the draft tube), thereby forming syngas. In some embodiments, the nitrogen from the air (e.g., airflows 8 and 10) remains mixed with the syngas.

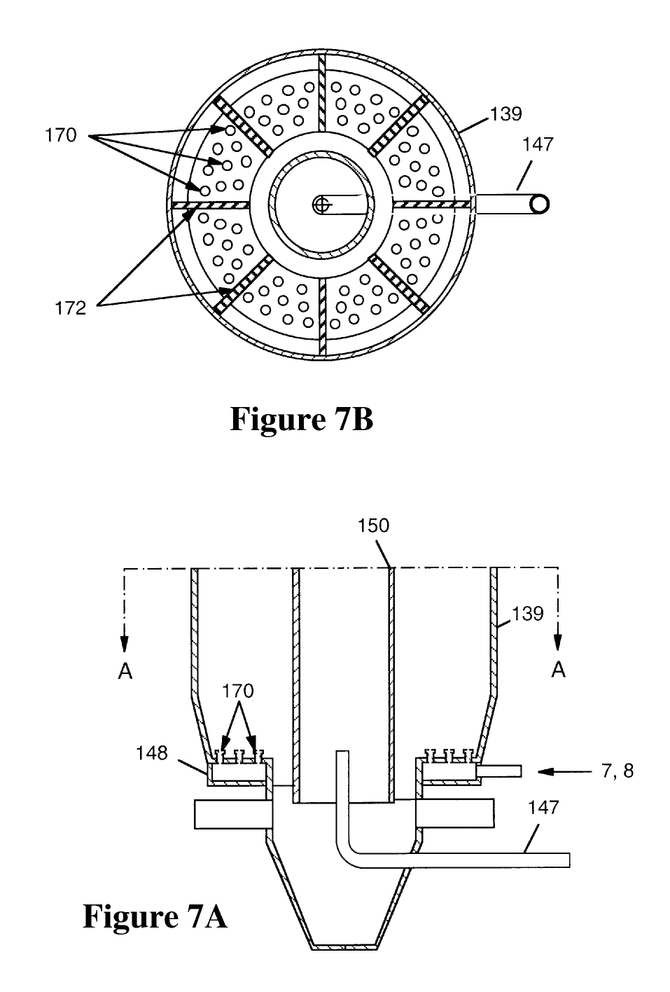

In some embodiments, the air and steam are injected into a plenum 148 at the bottom of the char bed 140, and enter the bed through bubble caps 170 in the plenum's top surface (See, e.g., FIG. 7A.).

In some embodiments, excess char may be removed from the carbonizer via the hopper at its bottom, at a rate determined by a control valve. An exemplary control valve is the “L” valve 146 which uses the pressure of steam flow 11 to regulate char flow through the valve 146. The char flow rate may be controlled, e.g., by a level sensor at the side of the carbonizer 56, so the top of the bed is at the a desired point. In some embodiments, the desired point is the same altitude as the top of the draft tube 150. Bottom-removal of the char may be preferred because, for example, it reduces or eliminates the possibility of a buildup of oversize particles in the char bed 140 that might otherwise defluidize the bed. From the “L” valve 146, the char may then pass through the char cooler 128, which may be cooled by steam tubes, before being depressurized through an airlock and transported to the PC plant or fluidized bed combustor.

In some embodiments, to operate the carbonizer, the unit is started with the annulus filled with char, by turning on the external burners 144 and fluidizing flows. Circulation, as well as heating of the char, may begin immediately. When the bed has reached its operating temperature, coal 6 may be fed through a coal feed pipe 147 into the bottom of the draft tube 150. The coal particles may be enveloped, and quickly heated, by a high flow of circulating char. The volatiles may then be released by the heat, and flow out of the top of the draft tube 150 along with the circulating char and newly-devolatized coal.

In some embodiments, the pyrolysis of the coal will be largely completed by the time the particles leave the draft tube. To the extent that more reaction time is needed, pyrolysis may be further accomplished or completed in the upper region of the char bed.

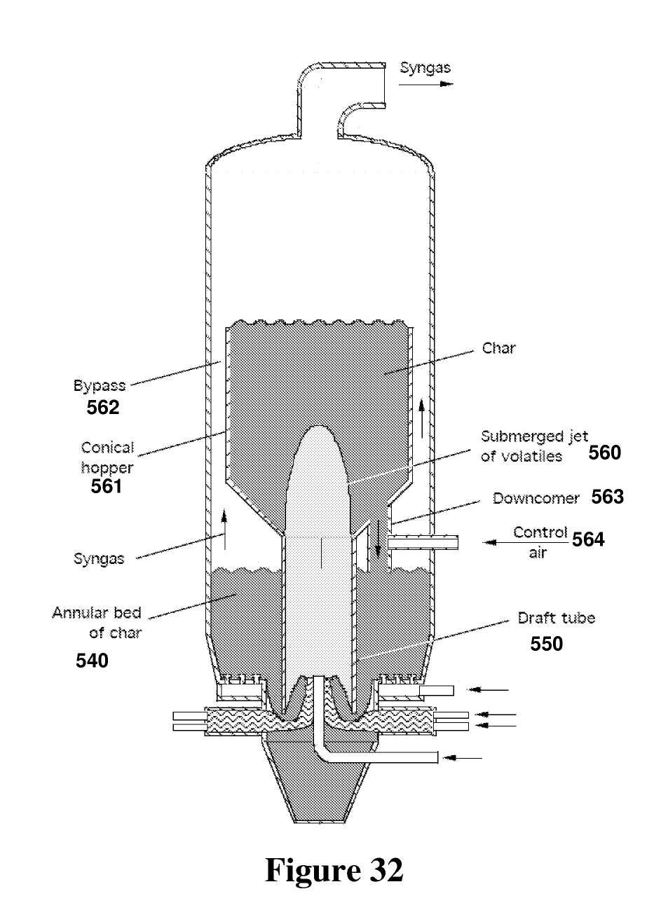

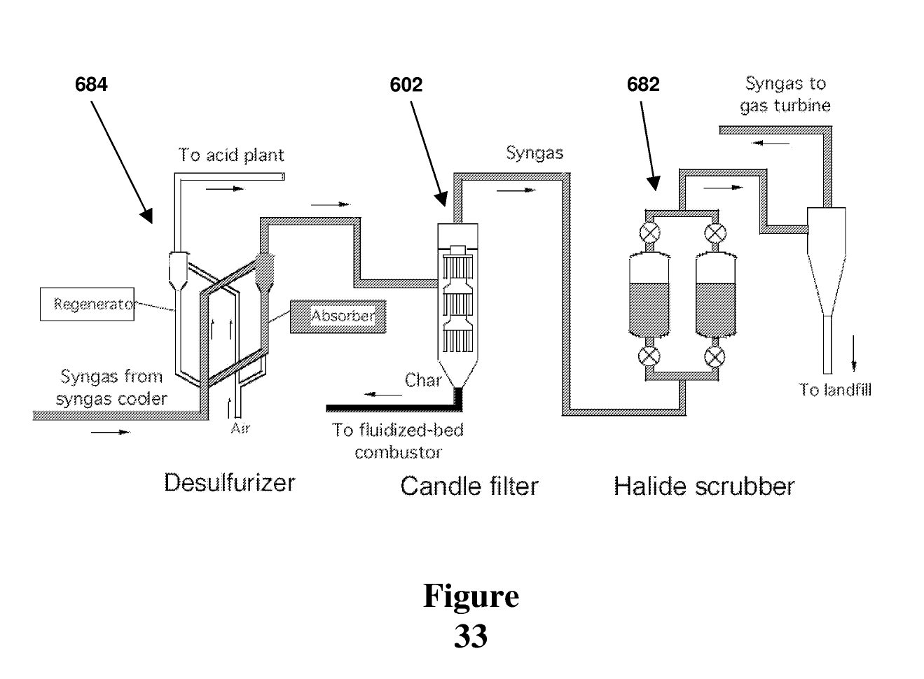

Referring generally to FIG. 32, in some embodiments, the carbonizer 556 of the present invention includes an annular bed of fluidized char surrounding a draft tube 550; a bed of fluidized char defined by a conical hopper 561 that extends beyond the top of the draft tube 550, and comprising a cylindrical extension sufficiently tall to avoid penetration of volatiles emitted from the draft tube 150; and a bypass channel 562 defined by an inner wall of the carbonizer 556 and an outer wall of the cylindrical extension of the conical hopper 561, for escape of syngas 517 formed in the annular bed. Optionally, the carbonizer 556 may further include a downcomer 563 in communication with the bottom of the conical hopper 561 for supplying a controlled amount of air 564 for maintaining the surface of the annular bed at a desired height. In some embodiments, the char bed 540 is deepened, such that it extends over the outlet of the jet 560 emitted from the draft tube 550. This can eliminate the need for the deflector over the draft tube, e.g., if erosion occurs at an unacceptable rate. This may also serve to thermally crack tar in the volatiles. The conical outlet over the draft tube 550 enables the syngas 517 from the char bed to accelerate, while the superficial velocity of the products of combustion over the outlet of the draft tube 550 declines. In some embodiments, without this conical outlet the carbonizer's diameter would have to be increased substantially.

In some embodiments, after the syngas leaves the carbonizer and is cooled, it is maintained above the temperature at which a sufficiently small percentage of the vapors condense in the warm-gas cleanup system and beyond, whereby a sufficiently-small percentage is one whose tar content is insufficient to impede the operations of downstream elements, but below the highest operating temperature of the warm-gas cleanup system. Typically, the temperature range for meeting these conditions is between 1000° F. and 1200° F.

In some embodiments, the operating temperature of the carbonizer is sufficiently high to avoid the formation of a preponderance of phenols, but low enough to avoid the formation of a preponderance of high-molecular-weight compounds such as polycyclic aromatic hydrocarbons. In some embodiments, this optimal operating temperature is between 1600° F. and 1700° F. An excessive concentration of these compounds may cause fouling in the elements of the gasifier train downstream of the syngas cooler.

As described above, in some embodiments the where the fluidized bed sits above the draft tube. In some such embodiments, thermal cracking of the tars in the volatiles is achieved with a draft-tube extension. It was previously thought that tars in volatiles could be kept vaporized at the temperature of a warm-gas cleanup system. This thought was reasonable considering the data for the volatiles' boiling points at atmospheric pressure. However, it has since been discovered that volatiles' boiling points are increased by pressure. Accordingly, in some embodiments of the present invention, tars are thermally cracked before they leave the carbonizer to avoid fouling.

In one such embodiment of the invention, thermal cracking is provided by a carbonizer 1056 that includes an annular bed of char 1006 extending about the draft tube 1050 and located below a tar-cracking fluidized bed 1004. In some embodiments, a jet 1002 is provided on the tip of the draft tube 1050 and extends into the tar-cracking fluidized bed 1004. In some embodiments, the depth of the fluidized bed 1004 is sufficiently less than that of the char bed 1006, e.g., by about a third of the depth of the char bed 1006, to, for example, ensure adequate circulation of the char, as shown in FIG. 49.

In some such embodiments, thermal cracking of the tars in the volatiles is achieved with an overhead fluidized bed as shown in FIG. 50. In some embodiments, the carbonizer 1156 includes a deflector 1152 positioned substantially over the outlet of the draft tube 1150 and diverts the coarse char back to annular bed 1106. In some such embodiments, the char fines, most of which are believed to have formed in the bed 1106, may become entrained in the syngas which passes through a distributor plate 1142 and into fluidized-bed 1104. In some embodiments, a preferred fluidized-bed 1104 material is dolomite, which also catalytically promotes the thermal cracking of tar and thereby reducing the bed depth requirement. In some such embodiments, the dolomite particles are made coarse enough to enable the superficial velocity in the fluidized-bed 1104 to be higher than it could be in prior embodiments, so that the diameter of the reactor is smaller than that of such prior embodiments. In some embodiments, the dolomite in the fluidized-bed 1104 could also be used to desulfurize the bed.

Without being limited to a particular theory, it is believed that the design shown in FIG. 50 is advantageous because it eliminates slug-bed flow in the draft tube 1150, and replaces it by dilute-phase flow instead. This replacement may reduce the stresses created by slug flow on both the draft tube 1150 and the surrounding structures, and/or improve the mixing between the circulating char and the incoming coal, speeding its devolatization.

In some embodiments, the shape of the deflector 1152 includes a deep pocket, as seen in FIG. 50. In use, the deep pocket is a dead-end passage that fills with material. When the deep pocket is filled with material, any further incoming material is diverted by the trapped material in the deep pocket, rather than the surface of deflector 1152. Without being limited to a particular theory, this deflector 1152 design is expected to reduce the erosion rate of the deflector 1152.

In some embodiments, an overflow is provided for controlling the depth of the fluidized-bed 1104. Such an overflow may control the depth of the fluidized-bed 1104 in case more coal is needed to maintain the bed temperature at its set point than is provided by the emission of char fines from the carbonizer 1156. In some embodiments, an overflow is not provided, but a sensor is provided instead to measure the depth of the fluidized bed 1104 of char and, at certain level, trigger removal of excess char from an opening in the bottom cone.

External Burners with Excess Air

Indirect gasification uses an external source of energy, such as external burners, to heat the incoming flows to the gasifier temperature. The gasifiers are called allothermal, in contrast to the conventional air-blown or oxygen-blown gasifiers, called autothermal, in which the energy for heating the incoming flows is provided by partial combustion within the gasifier. In some embodiments, allothermal gasifiers are preferred because they produce volatiles with heating values higher than autothermal gasifiers. In some embodiments, autothermal gasifiers are preferred because they typically destroy the tars that tend to deposit in low-temperature syngas coolers.

In some embodiments, mild gasification is used to treat the char fines and, as the term is used herein, refers to burning the char fines, as opposed to gasifying them. The char fines are the char particles small enough to be entrained by the velocity of the syngas in the gasifier. In some embodiments, the gasifier is an internally-circulating fluidized bed, consisting of a draft tube surrounded by a fluidized-bed of char. In some embodiments, relatively coarse coal is fed into the system, and most of the char is coarse enough to remain in the bed until gasified. In some such embodiments, about only 10-20% of the char becomes fine enough to be blown out of the bed as char fines. Therefore, some embodiments of the invention provide for a uniquely-dense reactor that gasifies most of the char, as the bed is entirely made up of reacting solids.

In some embodiments, e.g., when using the methods or systems of the present invention for carbon capture, elimination of tars and/or hydrocarbon vapors in the volatiles is afforded by adding sufficient excess air to the external combustors to burn them (e.g., in the draft tube). Tars and/or hydrocarbon vapors must be converted into carbon monoxide and hydrogen if their carbon is to be converted to CO₂ in a shift reactor. The system can also reduce or eliminate the possibility that tars are formed whose condensation temperature exceeds the operating temperature of the warm gas cleanup system.

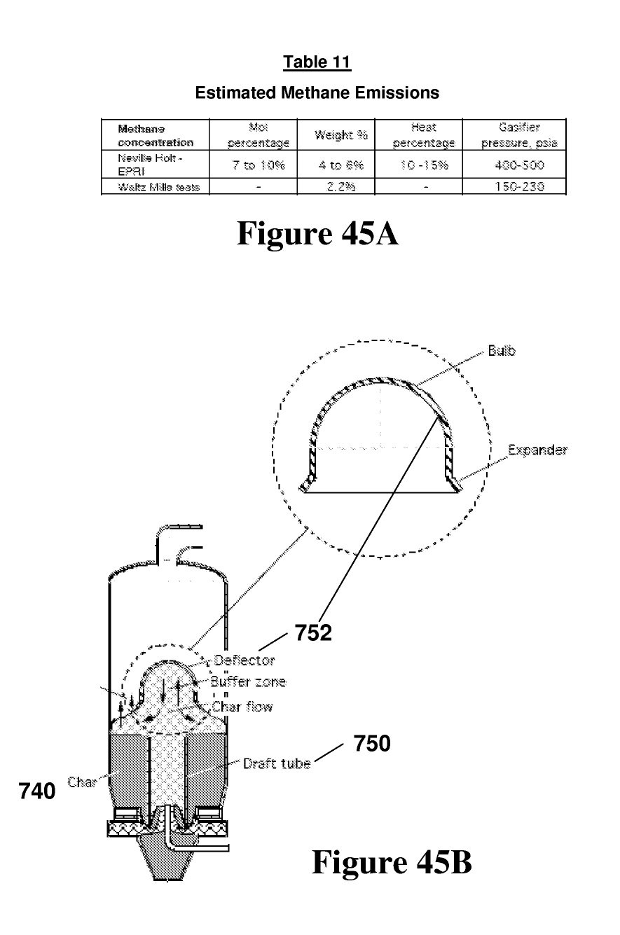

Testing at the pressurized-gasification coal-fired pilot plant at the Waltz Mills Research Laboratory in the late 1970's has indicated that the volatiles can be rendered free of tars with the addition of air with an air-to-coal ratio of as little as 5%. According to these tests, in some embodiments, the preferred embodiment of the carbonizer may also produce less methane as a conventional airblown gasifier. Lowering the methane concentration increases the level of CO₂ that can be removed from the syngas (See, e.g., FIG. 45A).

The most common indirect gasifiers use two interconnected reactors (see, e.g., Jose Corella et al., Ind. Eng. Chem Res. 2007, 46, 6831-6839), one for gasifying the fuel, the other for burning the char to provide the heat. Circulating solids, typically, inert bed material, transfers heat between the two, but the gases leave each reactor through separate conduits. Other designs incorporate the two reactors within a single vessel, but still with separate outlets for the products of combustion and the syngas. Use of an external vent requires a separate cleanup system, with a pressurized gasifier, would waste a lot of energy contained in the pressurized fluegas. Therefore, in some embodiments of the present invention, the products of combustion are mixed into the gasifier.

Accordingly, in some embodiments, external burners with excess air are utilized in the IGCC plants of the present invention. Such external burners may provide the air to burn the tar in the volatiles. In some embodiments, the outlets of the burners face the entrance of the draft tube. In some embodiments, the outlets of the burners contain fully-combusted recycle gas. Use of the recycle gas can eliminate the slagging that would occur if coal or char were used, and the burners allow the fuel to be burned to completion, whereby the carbon in the syngas is converted into CO₂. Carbon that is completely burned needs only about half as much combustion air per BTU as it would if it were burned to form CO (e.g., in an autothermal gasifier).

Using external burners with excess air, even at a level higher than about 5%, (e.g., much higher than 5%, e.g., about 7%, about 10%, about 15%, about 20%) may, in some embodiments, be needed to eliminate the tars in syngas to make it suitable for carbon capture. In some embodiments, excess air burns enough volatile matter to eliminate hydrocarbon vapors and provides some of the heat for the water-gas reaction in the char bed. Accordingly, in some embodiments, using external burners with excess air reduces the char-bed area (e.g., by reducing volumetric flowrate through the char bed). Using external burners with excess air may also increase the airflow required by the carbonizer by increasing the need for steamflow to the tar bed because the char is no longer being gasified by partial combustion. Using external burners with excess air may also produce more hydrogen (e.g., more hydrogen than would be produced if the heat for the water-gas reaction was all provided by air injected into the char bed). Having more hydrogen means less has to be converted in the shift reactor, which reduces the efficiency loss when the unit is upgraded to CCS. The energy loss in the water-gas shift reactor can represent the largest efficiency loss of upgrading some embodiments of the invention to providing carbon capture.

Using external burners with excess air may also provide quench cooling. In a CCS upgrade, the syngas cooler may be replaced by quench cooling produced by spraying water directly into the carbonizer's freeboard, as that reduces or eliminates the boiler capacity needed for this steam needed in the shift reactor. Using external burners with excess air may also have a negligible effect on the heating value of the syngas. Typically, the more air that is added to the draft tube, the lower the heating value of the syngas, and the larger the size of equipment in the warm-gas cleanup system. At the relatively low amounts of excess air expected to be needed to eliminate the tars, this effect would be minor.

The Syngas Cooler

In some embodiments, the IGCCs of the present invention include a syngas cooler 138 (See, e.g., FIG. 5). The syngas cooler 138 may be a fluidized bed 156 with imbedded coolant tubes that is located, e.g., in the upper region of the carbonizer pressure vessel. Coolant 15 can enter the coolant tubes, and leave as steam 16. The fluidized bed may be mounted on a distributor 154 that allows the syngas to pass through it. The fluidized bed 156 may, for example, be made up of low-silica granules. In some embodiments, there is no feed to or from the bed other than the material (e.g., low-silica granules) that may be required from time to time to maintain a constant inventory of free-flowing material. In some embodiments, the syngas cooler 138 is located (e.g., mounted) within the carbonizer vessel, which eliminates the need for the high-maintenance, high-temperature conduits between carbonizer and cooler that would otherwise be required.

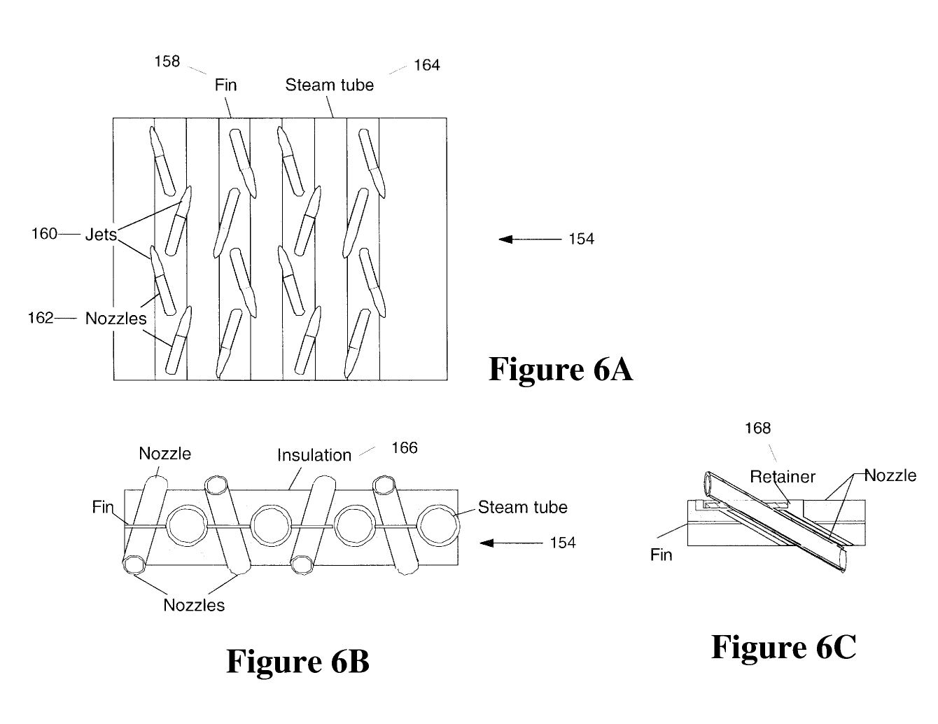

An exemplary distributor plate 154, e.g., for use in the syngas cooler 138 of some embodiments of the present invention is shown in FIGS. 6A-6C. The distributor 154 may consist of an array of slanted tubes or nozzles 162, whose angle relative to the horizontal is less than the angle of repose of the bed material. Such a configuration may hinder or prevent weepage of the bed material through the distributor during shutdown. Without wishing to be bound by any particular theory, it is believed that the use of straight passages through the distributor will hinder or prevent buildup by particulates in the syngas. Such a buildup may occur in conventional bubble caps, where there is change of direction of the gases. The tubes may be mounted on a fin-tube array, which are welded assemblies of fins 158 and tubes 164. Coolant flowing through the tubes can keep the plate cooled and structurally intact. The tube assembly may be insulated from the bed and surrounding gases by insulation 166. The tubes may also be insulated from the fin-tube assembly to avoid condensation of the tars. In some embodiments, the design and effectiveness at avoiding fouling are the same or similar as those described in dual-bed fluidized-bed combustors.

In some embodiments, the fluidized-bed cooler has higher heat transfer coefficients than the water-tube heat exchangers used in conventional systems. In some embodiments, the fluidized-bed cooler has lower syngas volumetric flow rates and thus a lower heat transfer than the water-tube heat exchangers used in conventional systems. In some embodiments, the fluidized-bed cooler has a lower syngas temperature difference than that of conventional airblown IGCCs. As a result, in some embodiments, the fluidized-bed cooler is as small as a tenth of the size of the water-tube heat exchangers used in conventional systems. (See, e.g., FIG. 18). Boiler feedwater may be used instead of steam as the coolant, as its low temperature further reduces the cooling piping required. The feedwater may boil in the in-bed pipes, and its outlet temperature can be controlled by adjusting the feedwater flow rate.

In some embodiments, a conventional syngas cooler, e.g., a firetube boiler, is not utilized in the present invention because the volatile condensation can cause tar buildups. Accordingly, in some embodiments, the turbulence of the fluidized bed keeps buildups from occurring.

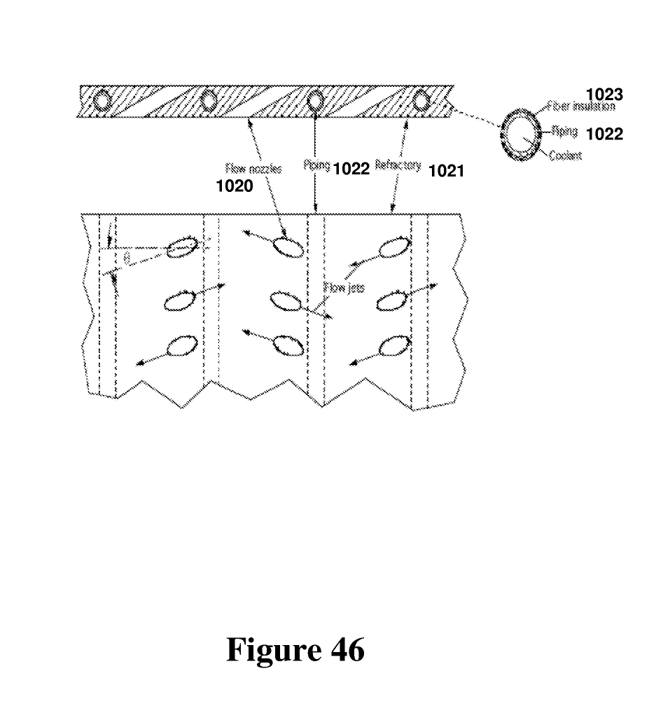

In some embodiments, the alternative fluidized bed syngas cooler shown in FIG. 46 is utilized in connection with the IGCC of the present invention. Instead of using refractory inserts to insulate the syngas, the openings through which the syngas flows 1020 are cast into the refractory 1021. The refractory assembly can be supported, e.g., by imbedded steam tubes 1022, which may be surrounded by a fibrous insulato 1023 to avoid thermal stresses. Without wishing to be bound by any particular theory, it is believed that the new design is more rugged, less prone to failure by erosion from high-chlorine coals, is better at insulating the ports from the cooling effects of the supporting coolant pipes than previous designs.

In another embodiment, the syngas is cooled by the injection of a coolant directly into the syngas, rather than with the fluidized-bed cooler. Use of direct injection can eliminate the cost of the fluidized bed cooler, and also reduce both the diameter and height of the pressure vessel surrounding it. High pressure steam is commonly injected into the combustors of airblown IGCCs to increase their power output. Injecting the coolant into the carbonizer's outlet instead serves both purposes: cooling the syngas, and increasing the power output.

In still other embodiments, jets of high-temperature steam are injected into the syngas leaving the carbonizer, and the jet flows are designed to provide a high degree of mixing of the steam with the syngas. Alternatively, spray bars may be used to inject the coolant, and water may be used instead of steam. The use of water eliminates the need for a demineralizer for the injected coolant, as well as the boiler surface to heat it, but it also reduces the output of the combined cycle plant. In some embodiments, the syngas cooler uses only about 20% of the heat transfer tubing as compared to a conventional firetube heat exchanger. In some embodiments, over half of that difference is due to the high heat transfer rates of a fluidized-bed heat exchanger, compared with a convection heat exchange in a firetube cooler. In some embodiments, the reduction in heat transfer tubing also due from lack of fouling with the fluidized-bed heat exchangers, in which the scouring action of the fluidized bed removes buildups that occur in firetube coolers. In some embodiments, the reduction of heat transfer tubing is further due to the warm-gas cleanup, which avoids the need to cool the gases to nearly the same temperature as the coolant, as is required in cold-gas cleanup systems. In some embodiments, the reduction of heat transfer tubing results in significant cost reduction of the syngas cooler.

The Syngas Cyclone

In some embodiments, the present invention includes a syngas cyclone (See, e.g., FIG. 4). Some char may be emitted from the carbonizer, particularly at higher levels of gasification. Unlike fly ash, most of the char is coarse enough to be captured in a cyclone 78. The cyclone catch 49 may be cooled in cooler 80 then combined with the char 47 leaving the char cooler. The two streams may then be conveyed to the PC plant or fluidized bed combustor through a convey line 50.

The Halide Scrubber

In some embodiments, the present invention includes a halide scrubber (See, e.g., FIG. 4). The halide scrubber 82 may remove hydrogen chloride and other halides. In some embodiments, the halide scrubber 82 is comprised of two 100%-capacity pressure vessels, each packed with a pebble bed of nahcolite or trona, minerals whose active ingredient is sodium bicarbonate. One vessel may be kept in service until the sorbent is saturated, with a nominal service period of two months. The second vessel may be purged, cooled, drained of spent bed material, and recharged. The vessels can be any size suitable for a halide scrubber, for example, 5, 10, 15 or 20 feet in diameter and 10, 20, 30 or 40 feet high. In some embodiments, the vessels are approximately 13 ft in diameter and about 25 ft high. The vessels may be fabricated of any material suitable for a halide scrubber, for example, carbon steel, with an inner lining of a stabilized grade of stainless steel and a refractory lining.

The Transport Desulfurizer

In some embodiments, the present invention includes a transport desulfurizer (See, e.g., FIG. 4). The transport desulfurizer 84 may use, for example, a reactor design typically used in oil refineries. In some embodiments, the transport desulfurizer 84 consists of an absorber loop, in which the sulfur compounds in the syngas are absorbed (e.g., by particles of a zinc-based sorbent), and a regenerator loop, which restores the sorbent. The active ingredient of the sorbent may be converted into zinc sulfide in the absorber, and back into zinc oxide in the regenerator.

Each loop may consist of a riser (90 and 96, respectively), a cyclone (86 and 92, respectively), and dipleg 88 and 94 respectively). The sorbent may be injected with the incoming gases into the bottom of each riser 90, 96, separated at the cyclone 86, 92 and re-injected at the bottom of the dipleg 88, 94. The risers 90, 96 may operate in a relatively dilute state, with a void fraction of about 95%. About 10% of the sorbent flowing through the absorber may continuously be circulated through the regenerator, and, in some embodiments, only about 10% of the active ingredient of a sorbent particle is reacted before it is regenerated. In some embodiments, these conditions result in capture efficiencies of more than about 95%, e.g., more than about 96%, about 97%, about 98%, about 99%, or even about 99.95%. In some embodiments, the conditions result in capture efficiencies of more than about 99.9%.

In some embodiments, absorption occurs at about the same temperature as the rest of the WGCU, although the reactions in the regeneration are exothermic. Accordingly, in some embodiments, the gases in the WGCU reach about 1300° F., e.g., about 1400° F., or about 1500° F. In certain embodiments, the gases in the WGCU reach about 1400° F. The gases leaving the regenerator may contain sulfur dioxide. In some embodiments, gases leaving the regenerator are then cooled in cooler 98 before being sent to the acid plant 100. Alternatively, gases leaving the regenerator can be reduced to elemental sulfur in a treatment plant.

The Acid Plant.

In some embodiments, the present invention includes an acid plant (See, e.g., FIG. 4). The acid plant 100 converts the sulfur dioxide in the regenerator gas into sulfuric acid 38. Unlike plants which make elemental sulfur, acid plants produce significant amounts of steam. The steam may be produced in a succession of catalytic reactions as the sulfur dioxide is converted into SO₃, e.g., at about 800° F. The steam 37 may be captured and reused, further improving the efficiency of some embodiments of the present invention. In some embodiments, an alternative to the acid plant 100, a Claus unit, which produces elemental sulfur instead of sulfuric acid, is utilized in the present invention.

Metallic Candle Filters

In some embodiments, the present invention includes metallic candle filters (See, e.g., FIG. 4). Metallic candle filters 102 are arrays of porous structures used to remove the fly ash and spalled sorbent. In some embodiments, individual filters are constructed of layers of alloy screens that have then been sintered. The resulting thick-walled construction may result in extraordinarily high collection efficiencies. Operated like baghouses or fabric filters, the filters can be cleaned by high-pressure pulses of recycle-gas 55 that breaks loose the filter cake on their surface, dropping it into a bin for removal. Self-acting valves on each filter element can automatically isolate it in case it springs a leak. The valves may be sufficiently fast-acting to avoid turbine blade damage, should it occur.

The Gas Turbine

In some embodiments, the present invention includes a gas turbine (See, e.g., FIG. 4). Gas turbines originally developed to serve as natural gas combined cycle powerplants (NGCCs) may be used for IGCCs. The capacity and turbine inlet temperature of gas turbines has been increasing since they were introduced in the 1960's, which has increased their efficiencies while lowering the per-kW cost. The gas turbine 62 used in the calculations used to describe the performance of some embodiments of the invention is based on the Siemens model SGT6-6000G, formerly the Siemens-Westinghouse W501G.

In some embodiments, the gas turbines used with syngas in connection with the present invention can be operated without modification. In other embodiments, gas turbines are modified. For example, gas turbines can be modified by opening up the flow passages through the inlet vanes of the expander to accommodate the higher volumetric flow rate of syngas. This may increase the stall margin and reduce the danger of flameout. Gas turbines operating with syngas may have a higher flow rate and power output than turbines operating on natural gas. In some cases, this may approach the torque limits of the turbine shaft.

In some embodiments using syngas, a combustor 104 can be employed that is normally of a pre-mix design with natural gas (to minimize NOx emissions), must be nozzle-mix (or, diffusion design) with syngas to avoid flashback due to the hydrogen in the syngas. In some embodiments, even diffusion burners can meet the NOx standards being established for IGCCs (15 ppmv). Some gas turbines may be subject to hot corrosion by the moisture formed by hydrogen in the syngas. In some embodiments, the gas turbine utilized is adapted such that it is not subject to hot corrosion by the moisture formed by hydrogen in the syngas.

Gas turbines operating on syngas may encounter flameout when its heating value is too low, and the syngas from conventional air blown systems sometimes approaches this limit. In some embodiments, the syngas produced has a heating value high enough to avoid flameout. In some embodiments, the syngas produced by the present invention has a heating value of about 300 BTU/SCF.

Fluidized-Bed Combustor

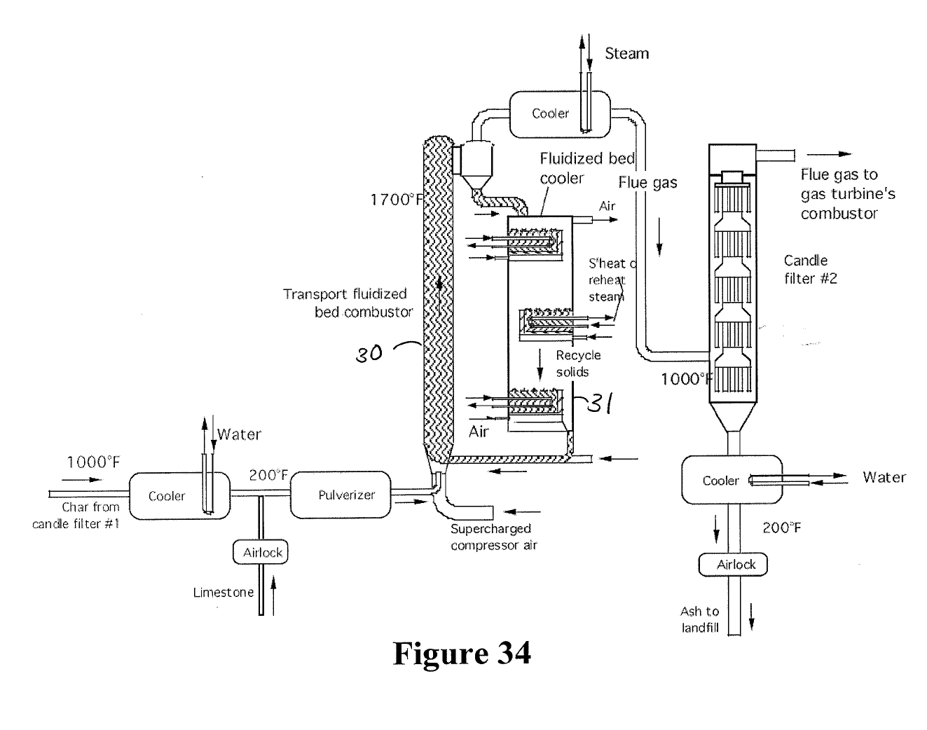

In some embodiments of the present invention, the char from the carbonizer is burned in a pressurized fluidized-bed combustor (FBC) instead of the existing steamplant of the PC plant. In some embodiments, the fluidized-bed combustor 30 has the configuration shown in FIG. 34. For example, in some embodiments, a circulating fluidized-bed is used instead of a bubbling-bed system to maximize the time that the char fines are surrounded by bed material, which promotes their combustion. In some embodiments, the heat exchangers in the return loop are similar to those of an atmospheric FBC. In some embodiments, the char is cooled and pulverized before it is fed to the FBC, to maximize the carbon conversion efficiency.

There are two major variations of hybrid IGCC: the partial gasification IGCC (also known as the advanced pressurized fluidized bed combustor IGGC, or APFBC) and the mild-gasification IGCC. In the APFBC, the ash from coal and other contaminants are removed from the gas stream emerging from the fluidized bed combustor, and the gasifier is used only to “top off” this gas by heating it to the temperature required by the gas turbine. Typically, the majority of the coal is consumed in the fluidized bed combustor, so the level of gasification is low. To be efficient, the temperature of the syngas cleanup system must be high, typically 1650° F., and despite years of effort, no reliable filter that is effective at such a high temperature was ever developed.

Variants of the mild gasification IGCC include the airblown gasification combined cycle (ABGC), which generally uses an atmospheric pressure FBC and the gasification fluidized bed combined cycle (GFBCC) which generally uses a pressurized fluidized bed combustor. In some embodiments of the invention, a GFBCC is used, including the pressurized fluidized bed combustor to burn the char fines. In the GBFBC, the ash and other impurities are removed from the syngas. The flowrate from a GFBCC's gasifier is typically much smaller than from an APFBC, because the latter includes the air needed for combustion, while the former does not. This in turn makes it possible to reduce the temperature of the syngas to one at which commercially-available syngas cleanup systems operate, without significantly reducing the plant's efficiency. However, this benefit has not generally been recognized, see, e.g., Proceedings from the 18^{th} International Conference on Fluidized Bed Combustion, Paper No. FBC2-5-78088, May 2005.

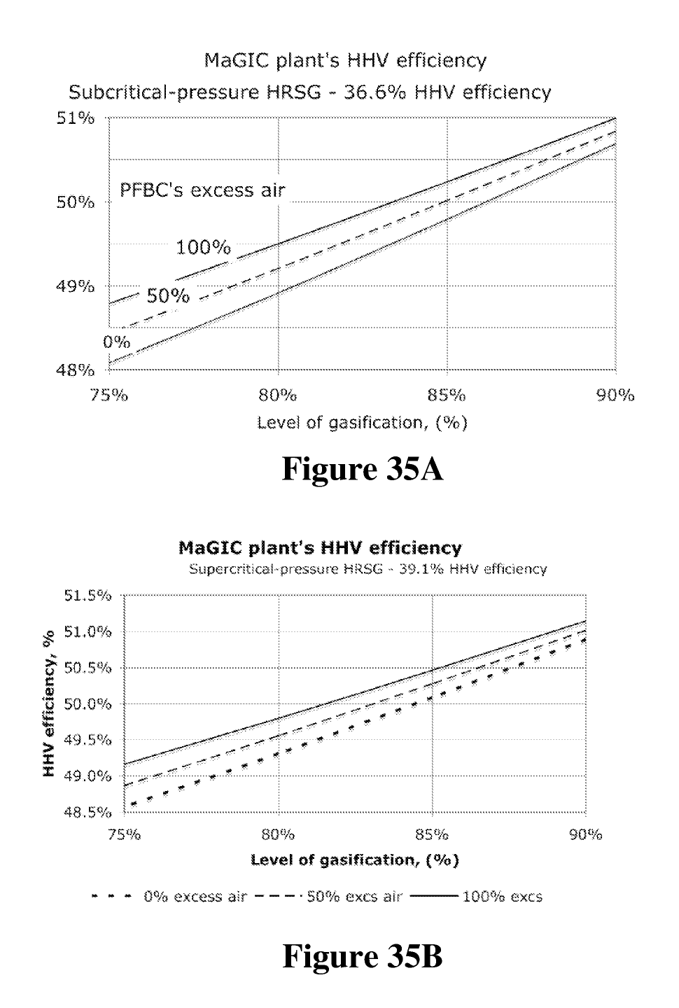

Accordingly, in some embodiments, a pressurized FBC is preferred over an atmospheric-pressure fluidized-bed combustor (AFBC), to minimize the size and cost of the vessel. The plant efficiency may also be greater than an AFBC system if the FBC's exhaust can be used to help power the gas turbine, rather than be used to generate steam. As is seen in FIGS. 35A and 35B, the plant efficiency is improved somewhat by the increased use of excess air in the FBC, as this reduces the amount of steam generated. However, the excess air increases the size and cost of the FBC, so in some embodiments, the system is optimized at an intermediate level of excess air.

In some embodiments, an internally-circulating fluidized bed is combined with mild gasification. In some such embodiments, the benefits of an internally-circulating fluidized bed are combined with mild gasification because burning char is upwards of a million times faster than gasifying them at the temperatures of airblown gasifiers, and, therefore, requires correspondingly less reactor volume, as compared to, for example, a boiler.

Auxiliary Systems

In some embodiments, the methods or systems can include one or more auxiliary compressors. In some embodiments, boost-air compressor 120 and recycle-gas compressors 130 and 134 are utilized to overcome the pressure drop through the gasifier train (see e.g., FIG. 4). Coolers 120, 122, and 132 upstream of the compressors may be used to increase efficiency and reduce their costs. In some embodiments, no cooler is used ahead of the first recycle-gas compressor, to avoid tar deposits. A flue-gas compressor 110 may also be used to pneumatically convey the char to the PC plant or fluidized-bed combustor. The flue gas may come, e.g., from the HRSG's or steamplant's stack.

Some embodiments of the present invention may include one or more heat exchangers. In some embodiments, the principal heat exchangers 128, 138 and 244 recover heat from the char and syngas. A significant amount of heat exchange may also occur in the acid plant 100.

Some embodiments of the present invention may include one or more coolers. Coolers include, but are not limited to, char coolers 128, char fines coolers 80 and regenerator-outlet gas coolers 98. The steam from the coolers can be used to generate steam for the steam turbine and to cool the syngas. In some embodiments, the waste heat is recycled to heat flows entering the gasifier, such as through superheater 116. In some embodiments, the waste heat is used to superheat steam flow 7 and airflow 8 that are fed to the carbonizer 56 to gasify char. Without wishing to be bound by any particular theory, it is believed that using waste heat to preheat flows to the carbonizer provides the highest conversion efficiency, and also reduces the external burner fuel requirement—in turn reducing the airflow to the gasifier and the corresponding syngas flow rate. In some embodiments, the incoming coal is heated to a temperature below the temperature at which volatiles are released, e.g., under about 700° F., e.g., under about 650° F., under about 600° F., under about 550° F., or under about 500° F. In some embodiments, the incoming coal is heated to a temperature below about 500° F.

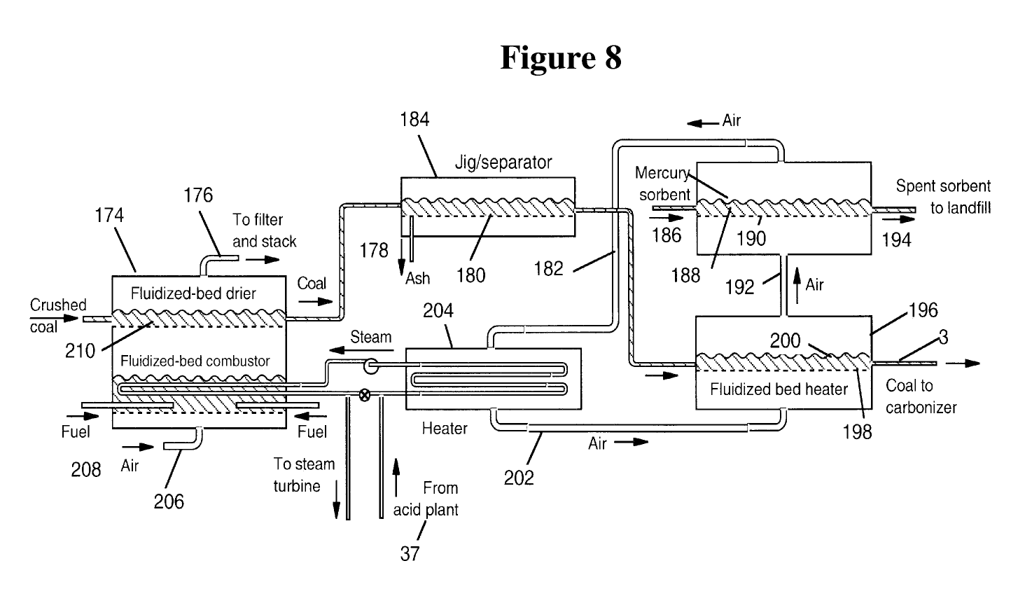

In some embodiments, the syngas cooler 244 is used to superheat the compressor discharge air 27 from the gas turbine. In some embodiments, the coal is dried and preheated, e.g., as seen in FIG. 8.

In some embodiments, the airflow to the external burners is not superheated, in order to minimize NOx emissions. In further embodiments, the coolant for the syngas cooler 58 is steam, not air, because there may not be enough space available for air tubes in the fluidized-bed cooler 138.

Some embodiments of the present invention may include a char cooler. In some embodiments, the char cooler 128 is a pressure vessel containing a moving-bed heat exchanger. For example, in some embodiments, the char particles cascade across heat exchanger piping, and are kept in free-fall by having the material from the vessel's bottom be removed more quickly than it is fed, which keeps the heat exchanger from filling. In some embodiments, heat transfer is in counterflow, with the water 13 entering at the bottom of the cooler and superheated steam 14 leaving at the top.

In some embodiments, additional elements, e.g., airlocks, pumps and the like, are utilized in connection with the present invention (e.g., in connection with the exemplary flow diagram of FIG. 4). Such elements may be used to provide and/or control the flow of gases, fluids and solids. Additional components may be employed in the hybrid IGCCs of some embodiments of the present invention without departing from the scope of the invention.

Exemplary Fuels of Some Embodiments of the Present Invention

Some embodiments of the present invention are suited for all grades of coal, as well as biomass. In some embodiments, however, the present invention may not be suited to using either petroleum coke (which may be too unreactive) or municipal solid waste (which may be too heterogeneous to fluidize). In some embodiments, the present invention is not suited to using petroleum coke or municipal solid waste without the petroleum coke or municipal solid waste being co-fired with coal.

Fuels for which the hybrid IGCCs of some embodiments of the invention is suited include, but are not limited to: bituminous coal, sub-bituminous coal, brown coal, lignite, clinkering, high-ash coals, biomass and high moisture coals.

Bituminous and sub-bituminous coals require no special processes for their use. However, the rank of the coal does affect the equipment size and operating conditions. As reactivity of coal diminishes with increasing rank, the lower-rank coals are preferable if very high levels of gasification are required. Also, the higher the rank of the coal, the lower is the coal's volatiles content, which means that more gasification is required, this in turn increases the cross-sectional area of the char bed.

The high moisture (upwards of 60% by weight) and sodium content of brown coal (or lignite) may require special treatment. Conventional driers that use only heat are undesirable as they are both fuel-intensive and costly. In some embodiments, steam fluidized bed drying (SFBD), developed by the German firm RWE in the 1980s, is utilized in treating brown coal or lignite. SFBD has been described as a heat pump in reverse. The most recent version is called “Fine-grained WTA”. WTAs dry the coal to relatively low moisture levels (as low as 12%) and use very little energy (12.2 kW/kg/s of raw coal).

In fluidized-bed gasifiers firing lignites and biomass, both of which are generally high in sodium, the sodium combines with silicates in the ash to form clinkers. To avoid this, finely-divided kaolinite and/or calcite powder may be injected into the carbonizer's freeboard to serve as “a getter” for the sodium. The powder is then collected with the fly ash at the filter. The powder can be used on a once-through basis, as it may become sticky otherwise.

In the syngas coolers of oxygen-blown IGCCs, cooling losses are so severe that oxygen-blown gasifiers are unsuited for high-ash coals. In this regard, some embodiments of the invention is the best-suited of any IGCC for high-ash coals because it can minimize both the temperature drop and the mass-flow through the syngas cooler. However, in some embodiments, the amount of ash in char going to the existing PC plant is significantly greater than the coal it replaces, because upwards of 40% of its heating value has been removed in the draft tube.

Conventionally-produced biomass, such as wood or switchgrass, is several times costlier than coal. However, since it avoids the need for sequestration it would be more competitive than it is now, once carbon-caps are mandated. A key benefit of biomass is that could provide a long-term alternative to coal, or in countries with biomass but no or little coal. Only minimal modifications would be required - primarily in the fuel feed system, and the clinkering-prevention measures described above—to make biomass usable in plants originally designed to burn coal.

Turndown

Turndown is a major issue in powerplants of all types, insofar as storing electricity is generally impractical. Conventional steamplants can be modulated to as little as 20% of their rated capacity with little change in efficiency, but the efficiency of gas turbines of combined cycle plants drops quickly with a reduction of throughput. This in turn requires the use of gas turbine peaking plants which, however, use the costlier fuels and are less efficient.

In some embodiments, hybrid IGCCs of the present invention can provide turndown and yet maintain high efficiency by simultaneously reducing the coal feedrate and increasing the gasification rate. The fuel energy to the gas turbine thereby may remain constant while the char fed to the PC plant and its power production are reduced.

To implement this, the annular bed in some embodiments of the invention's carbonizer may be comprised of a series of separated arc-shaped segments that are formed by radial separators 172, as shown in FIG. 7B. The segments created by the separators 172 may be individually fluidized according to power requirements. At full load, some of the segments may be left on standby as the maximum amount of the syngas is produced by pyrolysis in the draft tube. As the load drops, an increasing number of the standby segments may be turned on. FIG. 7B shows the segments to be of equal size, but for finer control, they may be made of different sizes. The segments in standby may be periodically turned on by briefly by injecting air into them, to maintain their temperature near the carbonizer's design point.

Mercury

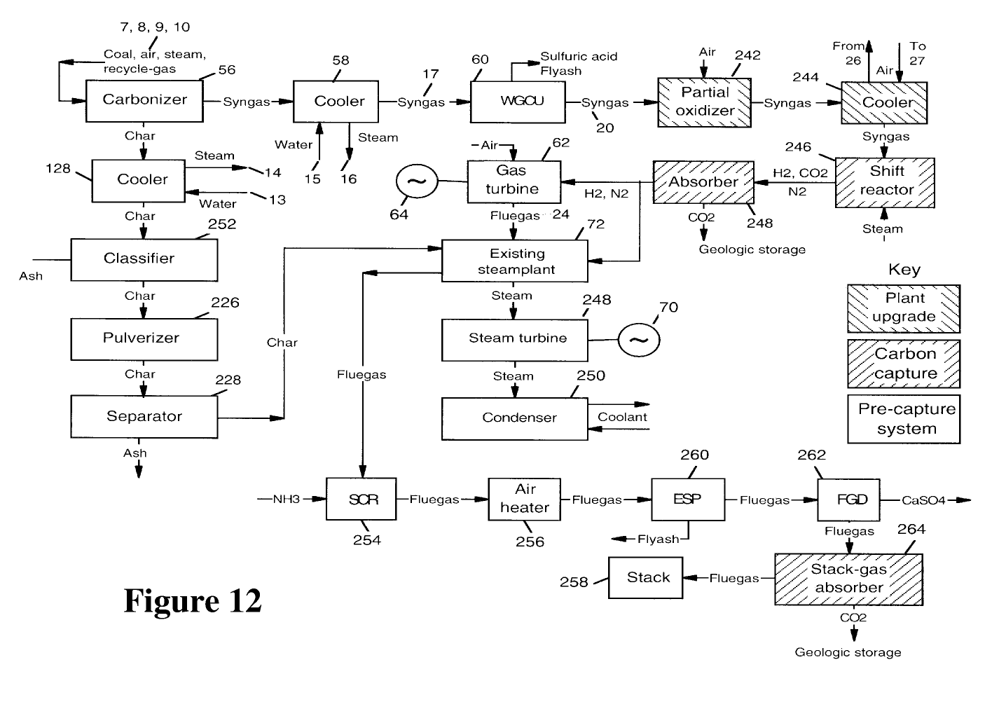

The technology used in conventional IGCCs to remove mercury uses a low-temperature process that may be unavailable for use in some embodiments of the present invention because it requires that the syngas be below the tar condensation temperature. Accordingly, in some embodiments, the present invention provides for the co-benefit capture of mercury using a selective catalytic reactor (SCR), fabric filters or electrostatic precipitator (ESP), and/or flue-gas desulfurizer (FGD) at the PC plant's stack. (See, e.g., FIG. 12). In some embodiments, e.g., embodiments using SCR, ESP and/or FGD, the mercury capture of the present invention removes about 90% of the mercury without special or additional treatment. An alternative or supplement is to inject chemically-treated activated carbon into the boiler's flue gas, ahead of its stack 258. Because many coal plants produce only a few pounds of mercury per year, this may be a viable option. The cost can be reduced further by using the char produced by the some embodiments of the invention, as the char from air blown gasifiers is nearly as reactive as the char used in commercial activated carbons.

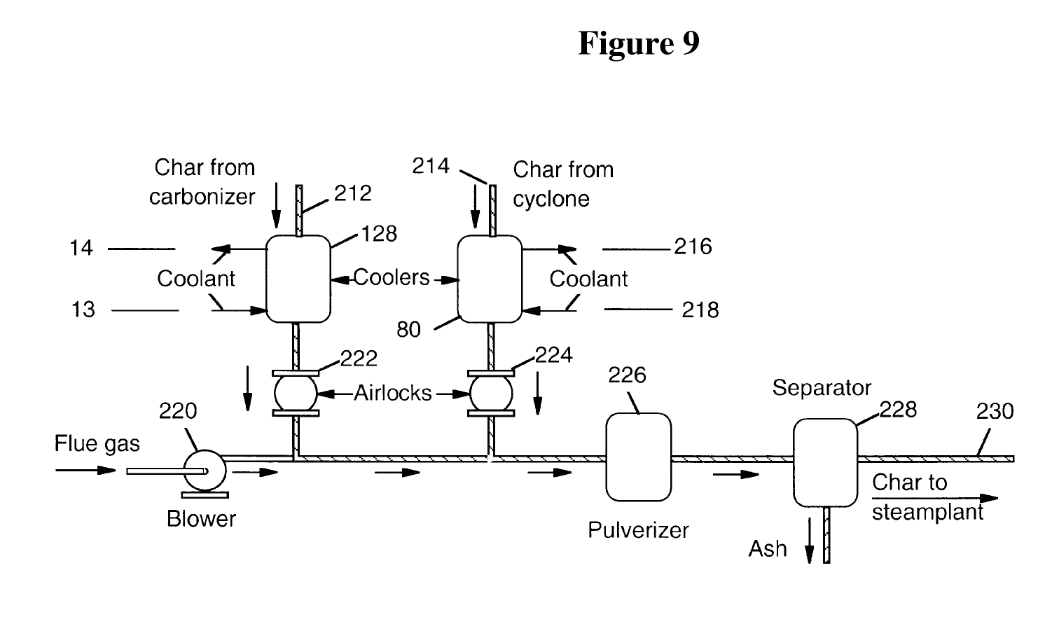

Additional options include the coal preparation system of FIG. 8, and the char preparation system of FIG. 9, which are both described in a later section.

Level of Gasification

In some embodiments, the optimal level of gasification (e.g., in a retrofit) would be a level of gasification that produces about the same flame temperature as the flame temperature of coal. In a typical application, this equates to a level of gasification of about 70%. As used herein, the term “level of gasification” refers to the percentage of energy in the coal that goes to the combined cycle plant. The balance typically goes into char, which may then be burned (e.g., in a boiler/char combustor). The maximum level of gasification that can be gasified in a once-through gasifier typically depends on the reactivity of the coal, as well as the size distribution of the coal feed.

In the retrofit of a PC plant where char is burned in a fludized bed combustor, the level of gasification can be maximized (see, e.g., FIGS. 35A and 35B) in order to maximize the plant efficiency of a retrofitted plant, thereby also minimizing the CO₂ emissions. In principal, the highest efficiency is created when the coal is fully gasified. However, because the gasification of char fines is slow at the temperatures of a carbonizer that uses air instead of oxygen to gasify char (e.g., an airblown carbonizer of some embodiments of the present invention), the size of gasifier would be greatly increased if it had to gasify all of the char fines, which would in turn greatly increase the size and cost of the carbonizer.

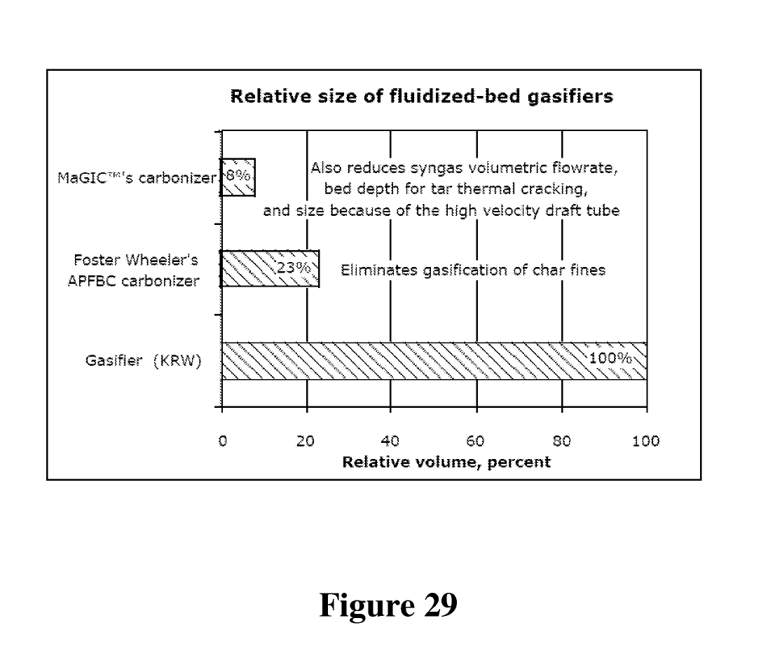

An example of this effect is shown in FIG. 29. Mild gasification provides for the conversion of the char fines in a combustor, where the reaction rates are much higher and the volume of reactor is therefore much smaller. A carbonizer which uses little or no extra volume for the gasification of fines, and also doesn't recycle the fines, is hereby referred to as a once-through carbonizer. Once-through carbonizers can operate at 80 to 90% levels of gasification, with the higher values applying to low-rank coals (See, e.g., Christopher John Mill, Pyrolysis of Fine Coal Particles at High Heating Rate and Pressure, Doctoral thesis, Univ. of New South Wales, September 2000, p 34). Therefore, in the present analyses, an 85% level of gasification is used. Accordingly, in some embodiments, the level of gasification in the mild gasification combined-cycle powerplant is maximized at a 75% level of gasification. In some embodiments, the level of gasification in the mild gasification combined-cycle powerplant is maximized at an 80% level of gasification. In some embodiments, the level of gasification in the mild gasification combined-cycle powerplant is maximized at an 85% level of gasification. In some embodiments, the level of gasification in the mild gasification combined-cycle powerplant is maximized at a 90% level of gasification. In some embodiments, the level of gasification in the mild gasification combined-cycle powerplant is maximized at a 95% or greater level of gasification.

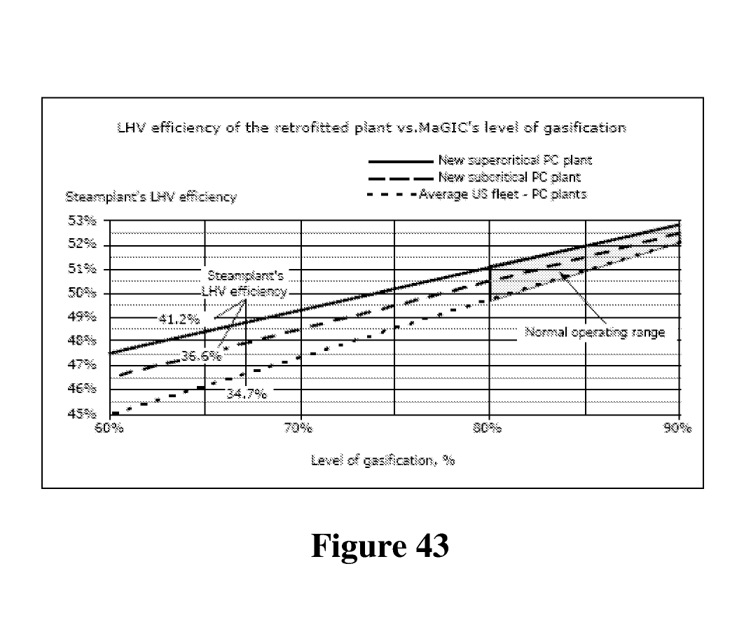

The effect of the level of gasification on plant efficiency is shown on FIG. 43. Although the benefits of a high level of gasification has been generally discussed (see, e.g., Cai et al., Proceedings of the 1 MECH E Part A Journal of Power and Energy, v. 2 No. 4, 1 Aug. 2001, 421-426), such discussions identify the level of gasification that can comfortably be achieved with international coals instead of attempting to optimize the level for each coal. Moreover, plant efficiencies in this reference are plotted to only 70%, even though, as taught by some embodiments of the present invention, higher levels would have resulted in higher efficiencies.

In some embodiments, the level of gasification is selected such that it provides the optimal conditions for meeting certain preferred criteria, such as plant efficiency or cost of electricity, by adding such enhancements that increase the level of gasification such as recirculating char and/or increasing the freeboard volume over the carbonizer's char bed. While other devices may be added to a once-through gasifier, such as an extended freeboard or char recirculating system, to increase the level of gasification by further gasifying char fines, the extent to which these are used, if at all, is determined by a balance between efficiency and economics.

Warm-Gas Cleanup.

In some embodiments, the present invention employs a warm-gas cleanup system (WGCU), which operates above the tar condensation point of volatiles in the syngas. In some embodiments, the gasifier train utilized in the present invention maintains the syngas temperature at 1000° F. or above. Accordingly, in these embodiments, it may be feasible to preserve volatiles rather than destroying them because they do not condense. The benefits of the maintenance of volatiles include the resulting density of syngas in relation to the syngas from conventional airblown gasifiers, which typically also includes carbon monoxide, hydrogen, nitrogen, and steam. In some embodiments, the volatiles are maintained above their condensation temperature in the entire gasification system, until they are burned in the gas turbine. In some embodiments, the syngas produced in accordance with the present invention has a density of about 300 BTU/SCF. Higher density of syngas can equate, for example, to smaller equipment needed to gasify, cool or clean the syngas.

In some embodiments, as described in more detail herein, the IGCC's of the present invention preserve the volatiles in the coal and use them as a fuel in the gas turbine's combustor, rather than burning them and thermally cracking them, e.g., in an airblown gasifier. The heating value of volatiles generated in a pyrolyzer is several times that of the syngas generated by airblown gasifiers. In some embodiments, volatiles generated by the temperature of the IGCC of the present invention (e.g., about 1650° F.) have a heating value of greater than 4000 BTU/SCF, e.g., greater than 4500 BTU/SCF, greater than 5000 BTU/SCF, e.g., about 5390 BTU/SCF (the heating value of naphthalene). This is higher than the 360-460 BTU/SCF reported for steam-blown pyrolyzers. See, e.g., Jose Coretta, et al, A Review on Dual Fluidized-Bed Biomass Gasifiers, Ind. Eng. Chem. Res. 46 (21) Sep. 11 2007. This in turn is higher than the 135 BTI/SCF of the syngas from an airblown gasifier.

Volatiles can be burned directly if they are maintained above the condensation temperature of the tars. This is typically the practice with pyrolyzers used to gasify biomass or coal, when the volatiles are fired in boilers or furnaces (see, e.g., Y. G. Pan, et al, Removal of tar by secondary air in fluidized bed gasification of residual biomass and coal, Fuel, v. 78, issue 14, Nov. 1999, 1703-1709). Volatiles can also be burned directly in gas turbines, once the contaminants have been removed in the syngas cleanup system.

The present inventor has identified the connection between the recently-developed warm-gas cleanup system (see, e.g., J. Schlather, Eastman Chemical Co., Syngas Desulfurization at Elevated Temperatures, 2006 Gasification Technologies Conference, Washington, D.C. October, 2006) and the use of volatiles. The warm-gas cleanup system newly makes it possible to preserve the volatiles released during pyrolysis, and still avoid the deposition of tars in the syngas cleanup system. Accordingly, in some embodiments, the IGCC of the present invention may be operated at temperatures above the condensation temperatures of the vapors in the volatiles as described in more detail above.

In addition to the benefits described above, preservation of the volatiles may also reduce gasification energy. Releasing volatiles occurs naturally when the coal is heated to the bed temperature, without the need for any additional energy. In a conventional (autothermal) gasifier, the air injected into the gasifier preferentially burns the volatiles. This air could have been used instead to partially oxidize char, providing the heat for the water-gas reaction while also gasifying the char. Moreover, additional air itself needs extra energy to bring it to the bed temperature.

Moreover, preservation of the volatiles may also provide syngas of a higher heating value. The higher heating value of the volatiles, compared with the low-BTU gas from conventional airblown gasifiers, can thus further reduce the size and cost of the gasifier train.

In some embodiments, the temperature at which the highest-boiling-point volatiles condense is maintained below that of the warm gas cleanup system. Accordingly, in some embodiments, the warm gas cleanup system is operated at about 1000° F. In some embodiments, the warm gas cleanup system is operated at temperatures up to 1100° F. It has been observed that the molecular weight of the species in the volatiles can increase with gasifier temperature, and the condensation temperatures of these compounds can also rise with both gasifier pressure and molecular weight. Accordingly, in some embodiments, the optimal gasifier operating temperature is about 1600° F., e.g., between about 1600° F. and about 1700° F.

In some embodiments, small amounts of air are added to the draft tube. Without wishing to be bound by any particular theory, it is believed that the addition of small amounts of air to the draft tube further reduces the occurrence of tars.

In some embodiments, the warm-gas cleanup system has a halide filter 682 positioned downstream of the candle filter 602, instead of ahead of the desulfurizer 684. An exemplary schematic of such an embodiment is shown, for example, in FIG. 33. It has been discovered that the char fines may plug the fixed bed reactor used to remove halides. While it would be possible to remove halides by injecting sorbent fines into the syngas ahead of the filter 682, this may also be unacceptable because the mineral used to scrub halides would become sticky when exposed to the temperature of the FBC. In some embodiments, a filter downstream of the halide scrubber is used to remove any particles that might flake off the sorbent. It is expected that a cyclone will suffice for this purpose, so the additional cost of a second candle filter can be avoided.

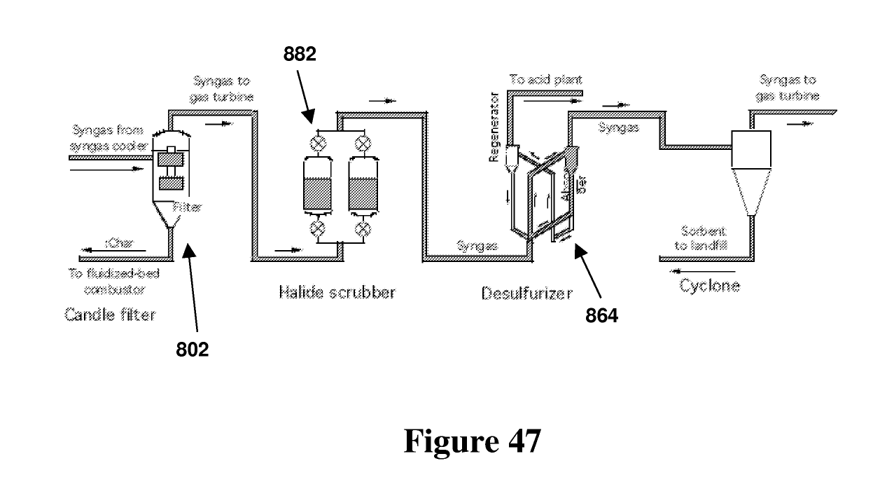

An alternative to the warm-gas cleanup system of FIG. 33 is shown in FIG. 47. As shown in FIG. 47, the candle filter 802 may be placed upstream of the desulfurizer 864, and the halide scrubber 882 may also be placed upstream of the desulfurizer 864. The filter 802 may, however, be subject to corrosion by both sulfur and halides, which may limit its durability (although some alloys exist that are corrosion-free even at the sulfur concentrations expected). The configuration shown in FIG. 47 protects the desulfurizer 864 from halide attack.

Exemplary Configurations of the Present Invention

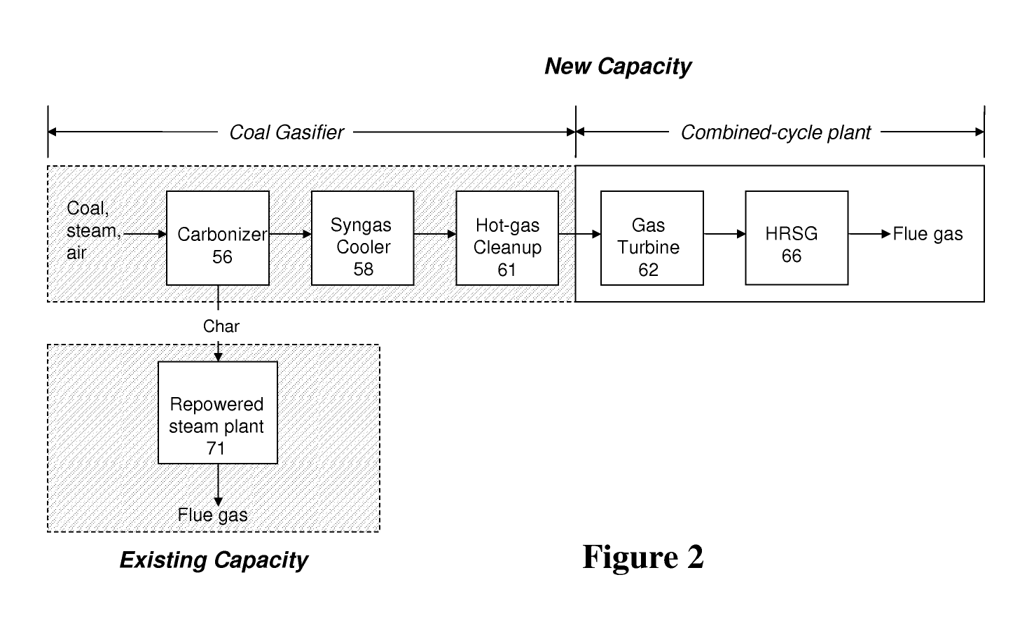

Mark 1. (See, e.g., FIG. 2). Mark 1 is the exemplary embodiment that can be used in new installations. Mark 1 is hybrid with its own heat recovery steam generator (HRSG) 66. While Mark 1 can be used in greenfield applications, it may also located near an existing PC plant site. Proximity can increase the convenience of transferring the char from the carbonizer 56 to the steamplant 71, and allows for the sharing of other balance-of-plant equipment. In some embodiments, the cost of electricity for Mark 1 is the lowest of any configurations of the present invention, but it may also have higher CO₂ emissions and use more water than other configurations.

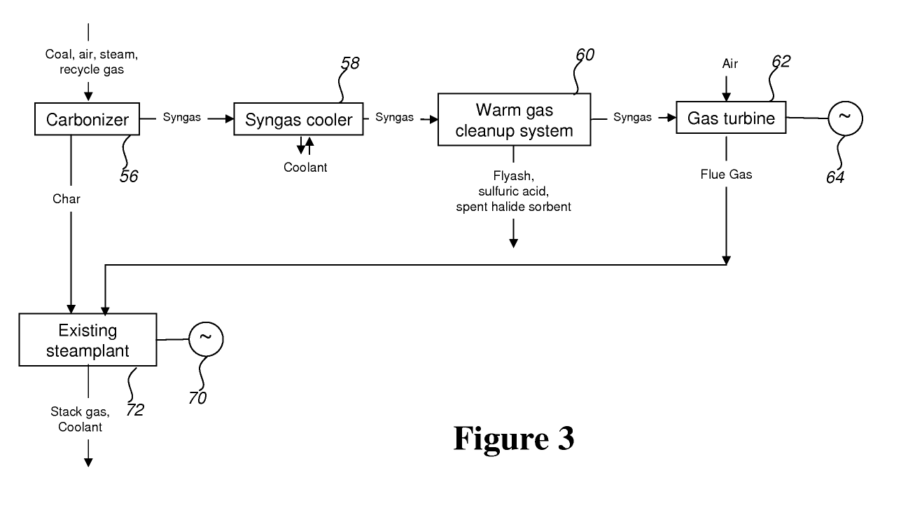

Mark 2. (See, e.g., FIG. 3). In certain embodiments of its application, the present invention is used to retrofit existing PC plants. Both the flue gas from the gas turbine 62 and the char from carbonizer 56 may be ducted to the existing steamplant 72, which serves as the HRSG. The capacity of the some embodiments of the invention's plant, and its char flowrate to the boiler, can both be designed to match the flows and temperatures of the existing steam plant before the retrofit.

In some embodiments, such a design utilizes a gasification level of about 70%. The gasification level is defined as the percentage of energy in coal to the carbonizer 56 that is used to produce syngas. The remaining energy in the coal may be in the char sent to the retrofitted steamplant. In some embodiments, the generating capacity of the retrofitted plant is about 260% of the capacity of the existing steamplant.

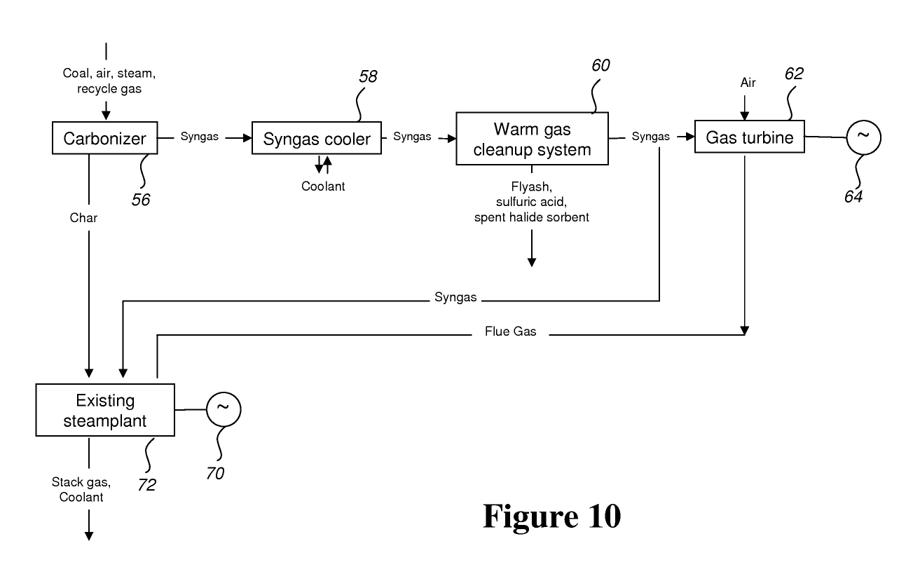

Mark 3. (See, e.g., FIG. 10). In some embodiments, e.g., in Mark 3, both syngas and char are burned in the retrofitted steamplant. In some embodiments, such a design utilizes an increased level of gasification, to as high as 80-90%, depending on the coal rank. The higher the level of gasification, the lower the excess-char flows from the carbonizer 56, until, at the maximum level of gasification, this flow becomes zero. The benefits of higher levels of gasification include a reduction in the concentration of ash in the boilerplant; a reduction in the unburned carbon loss from the retrofitted boiler, because there is less char being burned and because the syngas increases the combustion efficiency; replacement of auxiliary fuel with syngas for flame stabilization at low loads; and minimization of the amount of carbon dioxide that must be removed by post-combustion scrubbers in CCS application. The only downside of higher levels of gasification is that both the capacity and cost of the coal gasifier train may be increased.

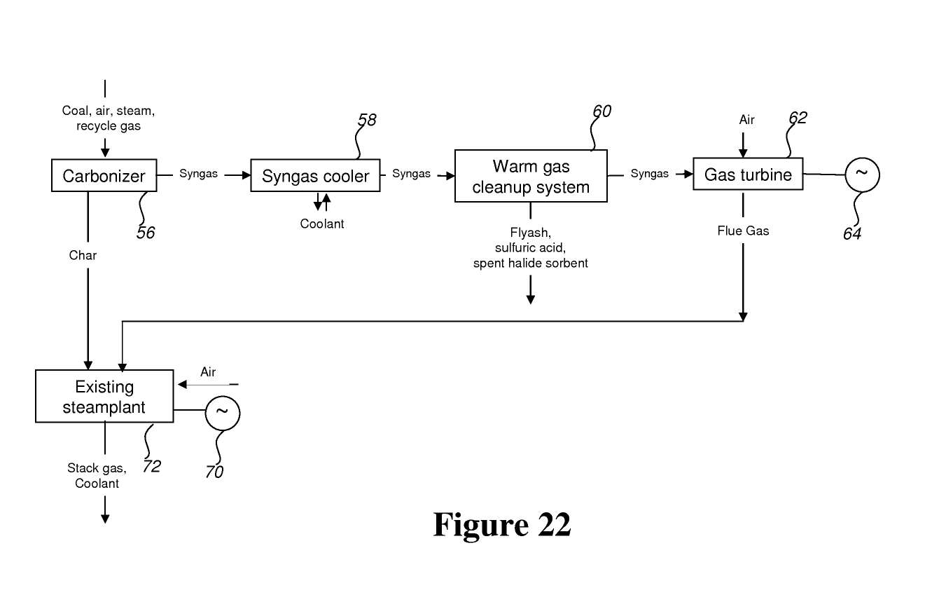

Mark 4. (See, e.g., FIG. 22). In some embodiments, e.g., in Mark 4, air is added to existing boiler 72 to supplement the air in the flue gas from the gas turbine 62 for burning the char. In some embodiments, such a design utilizes low levels of gasification, which are employed when the added generating capacity of some embodiments of the invention is lower than the rated plant output, which is the plant output provided by Mark 2.

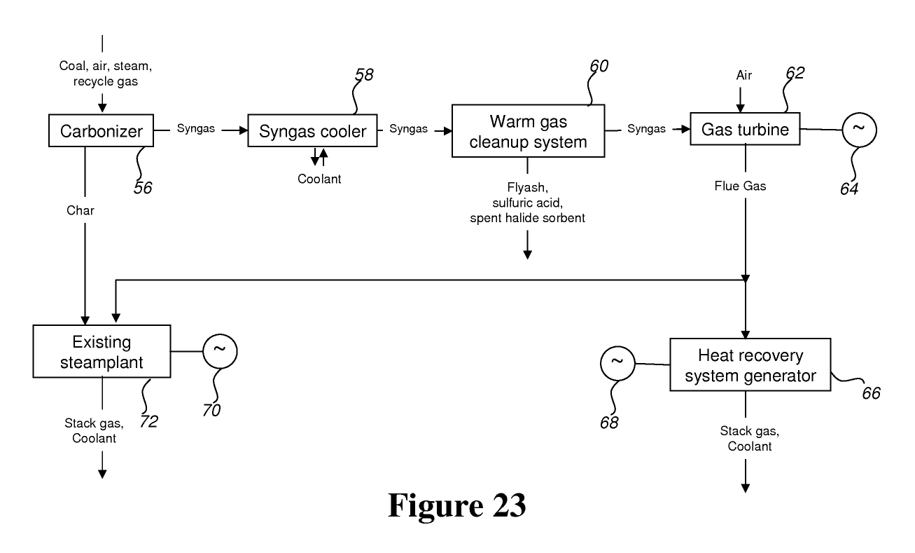

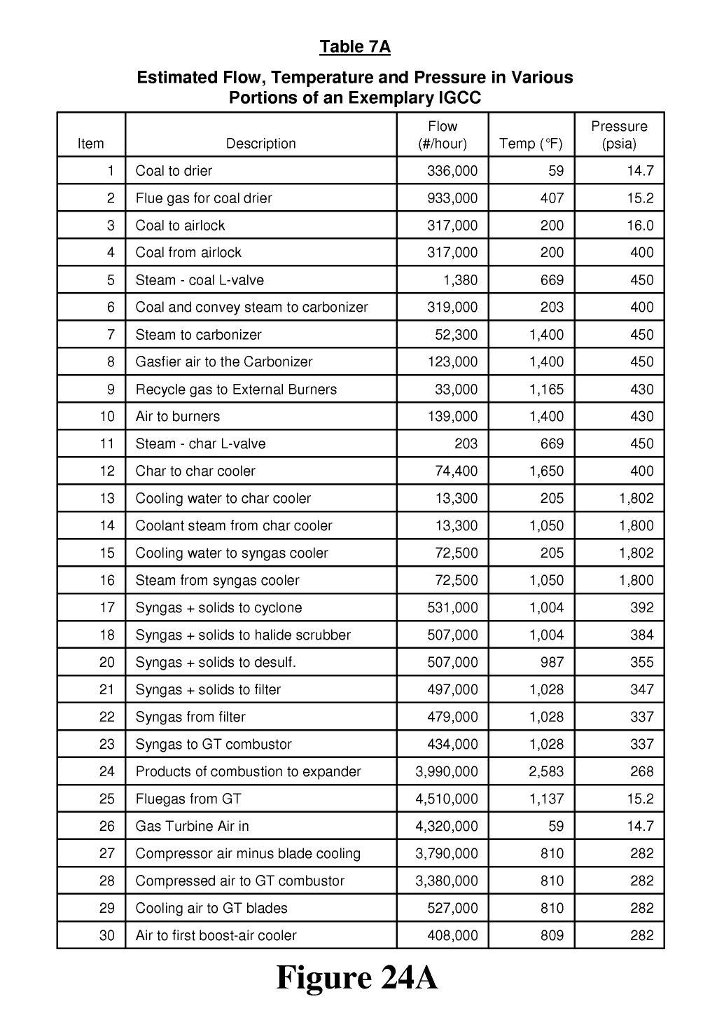

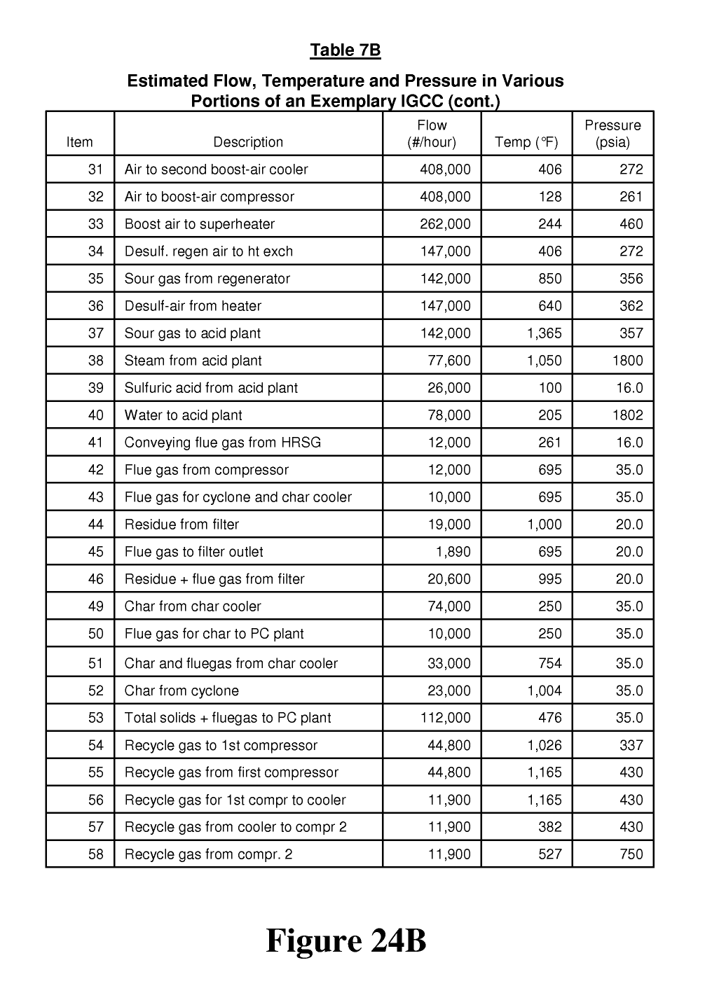

Mark 5. (See, e.g., FIG. 23). In some embodiments, e.g., in Mark 5, a HRSG 66 is added to the system, to supplement the heat recovery of the retrofitted steam plant 72. Embodiments such as Mark 5 may be used, for example, when the additional power required by the powerplant of the invention is greater than that of Mark 2.

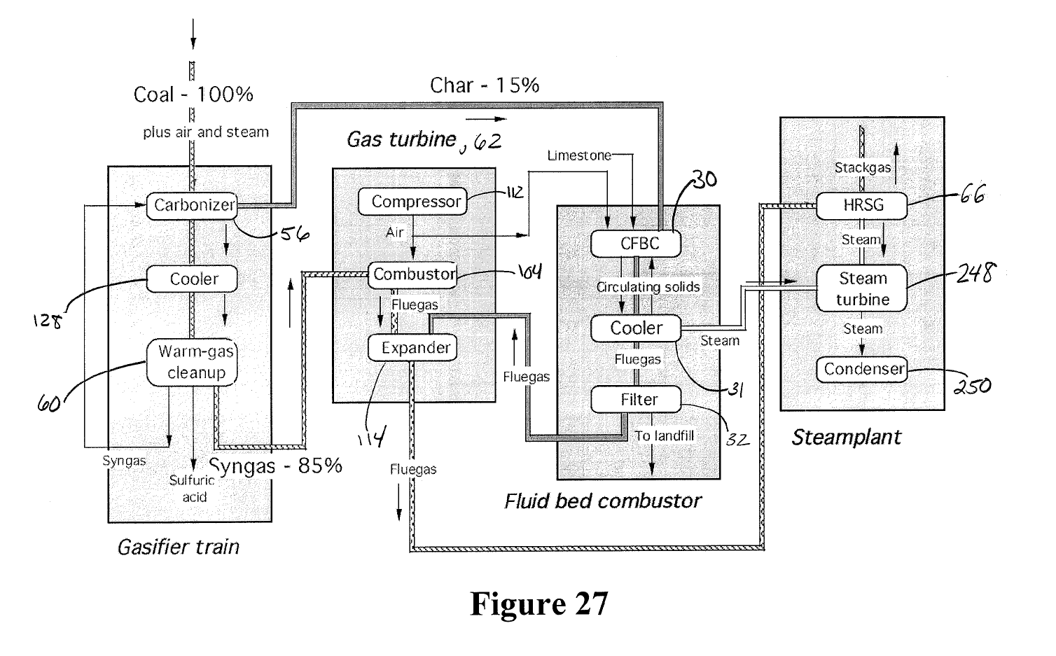

Additional embodiments. Embodiments of an alternative process flow diagram are shown in FIG. 27. As is seen, in some embodiments, the char is burned in a pressurized fluidized-bed combustor (FBC) 30 instead of the existing steamplant in some aspects of the present invention. The airflow for the FBC 30 comes from the gas turbine's compressor. The flue gases from the FBC are cooled, filtered, and re-injected into the syngas ahead of the gas turbine's combustor 104. The flue gas cooler 31 brings its temperature to a level suitable for treatment by a metallic candle filter 32.

Upgrading for Carbon Capture and Storage (CCS).

In some embodiments, the hybrid IGCC plants of the invention are carbon-ready, which means that they can be modified to provide CCS. The goal of the upgrades is to reduce the CO₂ emissions of the retrofitted steamplants. In some embodiments, the CO₂ emissions of the retrofitted steamplants are reduced by over 50%, e.g., over 60%, 70%, 80%, or 90%. In certain embodiments, the CO2 emissions of the retrofitted steamplants are reduced by over 90%. The reduction may be from both the efficiency gains provided by the some embodiments of the invention and from its CCS.

In some embodiments, the pre-combustion carbon capture systems of hybrid IGCC plants remove the CO₂ more cheaply than stack-gas systems. This may, for example, be due to high pressure and concentration in the scrubber. In the some embodiments, the hybrid IGCC plants of the present invention uses pre-combustion carbon capture for removing 70 to 90% of the CO₂. The balance is removed by a stack-gas scrubbers at the existing steamplant.

There are a number of configuration options, and some criteria used for selecting among them include, but are not limited to, minimizing the equipment changes required during upgrading, minimizing the preliminary investment needed to be carbon-ready, retaining the original benefits of the non-CCS version of the technology, and reducing the methane in the syngas to a level consistent with the required level of CO₂ reduction.

FIG. 12 is a schematic representation of an exemplary hybrid IGCC plant configuration which includes CCS. The upgraded powerplant may use mature technology (shift reactors 246 and absorption systems 248) for first converting the syngas to a mixture of hydrogen, carbon dioxide and nitrogen. The absorbers 248 may then separate the CO₂ from the hydrogen/nitrogen mixture. The hydrogen/nitrogen mixture may be used as fuel for the gas turbine 62, while the CO₂ is dried, pressurized, and sequestered, such as in geological storage. If pure hydrogen is required, a second separator can be used to remove the nitrogen.

During an upgrade, the only additional equipment, beyond that needed for any CCS system, may be a partial oxidizer 242 and its syngas cooler 244. The partial oxidizer acts as a pressurized furnace, while the syngas cooler is a pressurized heat exchanger.

In some embodiments, the partial oxidizer 242 converts the tars into a mixture of char and gases, and a portion of the methane into carbon monoxide and water vapor. Its operating temperature may be controlled by the incoming airflow. The temperature can be chosen based upon what is required to reduce both the tars and the methane to acceptable levels. The syngas cooler 244 downstream of the partial oxidizer 242 may return the syngas to the temperature required by the shift reactor. Since this heat can be recycled into the gas turbine's discharge air, partial combustion should have only a minor effect on plant efficiency.

Carbon capture of the syngas typically requires the conversion of the hydrocarbon vapors in the volatiles into CO and hydrogen before the syngas can be shift-reacted into hydrogen and CO₂. One way to do this is to use a partial-oxidizing reactor 242 that is located downstream of the warm-gas cleanup system 60, as described in detail above. In other embodiments, hydrocarbon vapors in the volatiles are converted into CO and hydrogen by providing partial oxidation in the draft tube. This may be accomplished, e.g., by adding just enough excess air to the external burners to eliminate the hydrocarbon vapors. In some embodiments, partial oxidation in the draft tube eliminates the need for the partial-oxidation reactor 242 and its heat exchanger 244.

The nitrogen mixed in with the hydrogen in the syngas can increase the size and cost of the shift reactor 242 and absorption units 248 as compared with an oxygen-blown carbonizer. Accordingly, in some embodiments, the carbonizer 56 utilized in the present invention is operated with oxygen to avoid complications caused by the nitrogen. On the other hand, the nitrogen in the syngas increases the power throughput of the gas turbine 62, thereby reducing the need for steam to fill the expander, while also reducing NOx emissions. Accordingly, in some embodiments, oxygen-blown IGCCs of the present invention re-inject the nitrogen back into the gas turbine 62. The use of air may also eliminate the cost and efficiency penalties of the oxygen plant.

An alternative configuration provides for the injection of air alone through the carbonizer external burners, instead of the products of combustion from burned recycle-gas. This would already burn off some of the volatiles, reducing the air and heat required in the partial oxidizer. To offset this, the throughflow capacity of the warm-gas cleanup system may be enlarged.

FIG. 12 also depicts a train of scrubbers 254 downstream of the existing steam plant 72, which may be utilized in some embodiments of the present invention. Although they are not necessary for the invention to reduce CO₂ emissions, their presence may further reduce emissions (as in existing plants).

In some embodiments, capturing the carbon dioxide from the fluidized-bed combustor is accomplished with a conventional atmospheric-pressure stack-gas scrubber. However, this may require a second gas turbine and HRSG that serves only the fluidized-bed flue gas (otherwise the entire flue gas would have to be decarbonated, at great cost). Adding a second gas turbine and HRSG adds to the system's complexity and cost. In other embodiments, the char fines are fully gasified. However, this can be even costlier than adding a second gas turbine and HRSG. Disposing of the char fines in a land fill may also not be an acceptable option, because the tars on the surfaces of particles are likely to render it hazardous waste.

Accordingly, in other embodiments, CO₂ is removed from the PFBC's flue gas with an absorber. Without wishing to be bound by any particular theory, it is believed that this not only eliminates the need for the extra gas turbine and HRSG, but also greatly reduces the size and cost of the CO₂ absorber, as compared to an atmospheric-pressure system. It is also believed that the process also reduces the CO₂ compression power requirements several fold, as compared to an atmospheric-pressure CO₂ scrubber.

In some embodiments, the methane produced by the draft tube assembly of the present invention (e.g., assembly which keeps volatiles separate from the remainder of the syngas) results in lower methane concentrations than in a conventional gasifier. Methane produced in a pyrolyzer was only 2.2%, only a half to a third that predicted for a conventional airblown gasifier (see, e.g., Neville Holt, EPRI, Gasification Process Selection—Trade-offs and Ironies, Gasifiscation Technologies Conference 2004, Washington, DC) A lower methane concentration means a greater CO₂ removal efficiency. In some embodiments, CO₂ removal efficiency of the IGCCs of the present invention are greater than about 90%.

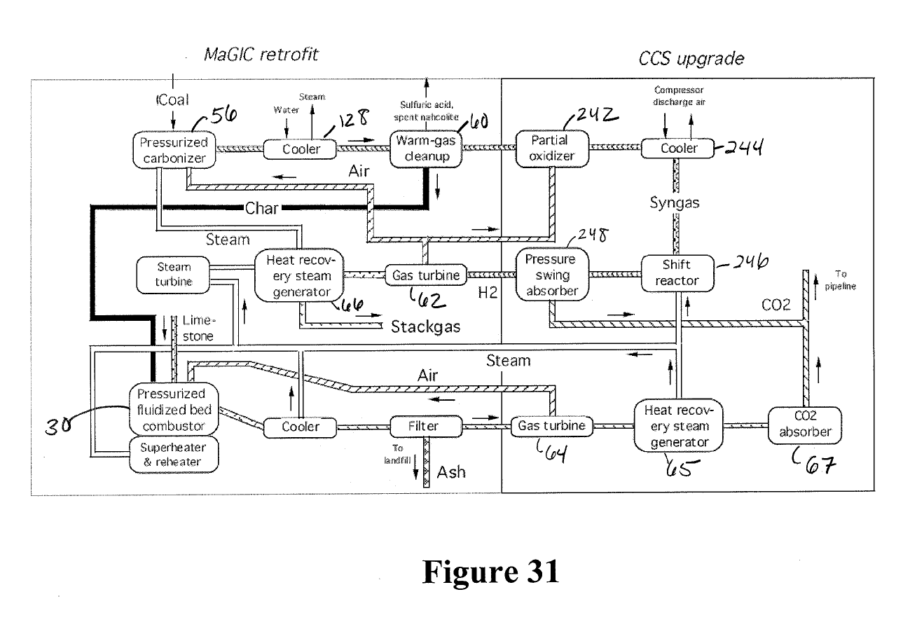

FIG. 31 is a schematic representation of another exemplary hybrid IGCC plant configuration which includes CCS. As in FIG. 12, a partial gasifier 242, cooler 244, and shift reactor 246 are used to convert the syngas into hydrogen and CO₂.

While it would be possible to gasify the char fines and include them in the syngas, this creates the need for large and costly equipment. Instead, the existing FBC 30 is used, in some embodiments, to burn the char fines, and the CO₂ from the FBC's flue gas is removed by a post-combustion scrubber 67. While post-combustion scrubbers cost more than pre-combustion systems, the relatively low flow of the FBC stream is expected to make the some such embodiments the most cost-effective configuration.

As seen in FIG. 31, a separate gas turbine 64 and HRSG 65 are used for the FBC exhaust. This is to avoid the contamination of the flue gases from the gasifier's gas turbine with CO₂. Such contamination would mean that the entire gas stream from the combined cycle plant would have to be treated by a post-combustion scrubber, which would increase its cost many times over.

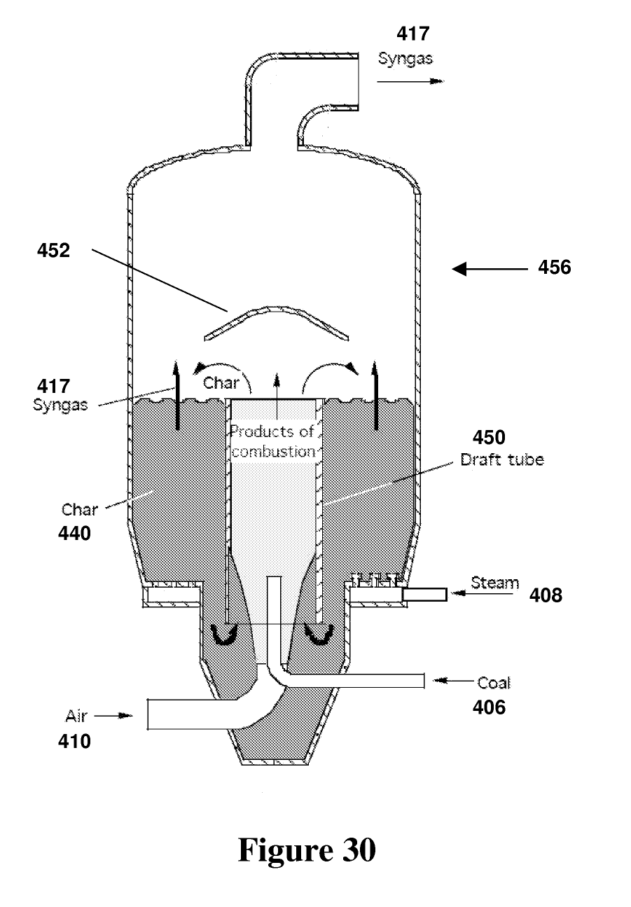

In an alternative embodiment, the external combustors are removed from the carbonizer 456 and air is injected into the draft tube 450 to provide heat by burning volatiles, as shown in FIG. 30. In still other embodiments, only steam is added to the bottom of the char bed 440, as the heat for char gasification also comes from the combustion of volatiles, which is then transmitted to the circulating char.

Airblown Pyrolyzer with Draft Tube

In some embodiments, the IGCC of the present application includes an airblown pyrolyzer with a draft tube 450, see, e.g., FIG. 30. As seen in FIG. 30, the air 410 fed to the draft tube 450 burns the volatiles as they are released from the incoming coal by the hot recirculating char 440. In some embodiments, the airflow to the draft tube 450 is limited what is needed to heat the incoming flows and provide the heat for the water gas reaction in the char bed. In some embodiments, no steam is injected into the draft tube 450, as this would form methane, which would reduce the level of carbon capture that could be achieved.

A carbonizer similar to the carbonizer of FIG. 30 was tested in the Westinghouse Waltz Mills Laboratory pressurized-coal gasifier pilot plant in the 1970's. The Waltz Mills system differs from the carbonizer of FIG. 30 insofar as the gasification of the char is performed in a second reactor. Only enough airflow was added to the bottom of the first reactor's char bed to keep the char fluidized, and no steam was added to the bottom of the first reactor's char bed.

The objective of the two systems also differs. In the Waltz Mills system, the pyrolysis unit was used to gasify highly caking coals, which had not previously been gasified in a fluidized-bed gasifier. When it was discovered that these coals could be gasified in a single vessel, the two units were combined into a single unit, and both the draft tube and the pyrolysis functions were eliminated.

In the Waltz Mill system, only enough air was added to the draft tube to provide the necessary amount of heat to keep the carbonizer's bed temperature at the desired temperature. The system included a water-cooled cyclone that recycled char to the pyrolyzer. The cyclone extracted considerable amount of heat, so a significant amount of air was needed to maintain the bed temperature.

A key finding was that there were no tars in the syngas leaving the gasifier. Accordingly, it appeared that the system successfully eliminated the hydrocarbon vapors that would interfere with the water shift reaction. This means the configuration provides an alternative to the higher-temperature partial oxidation of FIG. 30. This eliminates both the partial combustor and its heat exchanger. On the other hand, in some embodiments, the size of gasifier train will need to be increased because the heating value of the syngas produced by the modified system is lower than that of the original invention. Moreover, it appeared that warm-gas cleanup was no longer needed. Instead, either the volatiles or all of the syngas from the carbonizer may be cleaned in a conventional system. Although the efficiency is reduced by this, which adds to the system's cost, the approach retains the other benefits of embodiments of the invention.

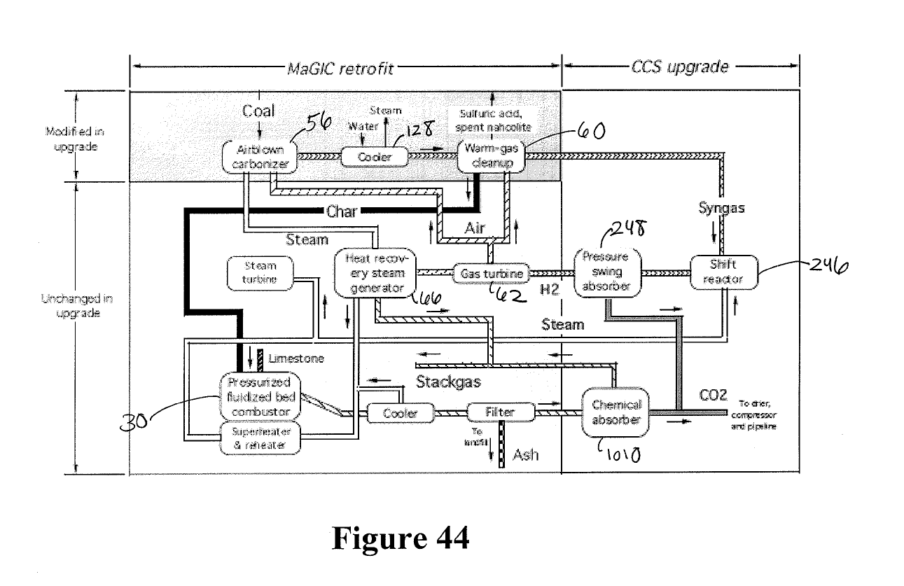

In some embodiments, the system to remove CO₂ from the char utilizes a pressurized fluidized-bed combustor 30 with a pressurized CO₂ absorber 1010 (See, e.g., FIG. 44). The absorber can be a conventional stack-gas scrubber, such as an amine system, except that it is under pressure. The pressurization reduces the size and cost of the system by an order of magnitude, and minimizes the energy needed to compress the CO₂ for sequestration. The pressurization also increases the plant efficiency by injecting some of the heat released in the FBC into the combined-cycle part of the system. The system can also eliminate the cost and complexity of a separate gas turbine and HRSG for the char combustion stream, or the need to completely gasify the char, as in previous embodiments.

In some embodiments, the airblown pyrolyzer of the present invention does not include external burners. If the external burners are eliminated, the source of heat for the gasifier can be, for example, the partial combustion of the volatiles. Just enough of the volitiles is added to heat the incoming flows to the gasifier temperature, and provide the heat for the water-gas reaction in the char bed.

Ash Concentration in the Steamplant.

The ash concentration in the char fed to the retrofitted steam plant is typically 40% greater than the coal it replaces. With low-ash coals, such as Australian lignites that contain only 1% ash, the effect on operation is negligible. At the other extreme, with high-ash coals, such as some in India and China, the higher ash in the char may make it incombustible in a pulverized coal boiler. Even at moderate levels of ash, increasing the ash concentration will require the enlargement of both the ash disposal system and the stack-gas particulate collector.

Simple solutions, if available, include washing the coal, blending it with a coal having a lower ash content, or using a lower-ash coal. Accordingly, in some embodiments, coal employed in the present invention is washed or blended with a coal having a lower ash content. In other embodiments, a low-ash coal is utilized in the present invention. Another partial solution is the coal jig 184, or separator, in the coal preparation system (FIG. 8) and the separator 228 in the char preparation system (FIG. 9), both described below.

In some embodiments, additional separation of the ash from char can be provided by the classifier 252 upstream of pulverizer 226, or, preferably, by separator 228 downstream of the pulverizer. A complete solution is to use Mark 3 (FIG. 10), to increase the level of gasification, and transmit enough syngas to return the fuel passing through the PC plant to the original ash concentration.

In all likelihood, the least-costly solution will be a combination of more than one of these methods.

Coal Preparation System

In some embodiments, the hybrid IGCC of the present invention includes a coal preparation system. See, e.g., FIG. 8. The coal preparation system depicted in FIG. 8 uses a process being developed by the Western Research Institute (WRI) called precombustion thermal treatment of coal (PCTTC). The benefits of PCTTC include the removal 50-80% of the mercury in coal in its first stage, depending on the type of coal, and perhaps half of the remainder, in the coal jig 184 downstream of the heater 204. Mercury removal was the original purpose of the PCTTC system. The benefits of PCTTC can also include the reduction of the amount of ash going to the boilerplant and the reduction of the heating requirements of the carbonizer external burners, which in turn provides a reduction in the syngas volumetric flowrate, equipment costs, and an increase in plant efficiency. PCTTCs may also provide a convenient system for burning the unburned carbon in the fly ash in the effluent from both the high-temperature filter 102 and the existing boilerplant's ESP 260 as well as a convenient source of superheat for the low-temperature steam generated at the acid plant 100.

In operation, the PCTTC system dries the coal at temperatures between 250° and 300° F. in an atmospheric drier 210, then heats it to 550° F. in fluidized-bed heater 196 to release the mercury from the organic part of coal. Circulating “sweep” air leaving the coal heater may pass through a second bed 188, where a high-temperature sorbent removes the mercury, and is then recycled to the heater.

The principal fuel for the fluidized bed combustor may be the carbon in the fly ash collected from both the gasifier train filter 102 of the IGCC plant and the boilerplant's electrostatic precipitator 260. In some embodiments, coal is used to supplement this principle fuel. Accordingly, the fluidized bed combustor may increase the plant's carbon utilization, while rendering the fly ash into a saleable low-carbon supplement for cement manufacture.

Char Preparation Plant

In some embodiments, the hybrid IGCC of the present invention includes a char preparation system. See, e.g., FIG. 9. In some embodiments, the final stage of ash removal is the separator 228 downstream of the pulverizer 226 at the retrofitted steamplant. Either a magnetic separator 228 or an electrostatic separator 228 or both may be used to remove ash. Without wishing to be bound by any particular theory, it is believed that, for high-ash coals with finely-imbedded ash, the collection efficiency is highest here, insofar as the coal is more finely divided than anywhere else in the system.

In some embodiments, the electromagnetic separator 228 works on the paramagnetic mineral pyrrhotite (FeSx), which has been transformed from the non-magnetic pyrites in coal by the heat of the carbonizer. In some embodiments, because much of the remaining mercury is contained in the pyrites, there is a possibility that this, too, can be removed at the separator.

The pulverizer 226 in the char preparation plant may be used to maximize the carbon utilization in the boiler by minimizing the particle size. Char formed under pressure, which occurs in hybrid IGCCs, is sometimes less reactive than the char formed in a pulverized coal plant, resulting in lower carbon utilization in the retrofitted boilerplant. On the other hand, if the char is formed in an inert (i.e., non-oxidizing) atmosphere, even under pressure its reactivity is about the same as that of a PC boiler. In some embodiments, the region where pyrolysis occurs (e.g., the draft tube 150) is kept air-free and thus pyrolysis occurs in an inert atmosphere.

Char is more friable than coal, so the particles emerging from the pulverizer 226 will be smaller. Accordingly, in some embodiments, the use of a char preparation plant will enhance carbon burnout. The carbon remaining in the fly ash leaving the boilerplant may be burned in the lower bed of the fluidized-bed combustor 174 contained in the coal-preparation plant.

In-Bed Desulfurizer

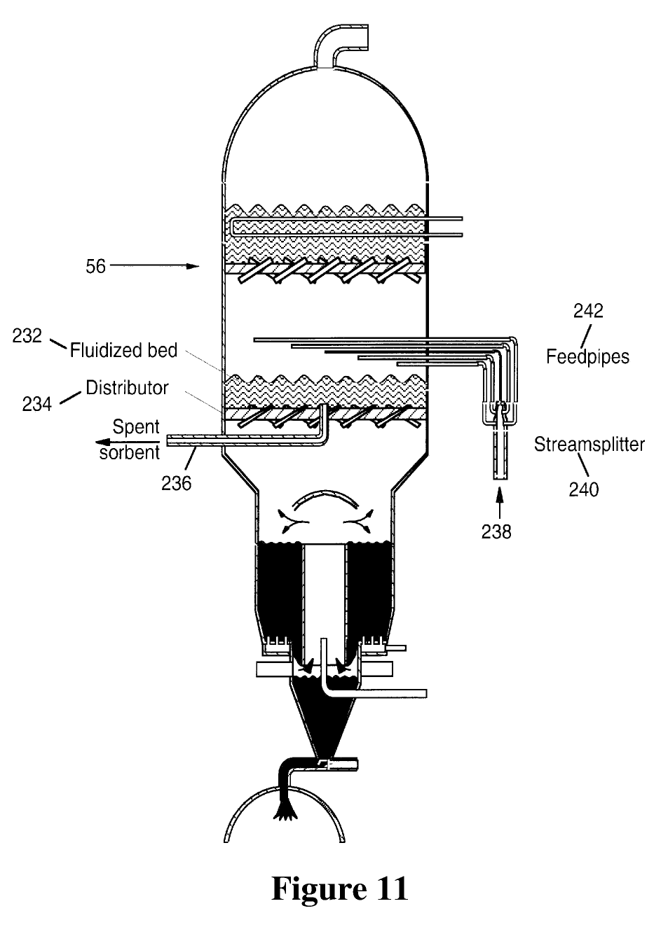

In some embodiments, the hybrid IGCC of the present invention includes an in-bed desulfurizer. See, e.g., FIG. 11. An alternative method of desulfurizing may be the use of a fluidized-bed 232 of calcium carbonate mineral such as limestone or dolomite. In such method, the calcium carbonate may be calcined by the bed temperature into calcium oxide and carbon dioxide.

Because a fluidized bed 232 may not be as efficient as the transport desulfurizer, a transport desulfurizer may be used as well. However, use of the fluidized bed 232 reduces the desulfurizing airflow 35 substantially. This in turn reduces the steam required to fill the expander, and overall, the plant efficiency rises by 1-2%. The spent sorbent is processed by a sulfator, in which the sorbent (as CaS) is converted to calcium sulfate in an oxidizing atmosphere. The sorbent leaving the sulfator is suitable for landfill, and may also be used as an ingredient in concrete.

For example, in some embodiments, injecting calcite (limestone or dolomite) into the gasifier is used to reduce the sulfur compounds from the syngas, although a transport desulfurizer remains useful as a polishing scrubber. The limestone is then converted into CaS (calcium sulfide) in the gasifier, which is in turn converted into CaSO₄ (calcium sulfate) in the fluidized-bed combustor, where it may be sold to gypsum wallboard manufacturers. Without wishing to be bound by any particular theory, it is believed that the efficiency is somewhat improved by using limestone, as it reduces the airflow drained from the gas turbine's compressor (See, e.g., Process Engineering Division, NETL/DOE, KRW Gasoifoer OGCC Base Cases PED-OGCC-98=005. Cases 1 and 3).

In some embodiments, the calcite is placed in an upper fluidized bed. For example, in some embodiments, a continuous flow of sorbent is fed to the upper bed by a spreader, and spent material is removed at a drain. It is believed that placing calcite in an upper fluidized bed may improve the sulfur removal efficiency while reducing the amount of sorbent required. In some embodiments, the calcite is injected directly into the char, however if the calcite is injected directly into the char, the short residence time and dilute concentration of the volatiles in the draft tube lessens the contact with the calcite and thus lessens the reaction between the sulfur compounds and the sorbent.

Spray Cooler

An alternative to the fluidized-bed syngas cooler 138 is a spray cooler, whereby the syngas is cooled in a chamber into which water is sprayed. Depending on the water requirements of the gas turbine 62, this may reduce the plant efficiency.

Decommissioned Boiler

In some embodiments, the existing boiler in the steamplant is decommissioned, and a new heat recovery steam generator (HRSG) is installed to recover the heat from the gas turbine. In certain embodiments of the invention, the existing boiler and its scrubbers are decommissioned, while the remainder of the existing steamplant remains in use. In some embodiments, the heat in the gas turbine's exhaust is recovered by an HRSG.

Without wishing to be bound by any particular theory, it is believed that, while it would be technically possible to use the heat transfer sections of the existing boiler, the extent of the modifications required make this unfeasible. Instead, in certain embodiments, a new HRSG is provided to recover the heat from the gas turbine's exhaust. Other benefits of decommissioning the boiler may include, for example, thermal efficiency, plant life extension, lower emissions (pulverized coal plant emit as much as an order of magnitude more polluting emissions than coal gasification plants) and ease of retrofit. That is, in some embodiments, the HRSG is compatible with and/or designed for higher temperatures and pressures than the previous plant, thus increasing the plant's efficiency, as these conditions are no longer limited by the efficiency of the previous steamplant. Additionally, in some embodiments, decommissioning the boiler greatly lengthens the useful life of the plant, e.g., because steamplants typically become uneconomic to run when their boilers become too old to repair. Without wishing to be bound by any particular theory, it is believed that lengthening the useful life of the plant would not only improve the economic viability of a retrofit, it would also make CCS (whose application to older steamplants is often limited by their short remaining life) more feasible. Additionally, in some embodiments, eliminating the need to modify the boiler minimizes the time and cost of tying-in the new retrofit plant. In further embodiments, the existing boiler and its attendant scrubbers can be scrapped, providing necessary space for elements of the new system.

Aeroderivative Engine

Recently, General Electric developed an aeroderivative gas turbine for utility-scale operations (LMS100 gas turbine, GE Power Systems). This engine uses a high pressure ratio gas turbine (i.e., a substantially greater compression ratio) in addition to intercooling, to increase the gas turbine's efficiency. Rated at 100 MWe, the simple cycle HHV efficiency is 46% vs. 36% for its other utility-scale gas turbines. See, e.g., http://ge-energy.com/prod_serv/products/aero_turbines/en/downloads/lms100_brochure.pdf. The gas turbine's low outlet temperature, however, makes it relatively unsuitable for combined cycle heat recovery. For example, despite the gas turbine's high efficiency, the efficiency of a natural-gas-fired combined cycle (NGCC) using this equipment is only slightly higher (efficiency of about 54%) because of the relatively low gas turbine exhaust temperatures associated with a high pressure-ratio cycle gas turbine.

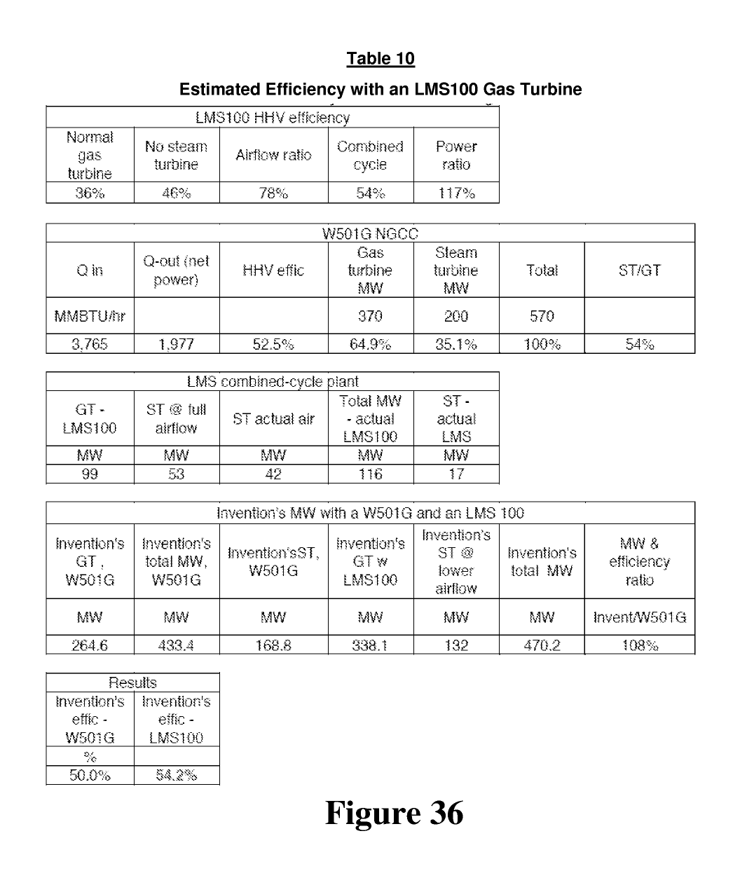

In some embodiments, the IGCC of the present invention utilizes an aeroderivative gas turbine. For example, in some embodiments, the IGCC of the present invention uses mild gasification to overcome the problem of low gas turbine exhaust temperature. Although the temperature of the steam generated by an HRSG attached to such a gas turbine is too low to be efficient in conventional systems, the IGCC of some embodiments of the present invention allows the steam to be superheated (and/or reheated) in the PFBC to overcome this deficiency. In some embodiments, using an aeroderivative gas turbine results in an increase of the plant's HHV efficiency by 2-6%, e.g., about 4%, in comparison to a conventional turbine (e.g., non-aeroderivative turbine or “G” series turbine). For example, using an aeroderivative gas turbine can result in an increase of the plant's HHV efficiency from 50% with a “G”-series gas turbine, to 54% (See, e.g., FIGS. 35A and 35B). This is the highest efficiency of any IGCC using currently-available gas turbines (See, e.g., FIG. 36). This higher efficiency is contrary to conventional belief that the use of an aeroderivative engine would result in lower plant efficiencies than a conventional gas turbine because of its low outlet temperature.

In some embodiments, the products of combustion in the gas turbine of the IGCC are reheated. It has been recognized that reheating the products of combustion in the gas turbine of the IGCC may also be used to improve the efficiency of an IGCC powerplant. In some embodiments, reheating the products of combustion are combined with the use of an aeroderivative gas turbine described above. To date, a gas turbine that does both of these functions has not been described (See, e.g., R. Giglio, Partial Gasiification Combined cycle Technology, DOE Combustion Workshop, January 2001).

Plant Sizing and Steamplant Derating.

In some embodiments, the IGCC of the present invention is sized such that the ratio of power generated by the gas turbine to power generated by the steam turbine is substantially the same as the original steamplant.

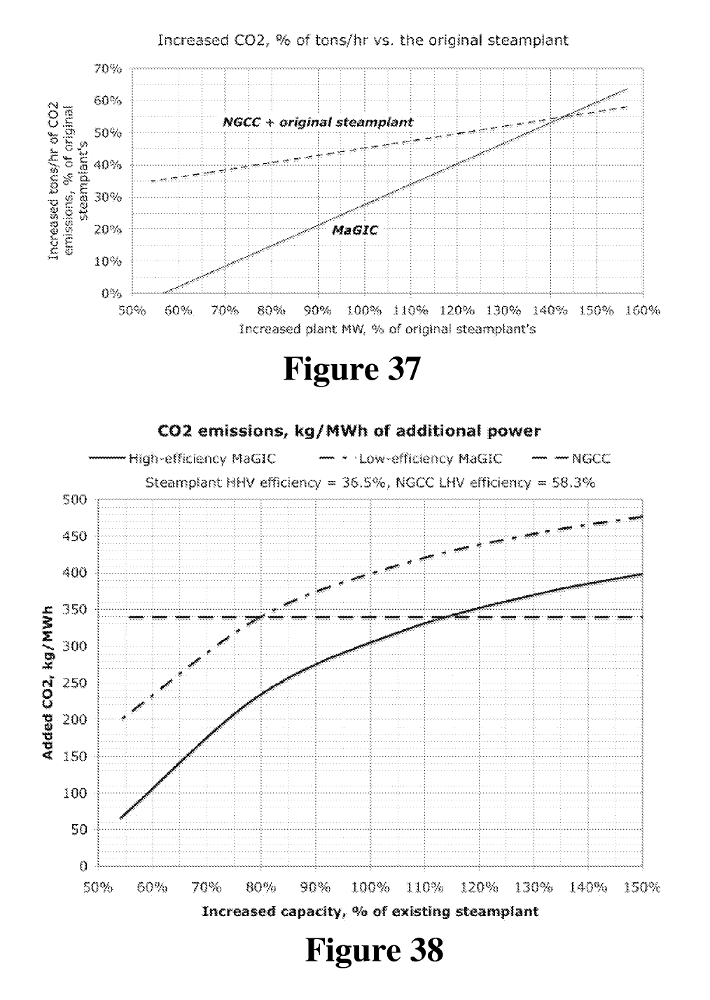

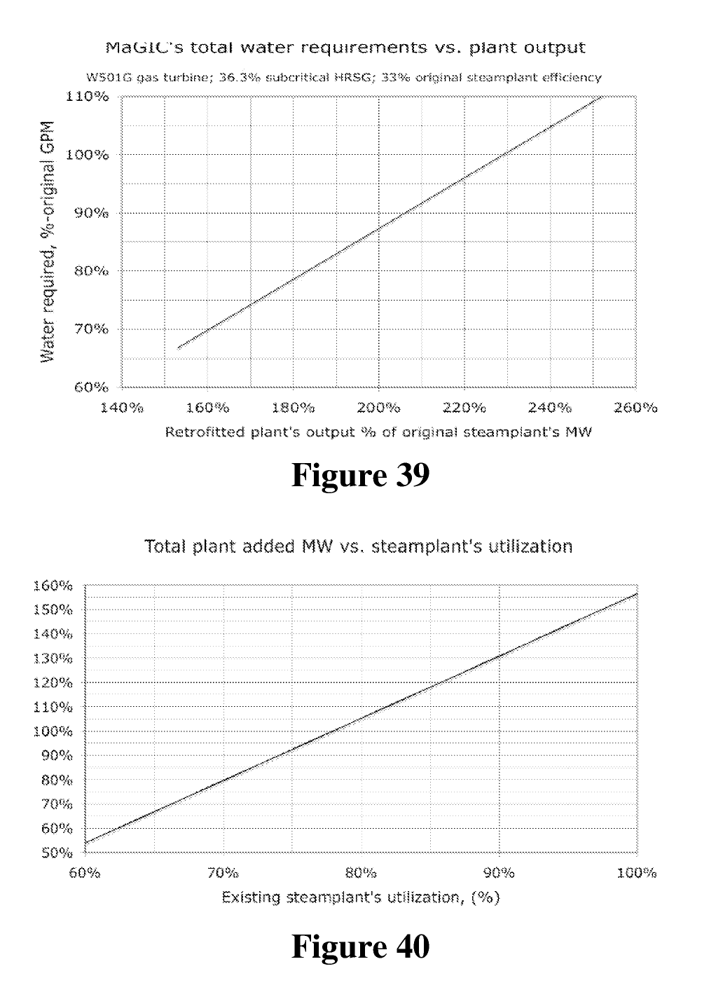

In selecting the size of the combined-cycle plant to retrofit an existing steamplant, one consideration is how much additional power is required and another consideration is the CO₂ emissions. As shown in FIG. 37, it is possible to increase the power output by retrofitting by 60% without increasing either coal flow or CO₂ emissions. (See the “MaGIC” curve at the lower left corner of the chart). The low emissions are the result of the higher efficiency of the retrofit versus the original steamplant. By comparison, if the existing steamplant were left in place, and a new NGCC were built to provide the additional power, the CO₂ emissions would rise by 30%. The remainder of FIG. 37 shows how the emissions compare at various levels of power addition. Without wishing to be bound by any particular theory, it is believed that sizing the retrofit such that the ratio as provided above is maintained can economically reduce the CO₂ emissions from the existing fleet of steamplants in a way that is environmentally more acceptable than building a new NGCC.

Typically, the more power that can be generated by the gas turbine (compared with the steam turbine), the higher the plant efficiency, because the heat through the latter achieves combined-cycle efficiencies (e.g., about 50%), while the heat through the latter achieves only steam-turbine efficiencies (e.g., about 30%). Recycling the waste heat through the gas turbine increases the gas-turbine/steam-turbine ratio. Accordingly, in some embodiments, the steam turbine is operated at part load, (e.g., if the gas turbine is sized smaller than the maximum rating that the existing steamplant's capacity would allow). FIG. 40 shows an exemplary determination of how much the steamplant must be de-rated, at various additions of power capacity provided by the retrofit.

As discussed above, in some embodiments, once this ratio has been established in an existing steamplant, it will be maintained (in retrofits) by the appropriate sizing of the IGCC plant to the existing steam system. For example, in some embodiments, if the amount of additional power required by the addition of the IGCC plant is less than what the steamplant could accommodate, the steamplant must be operated at a de-rated capacity, if the maximum efficiency is to be maintained.

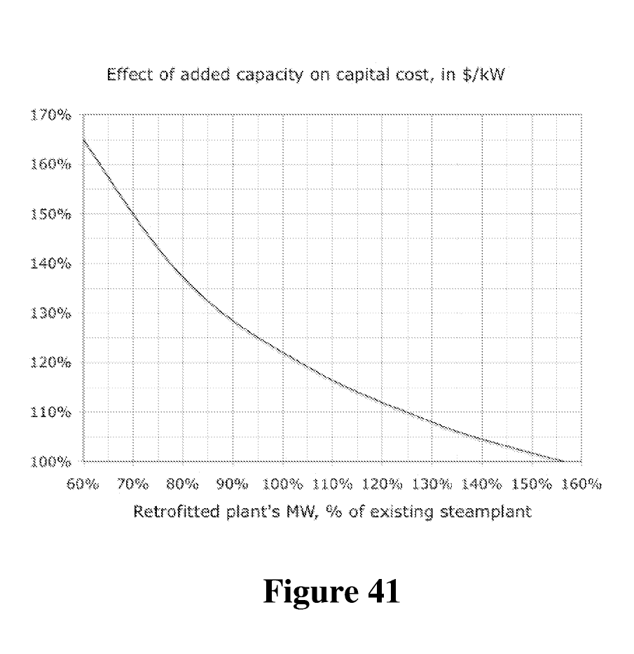

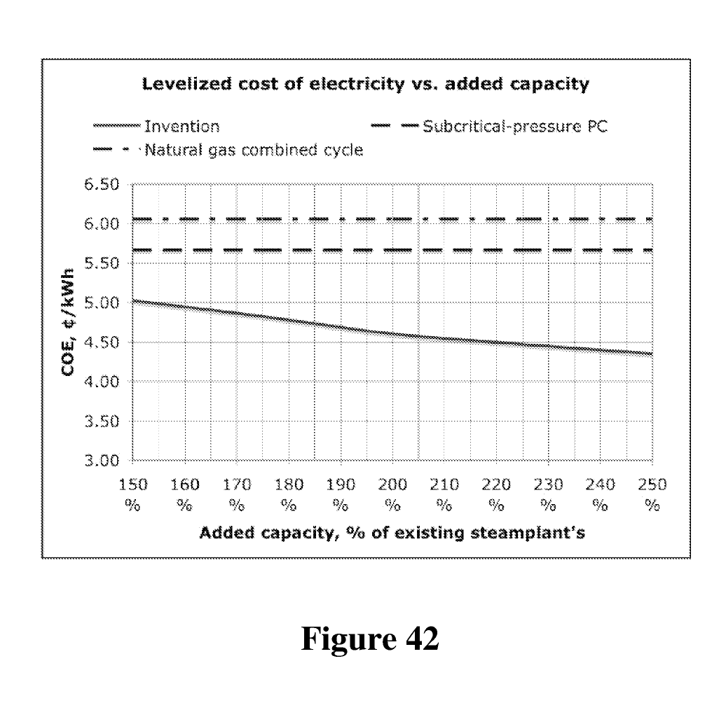

Without wishing to be bound by any particular theory, it is believed that one effect of running the steamplant at reduced capacity would be to increase the capital cost of the additional power, as the new equipment must also make up the power lost by the de-rated steamplant. The effect of de-rating on the capital cost of the retrofit, in $/kW, is shown in FIG. 41. Despite this, the cost of electricity is not greatly increased by the de-rating, as the improvement in efficiency at the lower ratings reduces the cost of fuel and other variable costs in a way that largely compensates for the higher capital costs. See, e.g., FIG. 42.

Poor efficiency performance of retrofits can sometimes be attributed to a disparity between the steam capacity actually utilized in the retrofit and the steam capacity calculated using this ratio.

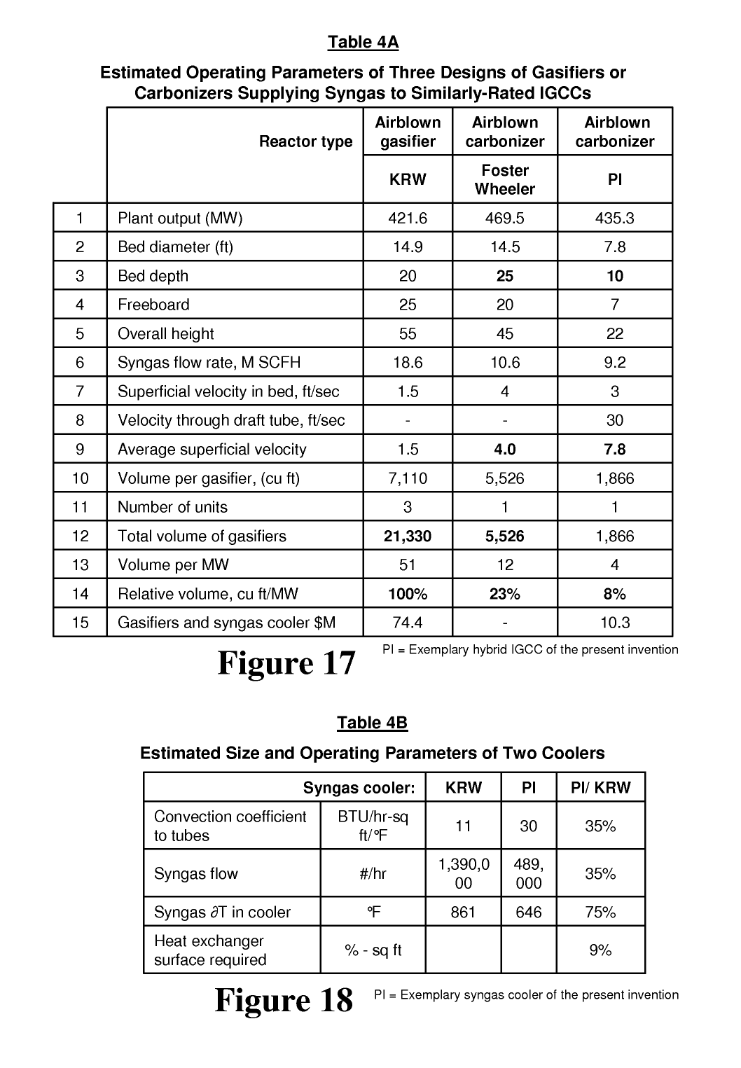

In some embodiments, maintaining the ratio as provided above allows for the upgrade of existing coalplants with carbon capture and sequestration (CCS), once that technology has been demonstrated. Most of the cost associated with CCS in an IGCC actually comes from the cost of the IGCC itself. The cost of upgrading with CCS adds as little as 10% to a retrofitted plant's cost. Accordingly, utilization of the methods and IGCCs of the present invention would, in some embodiments, largely or entirely cover the cost of upgrading to CCS, particularly in comparison to the next-lowest-cost source of new power (See, e.g., in FIG. 16 in 004-1). Accordingly, a key objection to CCS is thereby eliminated. See Carbon Capture and Storage: Assessing the Economics, McKinsey and Co., 2007;

http://www.mckinsey.com/clientservice/ccsi/pdf/CCS_Assessing_the_Economics.pdf.

CO₂ Emissions

In some embodiments, the present invention provides methods for realizing a reduction in CO₂ emissions by upgrading or retrofitting an existing IGCC plant according to any of teachings herein. As has been discussed above, FIG. 37 shows the CO₂ emissions at various capacity additions due to the retrofit. Specifically, FIG. 37 shows typical US conditions: 33% HHV efficiency of the steamplant, the use of an “F” gas turbine in the combined-cycle plant, and a subcritical-pressure-HRSG. FIG. 38 shows the higher steam conditions typical of a European steamplant, and uses the more-efficient “G” series gas turbine. The top line of FIG. 38 shows the performance of some embodiments of the invention at 85% gasification level and with a “G”-series gas turbine. The bottom line shows the use of the LMS100 aeroderivative engine as described herein.

As can be seen, the crossover point in FIG. 38 is lower (80 to 110% of the existing steamplant's capacity) vs. 143% in FIG. 37. The difference shows that the level of power addition depends on the efficiencies of the various systems. Significantly, the emissions of exemplary IGCCs of the present invention fall below 500 kg/MWh, the maximum allowance for new coal-fired capacity under recently-announced European Union standards established by the European Parliament. So far, no technology that does not utilize a retrofit can achieve this standard. See “Dirty Coal Hit by Euro Vote”, Guardian.co.uk (http://www.guardian.co.uk/environment/2008/oct/07/carboncapturestorage.carbonemissions).

Erosion-Resistant Char Deflector

In some embodiments, the IGCC of the present invention include an erosion resistant char deflector 752 (see e.g., FIG. 45B). Incoming char 740 will then impact against the char deflector 752 instead of the draft tube 750. Moreover, in some embodiments, the char deflector 752 includes a pocket or other receptacle which includes a material that protects the surface of the deflector from erosion. The pocket buffers a surface of the deflector 752 with material that becomes partially entrained on the surface. Incoming char 740 will then impact against the material from the pocket, rather than the surface of the char deflector 752. Such a char deflector 752, e.g., above the draft tube's 750 outlet, can be seen in FIG. 45B. Without wishing to be bound by any particular theory, it is believed that such a deflector will reduce the need for a deflector which erodes quickly enough to reduce the system's reliability, or using a deeper char bed to prevent elutriation.

Quench Cooling

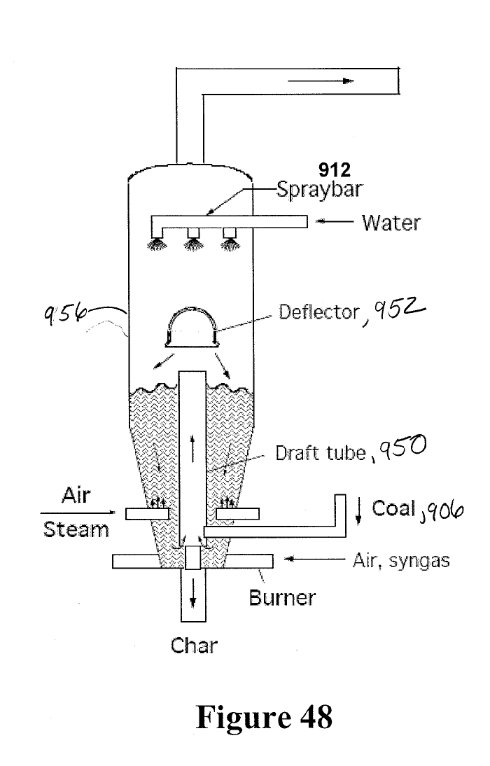

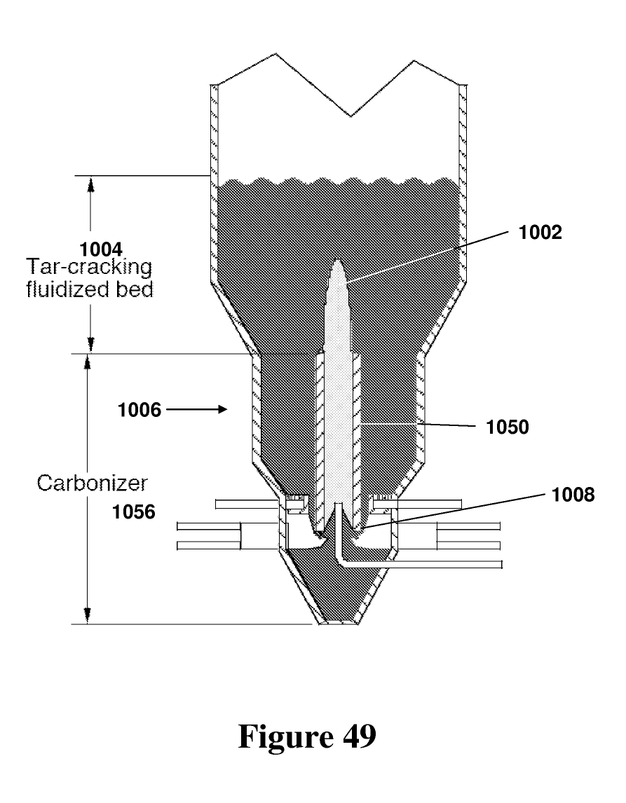

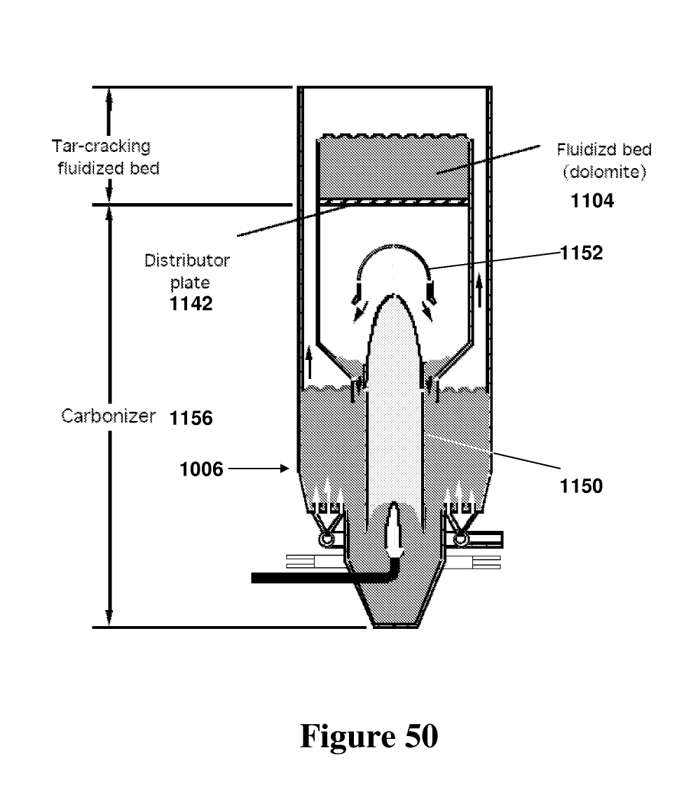

In some embodiments, the carbonizer 952 utilized in the present invention comprises spraybars 912, wherein water or steam is injected by the spraybars 912 instead of a fluidized-bed cooler to cool the syngas to the temperature required by the syngas cleanup system (See, e.g., FIG. 48). Without wishing to be bound by any particular theory, it is believed that the efficiency of IGCCs can be reduced by using water quenching to cool the syngas by direct contact instead of with radiant or convective coolers. This is because the heat in the syngas is lost instead of being recovered. Airblown gasifiers commonly use convective coolers to recover the heat, but nevertheless commonly inject steam into the gas turbine's combustor to increase the flow through the expander and increase its output. Spraying water instead of steam, and doing so upstream of the warm-gas cleanup system, can significantly reduce the plant's cost by eliminating the need for a demineralizer. In addition, spray cooling can eliminate the cost of the fluidized-bed cooler, and significantly reduce both the diameter and height of the gasifier reactor vessel. Together, the above advantages may outweigh the relatively-small efficiency loss encountered by spray-cooling in airblown gasifier IGCCs using warm-gas cleanup.

Microprocessor

In some embodiments, the present invention includes a microprocessor programmed to operate one or more functions of a hybrid IGCC. Accordingly, in some embodiments, the microprocessor is programmed to maintain the syngas at a temperature above a tar condensation temperature of a volatile matter in the syngas until the syngas is burned in the gas turbine. In some embodiments, the present invention is directed to a plant which includes a microprocessor programmed to maintain the syngas at a temperature above a tar condensation temperature of a volatile matter in the syngas until the syngas is burned in the gas turbine.

Performance

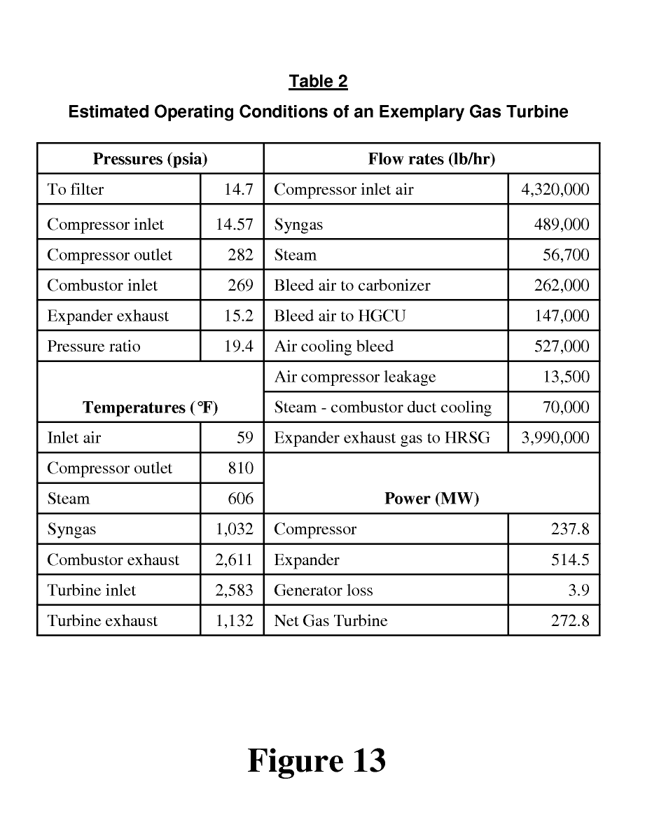

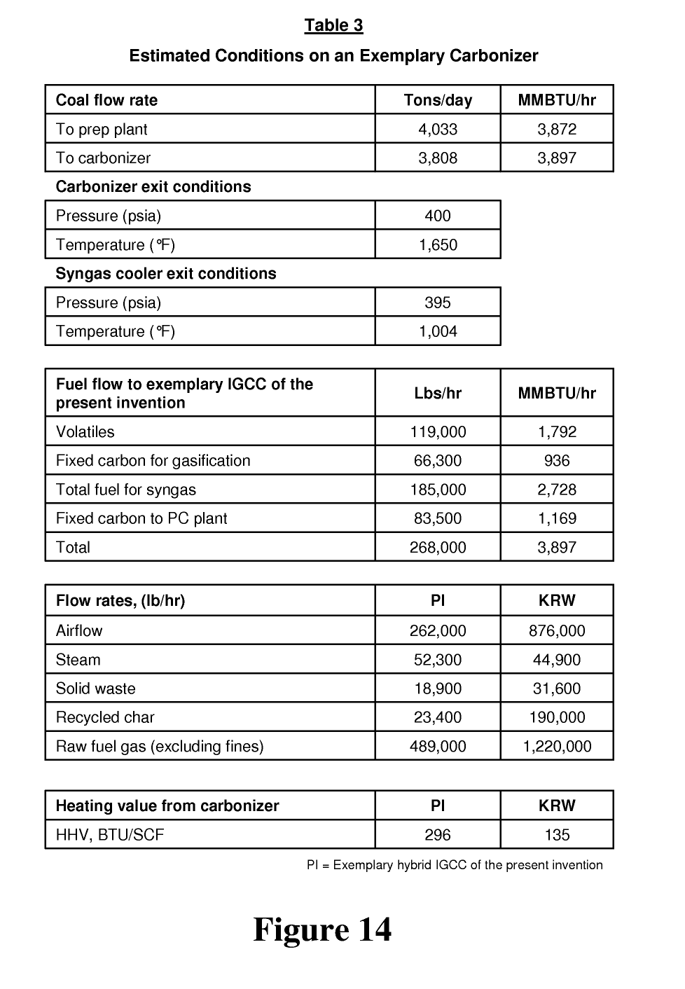

FIG. 13 describes the operating conditions of an exemplary gas turbine and FIG. 14 describes the conditions in an exemplary carbonizer in accordance with some embodiments of the present invention.

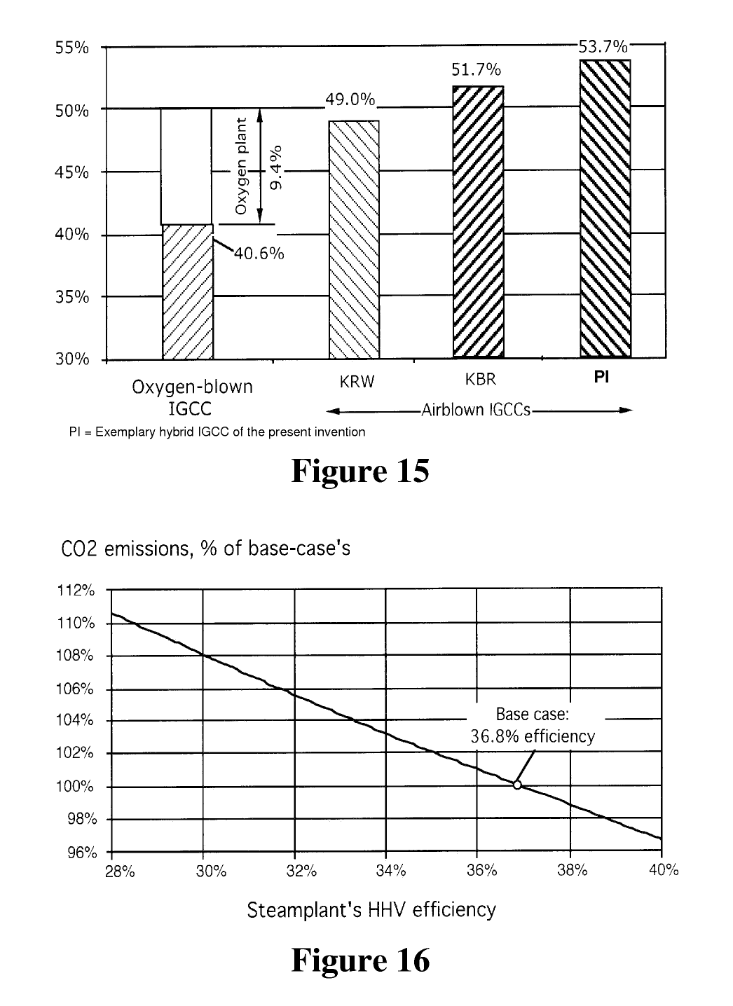

In some embodiments, the efficiency of hybrid IGCCs is significantly higher than that of any other current technology. The plant efficiency of some embodiments of the invention (See, e.g., FIG. 15) may be somewhat higher than that of the other air blown systems. In some embodiments, the invention requires less airflow to its carbonizer, which reduces the losses associated with the syngas cooler, as well as the auxiliary power required for the compressors.

In some embodiments, e.g., in retrofit applications, the efficiency of the existing steamplant affects the efficiency of the combined system (See, e.g., FIG. 16). The base-case steamplant in FIG. 16, with an HHV efficiency of 36.8%, uses a subcritical steam cycle with three stages of turbines. The inlet conditions for the HP, IP, and LP turbines, respectively, are: 1800 psia×1050° F.; 342 psia×1050° F.; 342 psia/485° F.

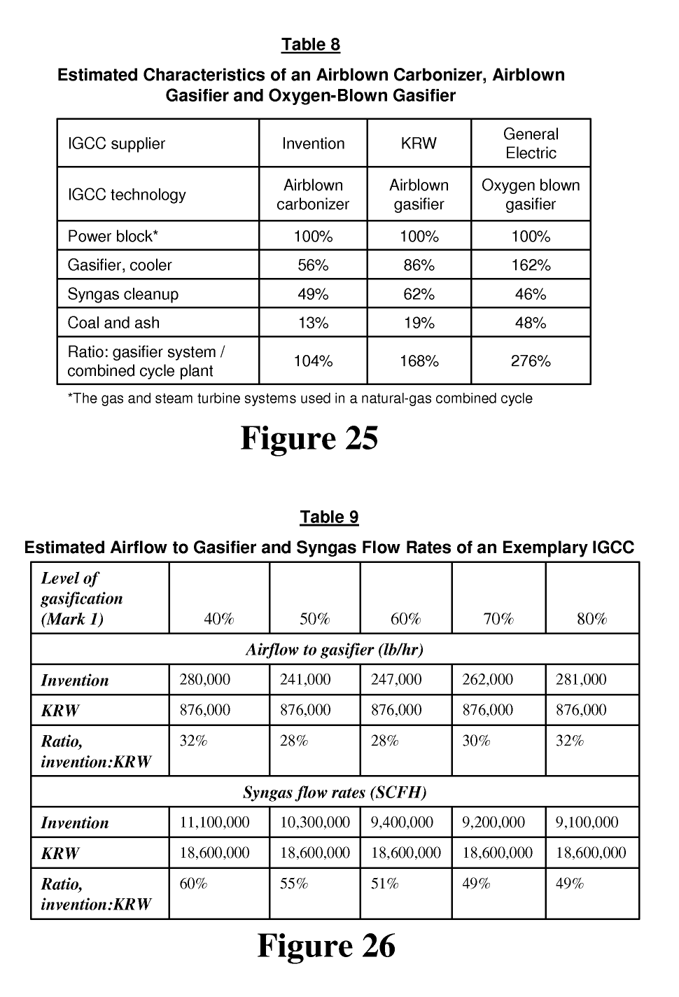

In some embodiments, the present invention achieves low capital cost. The gasification system of the some embodiments of invention may, for example, cost only about the same as the power block, which brings its total capital cost below that of a new pulverized coal plant. As seen in FIG. 25, the cost of conventional IGCCs do not allow them to be competitive with conventional PC plants. In some embodiments, the present invention provides low capital cost, combined with high efficiency and low cost of coal. This combination may make the cost of electricity produced in accordance with some embodiments of the present invention 25-30% lower than that of a PC plant, the next-cheapest source.

In some embodiments, a large portion (e.g., over half) of the cost savings realized by the invention, relative to other IGCCs, comes from the reduced size of both the gasifier (FIG. 17) and the syngas cooler (FIG. 18). FIG. 17 describes the size and operating parameters of three designs or gasifiers or carbonizers supplying syngas to similarly-rated IGCCs.

In some embodiments, a large portion of the size reduction by hybrid IGCCs is due the difference between the size of gasifier and carbonizer. This may be due to the need of the former to gasify the char fines, but not the latter. The conventional carbonizer (middle column) may be larger than the carbonizer of some embodiments of the invention (right-hand column) for two reasons. The conventional carbonizer typically needs a deeper char bed in order to thermally crack the volatiles (See FIG. 17, row 3). Additionally, the velocity in the draft tube of the carbonizer of some embodiments of the invention (See FIG. 17, row 8) may be much higher than the superficial velocity in a fluidized bed, resulting in twice the average velocity through the carbonizer of the invention (See FIG. 17, row 9). Accordingly, in some embodiments, the carbonizer that is less than 10% the size of a conventional air blown gasifier.

In some embodiments, the syngas cooler of the invention is also smaller (e.g., tenfold smaller) than conventional coolers. The heat transfer coefficient to the cooling tubes, for example, may be much higher in a fluidized-bed than in the convection of the firetube heat exchanger of a conventional cooler. Moreover, the syngas flowrate in connection with some embodiments of the present invention may be less than, e.g., only half, that of the conventional air blown gasifier IGCC. Additionally, the bed temperature may be higher in conventional gasifiers to thermally crack the volatiles, which increases heat exchanger size.

In some embodiments, the present invention utilizes external combustion. Use of external combustion may reduce the airflow to the carbonizer by 70%, and the syngas volumetric by half, compared with a conventional air blown IGCC. (See, e.g., FIG. 26). This, in turn, may reduce the size of the gasifier train, including the warm-gas cleanup system, by the same amount. Together, the cost of capital in connection with some embodiments of the present invention, as well as the cost of electricity, may be 30-40% lower than those of an air blown IGCC, and 25-30% less than that of a conventional PC plant.

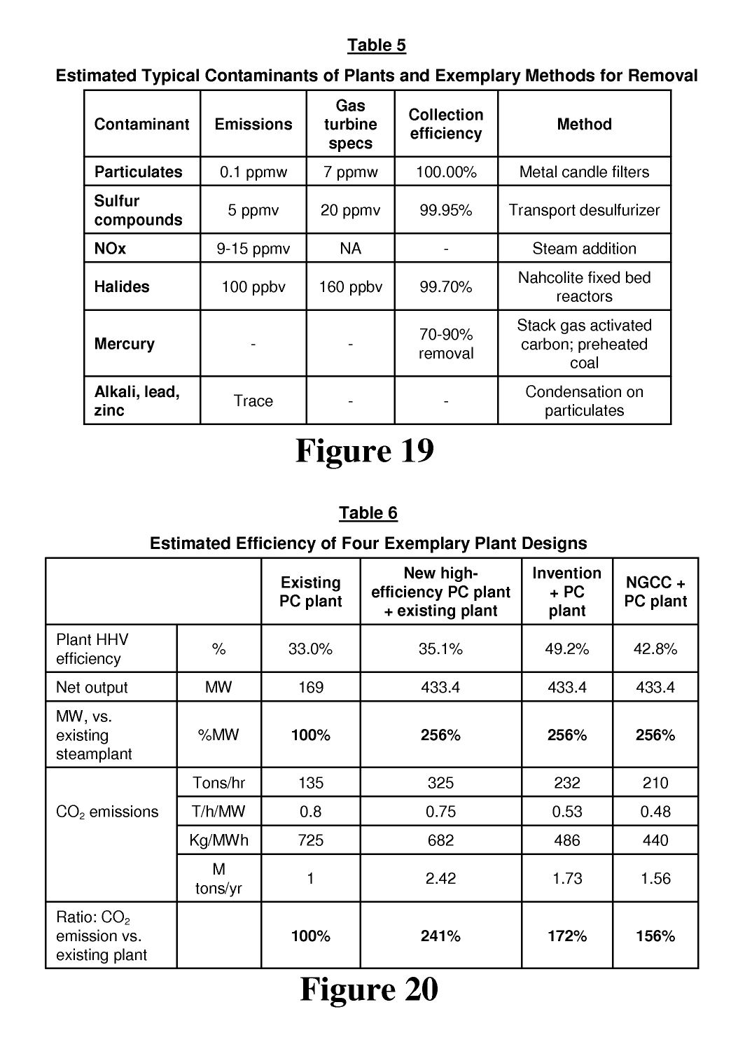

With regard to air emissions, the concentrations of particulates in the stack of an IGCC in accordance with some embodiments of the present invention are about the same as the most stringent ambient air pollution standards (30 μg/cu M). See, e.g., FIG. 19. In some embodiments, the sulfur dioxide emissions are also one to two orders of magnitude lower than those of a conventional coal-fired powerplant, when fitted with sulfur scrubbers.

In some embodiments, the present invention meets existing NOx air pollution standards. In some embodiments, improved combustor design may further lower NOx emissions, or selective catalytic reactors (SCR), as in FIG. 12, may be used to reduce NOx emissions by up to an additional 80%.

In some embodiments, the hybrid IGCCs of the present invention provide increased efficiency over conventional power plants. FIG. 20 describes the efficiency of exemplary IGCCs of the present invention in comparison to other plants. As seen in FIG. 20, a steamplant retrofitted with a hybrid IGCC in accordance with an embodiment of the invention emits only half as much additional CO₂ as if a new coal plant were built instead (increases of emissions by 72% vs. 141%). However, the emissions from the retrofitted plant are estimated about 10% more than if a natural-gas-fired combined-cycle plant were built instead. The emissions from the new plant using the an embodiment of the invention can be reduced by the 10% amount (or more) by de-rating the facility. This may be done by either building a full-scale plant and operating it at 90% of full capacity, or building a slightly smaller unit, and operating the steamplant at 90% of capacity. Accordingly, in some embodiments, this will enable new coalplants to meet a common requirement in developed countries —CO₂ emissions not exceeding those of a natural gas plant of equal capacity.

The benefits of coal plants over gas plants, even before CCS is available, include the cost of coal-fired electricity versus natural-gas-fired power and the affordability of potential CCS systems in IGCC retrofit versus natural gas plants. A natural-gas-fired combined cycle plant still emits 60% as much CO₂ as a new IGCC using the an embodiment of the invention (Mark 1). With some embodiments of the invention, the savings pay for the CCS, but with NGCC plants, there are no such savings. Therefore, these plants are likely to remain uncontrolled, with regard to CO₂, for a longer time.

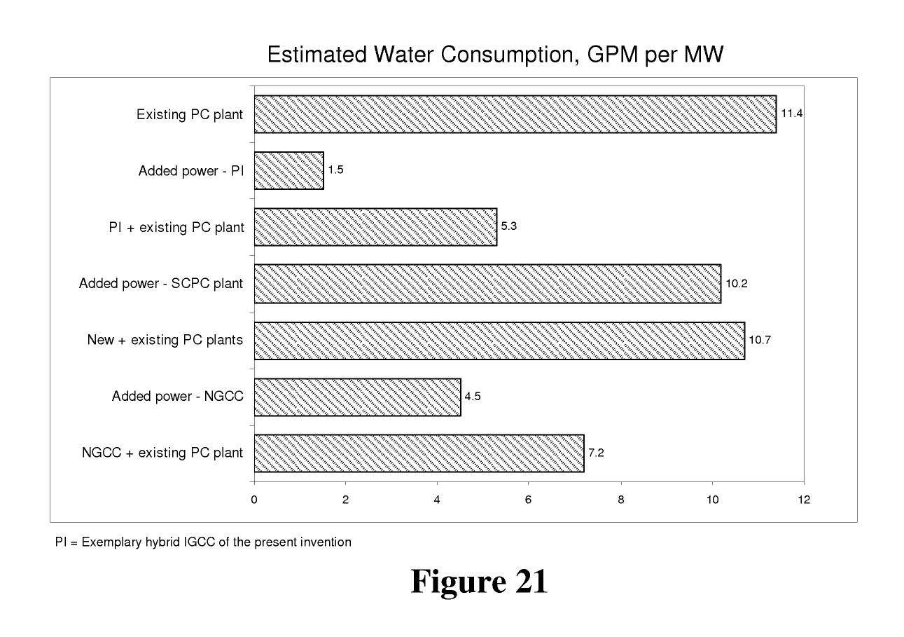

Steamplants require massive amounts of coolant to condense the spent steam, but the gas turbines of the IGCCs do not use any cooling water. (See, e.g., FIG. 21). In some embodiments, the hybrid IGCC of the present invention still requires some water, principally for gasification and to add to the expander, however, the net increase in water consumption is much smaller than with alternative technologies.

In some embodiments, the present invention is directed to methods for retrofitting an existing power plant utilizing at least one embodiment listed herein.

In some embodiments, the IGCC of the present invention includes at least one embodiment listed above. For example, in some embodiments, the IGCC of the present invention includes at least one of the following attributes:

(a) a gasified fluidized-bed combined cycle (GFBCC);

(b) a warm-gas cleanup system (e.g., to preserve volatiles);

(c) a level of gasification of greater than 70%, e.g, greater than 80%;

(d) a draft tube in the carbonizer (e.g., to isolate the volatiles);

(e) a ratio of heat to gasifier versus heat to steamplant that is the same as the powerplant being retrofitted;

(f) a fluidized-bed combustor (e.g., a pressurized fluidized-bed combustor) to use the char generated by the system's carbonizer;

(g) external burners on the carbonizer (e.g., to heat incoming airflow and/or to reduce airflow requirement to carbonizer by allowing its products to mix with syngas);

(h) a system for CCS;

(i) calcite (e.g., added in a continuous flow to an upper fluidized bed of the carbonizer to remove sulfur compounds);

(j) an aeroderivative engine;

(k) a fluidized-bed syngas cooler;

(l) a decommissioned boiler and optionally one or more scrubbers and optionally but keeping the remainder of the existing plant in use; and/or

(m) an HRSG (e.g., to recover heat from the gas turbine).

In some embodiments, the IGCC of the present invention includes at least two of the above attributes. In some embodiments, the IGCC of the present invention includes at least three of the above attributes. In some embodiments, the IGCC of the present invention includes at least four of the above attributes. In some embodiments, the IGCC of the present invention includes at least five of the above attributes. In some embodiments, the IGCC of the present invention includes at least six of the above attributes. In some embodiments, the IGCC of the present invention includes at least seven of the above attributes. In some embodiments, the IGCC of the present invention includes at least eight of the above attributes. In some embodiments, the IGCC of the present invention includes at least nine of the above attributes. In some embodiments, the IGCC of the present invention includes at least ten of the above attributes. In some embodiments, the IGCC of the present invention includes at least eleven of the above attributes. In some embodiments, the IGCC of the present invention includes at least twelve of the above attributes. In some embodiments, the IGCC of the present invention includes all of the above attributes.

For example, in some embodiments, the IGCC of the present invention includes (a) and (b); or (a) and (c); or (a) and (d); or (a) and (e); or (a) and (f); or (a) and (g); or (a) and (h); or (a) and (i); or (a) and (j); or (a) and (k); or (a) and (l); or (a) and (m). In some embodiments, the IGCC of the present invention includes (b) and (c); or (b) and (d); or (b) and (e); or (b) and (f); or (b) and (g); or (b) and (h); or (b) and (i); or (b) and (j); or (b) and (k); or (b) and (l); or (b) and (m). In some embodiments, the IGCC of the present invention includes (c) and (d); or (c) and (e); or (c) and (f); or (c) and (g); or (c) and (h); or (c) and (i); or (c) and (j); or (c) and (k); or (c) and (l); or (c) and (m). In some embodiments, the IGCC of the present invention includes (d) and (e); or (d) and (f); or (d) and (g); or (d) and (h); or (d) and (i); or (d) and (j); or (d) and (k); or (d) and (l); or (d) and (m). In some embodiments, the IGCC of the present invention includes (e) and (f); or (e) and (g); or (e) and (h); or (e) and (i); or (e) and (j); or (e) and (k); or (e) and (l); or (e) and (m). In some embodiments, the IGCC of the present invention includes (f) and (g); or (f) and (h); or (f) and (i); or (f) and (j); or (f) and (k); or (f) and (l); or (f) and (m). In some embodiments, the IGCC of the present invention includes (g) and (h); or (g) and (i); or (g) and (j); or (g) and (k); or (g) and (l); or (g) and (m). In some embodiments, the IGCC of the present invention includes (h) and (i); or (h) and (j); or (h) and (k); or (h) and (l); or (h) and (m). In some embodiments, the IGCC of the present invention includes (i) and (j); or (i) and (k); or (i) and (l); or (i) and (m). In some embodiments, the IGCC of the present invention includes (j) and (k); or (j) and (l); or (j) and (m). In some embodiments, the IGCC of the present invention includes (k) and (l); or (k) and (m); or (l) and (m).

In some embodiments, the IGCC of the present invention includes (a) and/or (b) and/or (c) and/or (d) and/or (e) and/or (f) and/or (g) and/or (h) and/or (i) and/or (j) and/or (k) and/or (l) and/or (m). It is to be understood that any and all subcombinations of the above identified list are meant to be encompassed by the present invention, e.g., (a), (d), (e), (g), (j), (l) and (m); or (a), (b), (e), (f), (h), (k) and (m); or (b), (c), (f), (g), (i) and (j); or (c), (d), (f), (h), (j), (k), (l) and (m).

In some embodiments, the plants of the present invention include at least one of the following components:

(a) a fluidized-bed combustor (e.g., a pressurized fluidized-bed combustor) to use the char generated by the system's carbonizer;

(b) a decommissioned boiler and optionally one or more scrubbers and optionally keeping the remainder of the existing plant in use; and/or

(c) an HRSG (e.g., to recover heat from the gas turbine).

In some embodiments, the present invention is directed to a system for reducing the world's carbon dioxide emissions from coalfired powerplants more quickly and extensively than by any other system, by retrofitting the new and existing pulverized coalplants with the new technology whenever new power capacity is required. In some embodiments, such retrofits provide new electricity at a lower cost than from any other technology, threreby enahncing the new technology's widescale adoption. In some embodiments, such retrofits can be upgraded to provide carbon capture and storage, once sequestration becomes available. In some embodiments, such upgrades cost only a fraction of what any other system for carbon capture costs, thereby enhancing the chances of its adoption even in countries currently reluctant to invest in the fight on global warming. In some such embodiments, the combination appears to be the only system by which for reducing the carbon emissions from coal fired powerplants can be reduced by upwards of 90% of emissions in the foreseeable future. In some such embodiments, the need for new power capacity in the near-term is sufficient to convert all of the coalplants to the low emissions in time to meet the climatologists' timetable.

Additional embodiments and combinations of some embodiments of the present invention include IGCCs which may include one or more of the following:

(A) A char combustor used to generate steam for a steam turbine, gasifier, and other uses of steam in a steam circuit, and consists of one of:
1. A pressurized fluidized-bed combustor
2. A steamplant boiler, in which the char is burned in the furnace, where coal was once burned
3. An atmospheric pressure fluidized-bed combustor,
4. The char may be used as a byproduct, to produce char briquettes for domestic heating, activated charcoal, or to fire an off-site steamplant or furnace.

(B) The level of gasification of the invention is controlled as follows:
1. When the char burner is an existing boiler, the level of gasification is controlled to keep flame temperature similar to that with coal, and typically is 65-70%.
2. When the char burner is a fluidized-bed, the level of gasification is designed to be the maximum level of gasification of which a once-through gasifier is capable, typically 80-90%.

(C) A syngas cooler comprised of either of:
1. A fluidized-bed syngas cooler which cools the syngas with conduits located within the fluidized bed, mounted on a distributor plate, or
2. The direct injection of coolant into the freeboard overhead from the top of the carbonizer, whereby the coolant is either steam or water.

(D) A carbon capture system comprised of one of:
1. With a pressurized fluidized-bed combustor, a pressurized adsorsber located downstream of a filter and cooler that treat the flue emitted from the fluidized bed combustor
2. With an atmospheric pressure char burner, a separate gas turbine, HRSG and stack-gas CO2 adsorber are used to treat the gases emitted from the char burner to remove the CO2.
3. A third alternative is to fully gasify the char fines, and mix their syngas with the syngas leaving the main gasifier.

(E) Use of calcite desulfurization to reduce the airflow to the transport desulfurizer, thereby increasing the plant output and efficiency, by, e.g.:
1. Using a fluidized bed of calcite to minimize the calcium-to-sulfur ratio, or
2. Mixing the calcite with the char, to eliminate the need for a fluidized bed of calcite.

(F) Maximization of plant efficiency when the added capacity required by the retrofit requires less than the rated capacity of the retrofitted steam turbine system, by reducing the power produced by the steam turbine proportionately.

(G) Use of an aeroderivative engine to maximize efficiency, by using steam FBC to superheat and reheat steam produced by the HRSG

(H) Conversion of the sour gas emitted from the desulfurizing regenerator into sulfuric acid, in order to use the steam generated there to increase the plant's output and efficiency

(I) Distributors for the syngas cooler and/or the calcite desulfurizer are comprised of an assembly of cooled conduits surrounded by refractory insulation, in which:
1. The assembly of conduits is comprised of fin tubes onto which insulation is placed on its top and bottom and metallic conduits attached to the fins of the fin-tube assembly, through which the syngas flows, and
2. The assembly of the distributor is comprised of coolant conduits without fins, which support an assembly of refractory through holes running the length of the fluidized bed, and in which the openings for the syngas to flow through the distributor are formed in the refractory.
3. Passages through the distributor for the syngas are formed in the supported refractory used to form the distributor

(J) Injection of air into the draft tube by:
1. Adding excess air to the external burners, or
2. Replacing the external burners with an air conduit, which then heats the incoming coal to the carbonizer bed temperature by burning volatiles in the draft tube

(K) Minimization of the height of the freeboard over the draft tube needed to minimize the loss of particles from the pressure vessel by:
1. Using a deflector over the outlet of the draft tube that returns char particles to the char bed.
2. Using a deflector that is comprised of an enclosed cup of a refractory material whose opening is at its bottom, to buffer its surface and reduce its erosion by the char leaving the draft tube.
3. Controlling the surface of the char bed to be over the top of the outlet of the draft tube by attaching a funnel-shaped vessel to the top of the draft tube, wherein:
   (a) the larger diameter of the funnel is at its top, and
   (b) whose outer diameter at its greatest is less than the inner diameter of the pressurized vessel, in order to allow syngas from the char bed to pass overehead, and
   (c) the height of the char bed in the annulus surrounding the draft tube is below the top of the draft tube, and
   (d) the funnel is filled with char, to a controlled height, and
   (e) excess char in the funnel is returned to the annular bed of char surrounding the draft tube through downcomer fitted with a valve.

It is noted that embodiments of the inventions described herein may include similar features, elements, arrangements, configurations, steps and the like. Therefore, for clarity purposes, some of the figures appended hereto, and referenced herein, include common reference numerals. However, common reference numerals are in no way meant to indicate that the commonly referenced features are identical or substantially similar, but instead are meant to indicate that they are generally the same feature. For example, the embodiment shown in FIG. 4 includes a carbonizer referenced as numeral “56”, and the embodiment shown in FIG. 30, which is a separate and distinct embodiment from the embodiment shown in FIG. 4, also includes a carbonizer that is referenced as numeral “56.” The reference to the carbonizer as “56” in FIGS. 4 and 30 is not meant to limit the embodiments shown in FIGS. 4 and 30 to include the identical or substantially similar carbonizer, but, instead, are used to only indicate that they include a carbonizer, generally. Therefore, in sum, common reference numerals used herein do not limit the referenced feature(s) to any particular embodiment, but instead simply indicates that the features are generally similar (such as features that perform a similar function).

What is claimed is:

1. A hybrid integrated gasification combined cycle (IGCC) plant for retrofitting existing steamplants comprising:
an internally-circulating fluidized bed carbonizer that forms a syngas and char;
a syngas cooler;
a warm gas cleanup system; and
a gas turbine fired by the syngas.

2. The plant of claim 1, wherein the plant further comprises at least one of the following:
an existing boiler and optionally one or more scrubbers that are decommissioned;
a heat recovery steam generator (HRSG); and/or
a fluidized-bed combustor for combusting a char generated by the carbonizer.

3. The plant of claim 1, wherein the syngas cooler is comprised of a fluidized bed with coolant tubes that are in contact with the fluidized bed.

4. The plant of claim 2 or claim 3, wherein the fluidized-bed combustor is a pressurized fluidized-bed combustor.

5. The plant of any of the preceding claims, wherein the carbonizer is operated at or near the maximum level of gasification for a once-through system.

6. The plant of any of the preceding claims, wherein the carbonizer, the warm gas cleanup system, and/or the gas turbine are rated at a lower capacity than required to match the output of the retrofitted steamplant for operating the existing at a reduced output.

7. The plant of any of the preceding claims, further comprising a second HRSG, a second gas turbine, and a stack-gas CO₂ scrubber for providing carbon capture from char generated by the system's carbonizer.

8. The plant of any of the preceding claims, wherein the carbonizer further comprises a draft tube configured to inject air into the carbonizer for partially combusting volatiles, providing heat for incoming flows, and gasifying char with steam.

9. The plant of claim 8, wherein the carbonizer does not comprise external burners.

10. The plant of any of the preceding claims, wherein the gas turbine is an aeroderivative gas turbine, and wherein the fluidized-bed combustor is adapted to superheat and reheat steam generated by the HRSG.

11. The plant of any of the preceding claims, wherein the carbonizer comprises:
an annular bed of fluidized char surrounding a draft tube;
a bed of fluidized char defined by a conical hopper that extends beyond the top of the draft tube, and comprising a cylindrical extension sufficiently tall to avoid penetration of volatiles emitted from the draft tube; and
a bypass channel defined by an inner wall of the carbonizer and an outer wall of the cylindrical extension of the conical hopper, for escape of syngas formed in the annular bed,
and, optionally, a downcomer in communication with the bottom of the conical hopper for supplying a controlled amount of air for maintaining the surface of the annular bed at a desired height.

12. The plant of any of the preceding claims, wherein a halide scrubber of said warm-gas cleanup system is located downstream of a candle filter.

13. The plant of any of the preceding claims, wherein gasification of fines is increased by recirculating fines or increasing a freeboard volume to a value above the freeboard volume of the carbonizer.

14. The plant according to claim 13, wherein the gasification of fines is increased so as to optimize the system with regard to plant efficiency or cost of electricity.

15. The plant of any of the preceding claims, further comprising a pressurized carbon dioxide adsorber for removing CO₂ from char generated by the system's carbonizer.

16. The plant of claim 15, wherein the pressurized carbon dioxide adsorber is an amine system.

17. The plant of any of the preceding claims, further comprising a char deflector above the outlet of a draft tube of the carbonizer, wherein the char deflector includes a pocket which buffers a surface of said deflector with material that becomes partially entrained on the surface, thereby minimizing the erosion of the deflector by char.

18. The plant of any of the preceding claims, wherein a distributor plate of of the syngas cooler defines passages for syngas formed in a refractory casting, wherein the casting comprises coolant pipes that provide structural support, and wherein the coolant pipes are at least partially surrounded a fibrous insulation that minimizes the thermal stresses in the refractory.

19. The plant of any of the preceding claims, wherein the plant is in communication with a furnace of an existing steamplant for burning char generated by the carbonizer.

20. The plant of any of the preceding claims, wherein a candle filter and a halide scrubber are placed upstream of a desulfurizer of the warm gas cleanup system.

21. The plant of any of the preceding claims, wherein the carbonizer comprises spraybars and wherein water is injected by the spraybars to cool the syngas to a desired temperature for the syngas cleanup system.

22. A method of retrofitting an existing power plant comprising the step of retrofitting an existing power plant to include a hybrid IGCC plant in accordance with any one of the preceding claims.

23. A method according to claim 22, wherein a de-rated plant is retrofitted to lower the emissions.

24. A method of realizing a reduction in CO₂ emissions by upgrading or retrofitting an existing power plant to include a hybrid IGCC plant in accordance with any one of the preceding claims.

25. The method of any of claims 22-24, wherein a reduction of CO₂ emissions of at least about 20% is realized.

26. A method according to claim 25, further comprising the step of using coal to produce new generating capacity.
